(19) United States
(12) Patent Application Publication
(10) Pub. No.: US 2006/0182352 A1
(43) Pub. Date: Aug. 17, 2006

(54) Encoding apparatus and method, decoding apparatus and method, recording medium, and image processing system and method

(76) Inventors: Tetsuya Murakami, Tokyo (JP); Tetsiujiro Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/343,185

(22) Filed: Jan. 31, 2006

(30) Foreign Application Priority Data
Feb. 4, 2005 (JP) P2005-029546

(51) Int. Cl. G06K 9/36

(52) U.S. Cl. 382/232

(57) ABSTRACT

An encoding apparatus includes an extremum detector configured to detect extremum pixels having extrema in input image data and the number of extrema corresponding to the number of the extremum pixels; and an encoder configured to encode the image data by an encoded-data amount that is based on the number of extrema detected by the extrema detector. A decoding apparatus includes an input unit configured to receive input of an encoding parameter that is set in accordance with the number of extrema corresponding to the number of extremum pixels having extrema in image data and input of encoded image data encoded by a data amount that is based on the encoding parameter; and a decoder configured to decode the encoded image data input via the input unit, on the basis of the encoding parameter input via the input unit, and to output decoded image data.

### CROSS REFERENCES TO RELATED APPLICATIONS

The present invention contains subject matter related to Japanese Patent Application JP 2005-029546 filed in the Japanese Patent Office on Feb. 4, 2005, the entire contents of which are incorporated herein by reference.

### BACKGROUND OF THE INVENTION

1. Field of the Invention

The present invention relates to encoding apparatuses and methods, decoding apparatuses and methods, recording media, and image processing systems and methods.

More specifically, the present invention relates to an encoding apparatus and method, a decoding apparatus and method, a recording medium, and an image processing system and method with which image data is encoded by a data amount that is based on the number of extrema in the image data so that copying can be inhibited while maintaining a favorable image quality without degrading the quality of output based on data before copying.

2. Description of the Related Art

FIG. 1 shows an example configuration of an image processing system 1 according to a related art. The image processing system 1 includes a playback apparatus 11 configured to output analog image data Van, and a display 12 configured to display an image corresponding to the image data Van output from the playback apparatus 11.

The playback apparatus 11 includes a decoder 21 and a digital-to-analog (D/A) converter 22. The decoder 21 decodes encoded image data that is played back from a recording medium (not shown), such as an optical disk, and supplies the resulting decoded digital image data to the D/A converter 22. The D/A converter 22 converts the digital image data supplied from the decoder 21 into analog image data Van, and supplies the analog image data Van to the display 12.

The display 12 is implemented, for example, by a cathode ray tube (CRT) display or a liquid crystal display (LCD).

According to the related art, it has been possible to perform unauthorized copying using the analog image data Van output from the playback apparatus 11 of the image processing system 1.

More specifically, the analog image data Van output from the playback apparatus 11 is converted into digital image data Vdg by an analog-to-digital (A/D) converter 31, and the digital image data Vdg is supplied to an encoder 32. The encoder 32 encodes the digital image data Vdg, and supplies resulting encoded image data Vcd to a recorder 33. The recorder records the encoded image data Vcd on a recording medium, such as an optical disk.

### SUMMARY OF THE INVENTION

In order to prevent such unauthorized copying based on the analog image data Van, when copyright protection is imposed, it has been the case to scramble the analog image data Van before output (e.g., Japanese Unexamined Patent Application Publication No. 2001-245270) or to inhibit output of the analog image data Van. However, this inhibits normal display of images on the display 12.

When encoding and decoding are performed by adaptive dynamic range coding (ADRC), described in Japanese Unexamined Patent Application Publication No. 61-144989, the dynamic range is reduced as the encoding and decoding take place, so that image data is degraded. In the case of ADRC, however, the dynamic range is not reduced so considerably. Although ADRC can be applied to moving images, since ADRC is not based on characteristics of motion, moving images are not degraded so considerably.

In view of this situation, the applicant has proposed a method of preventing authorized copying based on analog image signals without disadvantages such as the failure to display images normally (e.g., Japanese Unexamined Patent Application Publication No. 2004-289685).

According to the method described in Japanese Unexamined Patent Application Publication No. 2004-289685, encoding is performed in consideration of analog noise, such as a phase shift of a digital image signal obtained by A/D conversion of an analog image signal. This serves to inhibit copying while maintaining a favorable image quality without degrading the quality of an image before copying. However, considering the recent spread of distribution of digital content, demand exists for other methods for preventing unauthorized copying.

It is desired to inhibit copying while maintaining a favorable image quality without degrading the quality of output based on data before copying.

According to an embodiment of the present invention, there is provided an encoding apparatus that encodes image data. The encoding apparatus includes an extremum detector configured to detect extremum pixels having extrema in input image data and the number of extrema corresponding to the number of the extremum pixels; and an encoder configured to encode the image data by an encoded-data amount that is based on the number of extrema detected by the extrema detector.

The encoder may include a predicted-pixel generator configured to generate predicted image data using the extremum pixels; a difference calculator configured to calculate a difference between the predicted image data generated by the predicted-pixel generator and the image data; and a difference encoder configured to block-encode the difference calculated by the difference calculator.

For example, the predicted-pixel generator generates the predicted image data by linear interpolation of the extremum pixels.

Alternatively, the predicted-pixel generator generates the predicted-image data on the basis of a motion vector calculated using the extremum pixels.

The difference encoder may use adaptive dynamic range coding to block-encode the difference calculated by the difference calculator by the encoded-data amount that is based on the number of extrema.

The encoder may further include a data output unit configured to output location data and values of the extremum pixels detected by the extremum detector, an encoding parameter that is set in accordance with the number of extrema, and the difference block-encoded by the difference encoder to a subsequent stage as encoded data.

Also, the encoder may further include a data output unit configured to output a motion vector calculated using the extremum pixels, an encoding parameter that is set in accordance with the number of extrema, and the difference block-encoded by the difference encoder to a subsequent stage as encoded data.

The encoding apparatus may further include a noise adder configured to add noise to the image data and to output the image data with the noise added thereto. In this case, the extremum detector detects the extremum pixels and the number of extrema in the image data with the noise added thereto by the noise adder.

Also, the encoding apparatus may further include an encoding-information calculator configured to calculate an encoding parameter in accordance with the number of extrema detected by the extremum detector. In this case, the encoder encodes the image data by an encoded-data amount that is based on the encoding parameter.

The extremum detector may include a checker configured to check whether a pixel in the image data has a value that is maximum or minimum compared with pixel values of neighboring pixels. In this case, the extremum detector detects, as an extremum pixel, each pixel determined by the checker as having a maximum or minimum value compared with the pixel values of the neighboring pixels.

According to another embodiment of the present invention, there is provided an encoding method for an encoding apparatus that encodes image data. The encoding method includes the steps of detecting extremum pixels having extrema in input image data and detecting the number of extrema corresponding to the number of the extremum pixels; and encoding the image data by an encoded-data amount that is based on the number of extrema detected in the extremum detecting step.

According to another embodiment of the present invention, there is provided a recording medium having recorded thereon a program that allows a computer to execute processing for encoding image data. The program includes the steps of detecting extremum pixels having extrema in input image data and detecting the number of extrema corresponding to the number of the extremum pixels; and encoding the image data by an encoded-data amount that is based on the number of extrema detected in the extremum detecting step.

According to another embodiment of the present invention, there is provided a decoding apparatus that decodes encoded image data. The decoding apparatus includes an input unit configured to receive input of an encoding parameter that is set in accordance with the number of extrema corresponding to the number of extremum pixels having extrema in image data and input of encoded image data encoded by a data amount that is based on the encoding parameter; and a decoder configured to decode the encoded image data input via the input unit, on the basis of the encoding parameter input via the input unit, and to output decoded image data.

According to another embodiment of the present invention, there is provided a decoding method for a decoding apparatus that decodes encoded image data. The decoding method includes the steps of receiving input of an encoding parameter that is set in accordance with the number of extrema corresponding to the number of extremum pixels having extrema in image data and input of encoded image data encoded by a data amount that is based on the encoding parameter; and decoding the encoded image data input in the input step, on the basis of the encoding parameter input in the input step, and outputting decoded image data.

According to another embodiment of the present invention, there is provided a decoding apparatus that decodes encoded image data. The decoding apparatus includes an input unit configured to receive input of prediction data calculated using extremum pixels having extrema in image data and input of encoded difference data obtained by encoding difference data by a data amount that is set in accordance with the number of extrema corresponding to the number of-the extremum pixels, the difference data representing a difference between the image data and pixels predicted on the basis of the prediction data; a predicted-image generator configured to generate predicted-image data using the prediction data input via the input unit; a decoder configured to decode the encoded difference data input via the input unit and to output decoded difference data; and a data combiner configured to combine the difference data decoded by the decoder and the predicted-image data generated by the predicted-image generator.

For example, the prediction data includes location data and values of the extremum pixels.

The decoding apparatus may further include a noise adder configured to add noise to the image data combined by the data combiner and to output the image data with the noise added thereto to a subsequent stage.

The predicted-image generator may generate the predicted-image data by linear interpolation of the extremum pixels.

The decoder may decode the encoded difference data by adaptive dynamic range coding and output the decoded difference data.

The encoded difference data includes, for example, a minimum value and a dynamic range of the difference data for pixels in a block.

According to another embodiment of the present invention, there is provided a decoding method for a decoding apparatus that decodes encoded image data. The decoding method includes the steps of receiving input of prediction data calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data; generating predicted-image data using the prediction data input in the input step; decoding the encoded difference data input in the input step and outputting decoded difference data; and combining the difference data decoded in the decoding step and the predicted-image data generated in the predicted-image generating step.

According to another embodiment of the present invention, there is provided a recording medium having recorded thereon a program that allows a computer to execute processing for decoding encoded image data. The program includes the steps of receiving input of prediction data calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data; generating predicted-image data using the prediction data input in the input step; decoding the encoded difference data input in the input step and outputting decoded difference data; and combining the difference data decoded in the decoding step and the predicted-image data generated in the predicted-image generating step.

According to another embodiment of the present invention, there is provided a decoding apparatus that decodes encoded image data. The decoding apparatus includes an input unit configured to receive input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector; a predicted-image generator configured to generate predicted-image data using the motion vector of the extremum pixels, the motion vector being input via the input unit; a decoder configured to decode the encoded difference data input via the input unit and to output decoded difference data; and a data combiner configured to combine the difference data decoded by the decoder and the predicted-image data generated by the predicted-image generator.

According to another embodiment of the present invention, there is provided a decoding method for decoding encoded image data. The decoding method includes the steps of receiving input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector; generating predicted-image data using the motion vector of the extremum pixels, the motion vector being input in the input step; decoding the encoded difference data input in the input step and outputting decoded difference data; and combining the difference data decoded in the decoding step and the predicted-image data generated in the predicted-image generating step.

According to another embodiment of the present invention, there is provided a recording medium having recorded thereon a program that allows a computer to execute processing for decoding encoded image data. The program includes the steps of receiving input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector; generating predicted-image data using the motion vector of the extremum pixels, the motion vector being input in the input step; decoding the encoded difference data input in the input step and outputting decoded difference data; and combining the difference data decoded in the decoding step and the predicted-image data generated in the predicted-image generating-step.

According to another embodiment of the present invention, there is provided an encoding apparatus that encodes image data. The encoding apparatus includes extremum detecting means for detecting extremum pixels having extrema in input image data and the number of extrema corresponding to the number of the extremum pixels; and encoding means for encoding the image data by an encoded-data amount that is based on the number of extrema detected by the extrema detecting means.

According to another embodiment of the present invention, there is provided a decoding apparatus that decodes encoded image data. The decoding apparatus includes input means for receiving input of an encoding parameter that is set in accordance with the number of extrema corresponding to the number of extremum pixels having extrema in image data and input of encoded image data encoded by a data amount that is based on the encoding parameter; and decoding means for decoding the encoded image data input via the input means, on the basis of the encoding parameter input via the input means, and for outputting decoded image data.

### BRIEF DESCRIPTION OF THE DRAWINGS

FIG. 1 is a block diagram showing an example configuration of an image processing system according to the related art;

FIG. 2 is a block diagram showing an example configuration of an image processing system according to an embodiment of the present invention;

FIG. 3 is a diagram for explaining an encoding process in which extrema are used;

FIG. 4 is a diagram for explaining white noise and the number of extrema;

FIG. 5 is a flowchart of a process executed by the image processing system shown in FIG. 2;

FIG. 6 is a block, diagram showing an example configuration of an encoder in an encoding apparatus shown in FIG. 2;

FIG. 7 is a block diagram showing an example configuration of an extremum generator shown in FIG. 6;

FIG. 8 is a diagram for explaining a method of checking an extremum by an extremum checker shown in FIG. 7;

FIG. 9 is a block diagram showing an example configuration of a calculator for calculating the number of bits for quantization shown in FIG. 6;

FIG. 10A is a diagram for explaining a relationship between white noise and the number of bits for quantization that is calculated on the basis of the number of extrema;

FIG. 10B is a diagram for explaining a relationship between white noise and the number of bits for quantization that is calculated on the basis of the number of extrema;

FIG. 10C is a diagram for explaining a relationship between white noise and the number of bits for quantization that is calculated on the basis of the number of extrema;

FIG. 11 is a block diagram showing an example configuration of a linear predictor shown in FIG. 6;

FIG. 12 is a block diagram showing an example configuration of a horizontal inter-extremum predictor shown in FIG. 11;

FIG. 13 is a block diagram showing an example configuration of a vertical inter-extremum predictor shown in FIG. 11;

FIG. 14 is a block diagram showing an example configuration of a residual generator shown in FIG. 6;

FIG. 15 is a block diagram showing an example configuration of a residual encoder shown in FIG. 6;

FIG. 16 is a diagram for explaining a scheme of ADRC quantization and dequantization;

FIG. 17 is a flowchart of an encoding process in step S5 shown in FIG. 5, executed by the encoder shown in FIG. 2;

FIG. 18 is a flowchart of an extremum generating process in step S21 shown in FIG. 17;

FIG. 19 is a flowchart of a process for calculating the number of bits for quantization in step S22 shown in FIG. 17;

FIG. 20 is a flowchart of a linear prediction process in step S23 shown in FIG. 17;

FIG. 21 is a flowchart of a horizontal inter-extremum prediction process in step S93 shown in FIG. 20;

FIG. 22 is a flowchart of a vertical inter-extremum prediction process in step S94 shown in FIG. 20;

FIG. 23 is a flowchart of a predicted-image block generating process in step S24 shown in FIG. 17;

FIG. 24 is a flowchart of a residual calculating process in step S26 shown in FIG. 17;

FIG. 25 is a flowchart of a residual encoding process in step S27 shown in FIG. 17;

FIG. 26 is a flowchart of a data combining process in step S28 shown in FIG. 17;

FIG. 27 is a block diagram showing an example configuration of a decoder in the encoding apparatus shown in FIG. 2;

FIG. 28 is a block diagram showing an example configuration of a residual decoder shown in FIG. 27;

FIG. 29 is a block diagram showing an example configuration of a residual compensator shown in FIG. 27;

FIG. 30 is a flowchart of a decoding process in step S6 shown in FIG. 5, executed by the decoder shown in FIG. 2;

FIG. 31 is a flowchart of a data decombining process in step S301 shown in FIG. 30;

FIG. 32 is a flowchart of a residual decoding process in step S303 shown in FIG. 30;

FIG. 33 is a flowchart of a residual compensation process in step S304 shown in FIG. 30;

FIG. 34 is a flowchart of a data combining process in step S305 shown in FIG. 30;

FIG. 35 is a diagram showing a frame structure of image data;

FIG. 36 is a block diagram showing another example configuration of the encoder in the encoding apparatus shown in FIG. 2;

FIG. 37 is a diagram showing an input block;

FIG. 38 is a block diagram showing an example configuration of an extremum generator shown in FIG. 36;

FIG. 39 is a block diagram showing an example configuration of a calculator for calculating the number of bits for quantization shown in FIG. 36;

FIG. 40 is a block diagram showing an example configuration of an extremum motion estimator shown in FIG. 36;

FIG. 41 is a block diagram showing an example configuration of a residual generator shown in FIG. 36;

FIG. 42 is a flowchart showing another example of the encoding process in step S5 shown in FIG. 5, executed by the encoder shown in FIG. 2;

FIG. 43 is a flowchart of a block generating process in step S411 shown in FIG. 42;

FIG. 44 is a flowchart of an extremum generating process in step S412 shown in FIG. 42;

FIG. 45 is a flowchart of a process for calculating the number of bits. for quantization in step S413 shown in FIG. 42;

FIG. 46 is a flowchart of a motion estimating process in step S414 shown in FIG. 42;

FIG. 47 is a flowchart of a residual calculating process in step S415 shown in FIG. 42;

FIG. 48 is a flowchart of a data combining process in step S417 shown in FIG. 42;

FIG. 49 is a block diagram showing another example configuration of the decoder in the encoding apparatus shown in FIG. 2;

FIG. 50 is a block diagram showing an example configuration of an extremum motion compensator shown in FIG. 49;

FIG. 51 is a flowchart showing another example of the decoding process in step S6 shown in FIG. 5, executed by the decoder shown in FIG. 2;

FIG. 52 is a flowchart of a data decombining process in step S611 shown in FIG. 51;

FIG. 53 is a flowchart of a motion compensation process in step S613 shown in FIG. 51;

FIG. 54 is a flowchart of a residual adding process in step S614 shown in FIG. 51;

FIG. 55 is a flowchart of a data combining process in step S615 shown in FIG. 61; and

FIG. 56 is a block diagram showing an example configuration of a personal computer according to an embodiment of the present invention.

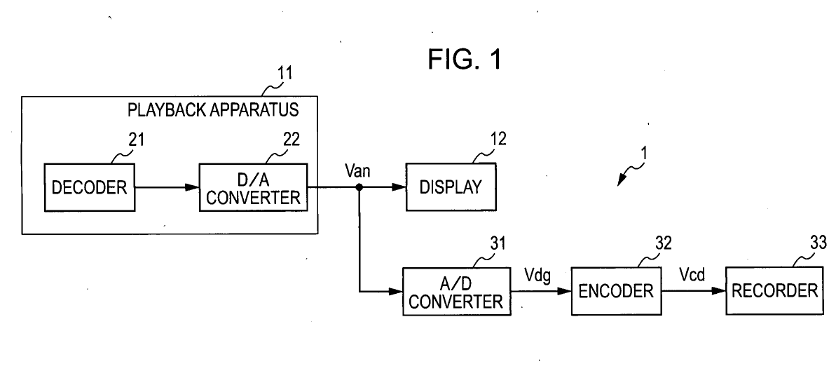

### DESCRIPTION OF THE PREFERRED EMBODIMENTS

Before describing embodiments of the present invention, the correspondence between the features of the claims and the specific elements disclosed in the embodiments of the present invention is described below. This description is intended to assure that embodiments supporting the claimed invention are described in this specification. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

Furthermore, this description should not be construed as restricting that all the aspects of the invention disclosed in the embodiments are described in the claims. That is, the description does not deny the existence of aspects of the present invention that are described in the embodiments but not claimed in this application, i.e., the existence of aspects of the present invention that in future may be claimed by a divisional application, or that may be additionally claimed through amendments.

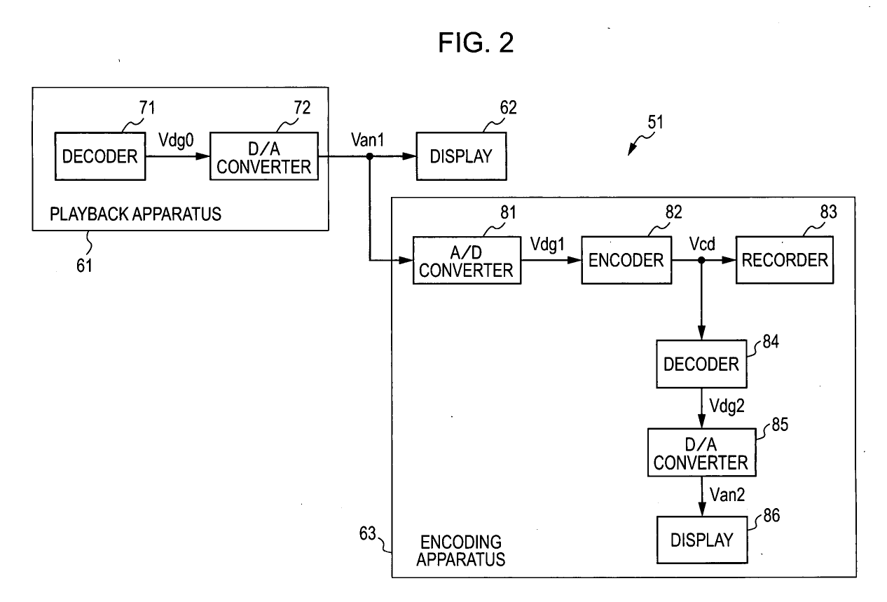

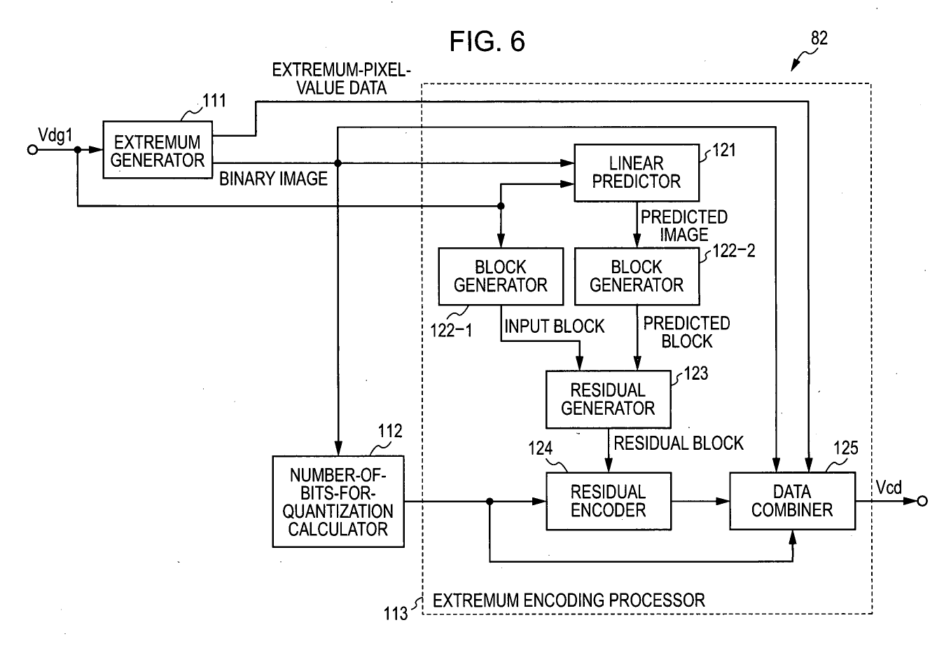

An encoding apparatus (e.g., an encoding apparatus 63 shown in FIG. 2) includes an extremum detector (e.g., a linear predictor 121 shown in FIG. 6) configured to detect extremum pixels having extrema in input image data and the number of extrema corresponding to the number of the extremum pixels; and an encoder (e.g., an extremum encoding processor 113 shown in FIG. 6) configured to encode the image data by an encoded-data amount that is based on the number of extrema detected by the extrema detector.

The encoder may include a predicted-pixel generator (e.g., the linear predictor 121 shown in FIG. 6) configured to generate predicted image data using the extremum pixels; a difference calculator (e.g., a residual generator 123 shown in FIG. 6) configured to calculate a difference between the predicted image data generated by the predicted-pixel generator and the image data; and a difference encoder (e.g., a residual encoder 124 shown in FIG. 6) configured to block-encode the difference calculated by the difference calculator.

For example, the predicted-pixel generator (e.g., the linear predictor 121 shown in FIG. 6) generates the predicted image data by linear interpolation of the extremum pixels.

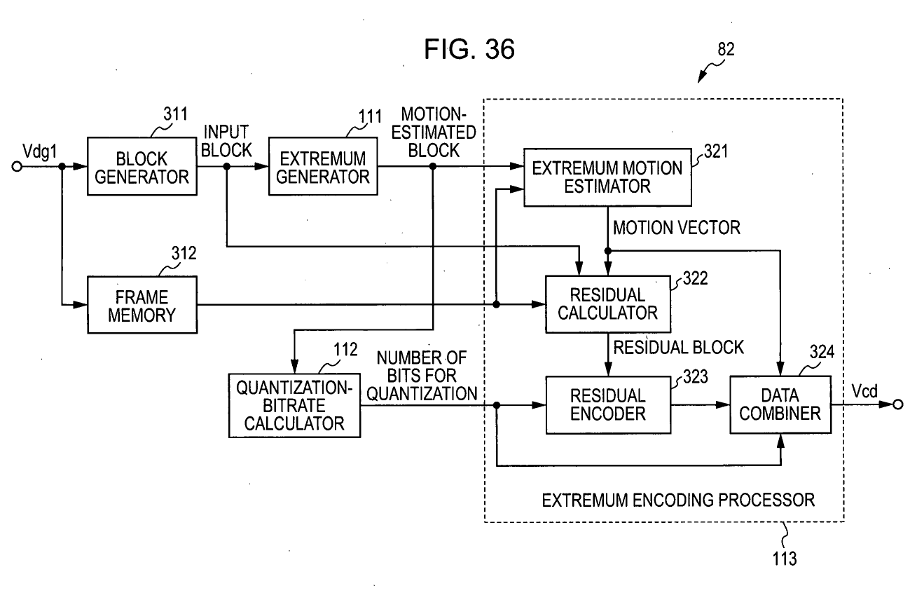

Alternatively, the predicted-pixel generator (e.g., an extremum motion estimator 321 shown in FIG. 36) may generate the predicted-image data on the basis of a motion vector calculated using the extremum pixels.

The encoder may further include a data output unit (e.g., a data combiner 125 shown in FIG. 6) configured to output location data and values of the extremum pixels detected by the extremum detector, an encoding parameter that is set in accordance with the number of extrema, and the difference block-encoded by the difference encoder to a subsequent stage as encoded data.

Alternatively, the encoder may further include a data output unit (e.g., a data combiner 324 shown in FIG. 36) configured to output a motion vector calculated using the extremum pixels, an encoding parameter that is set in accordance with the number of extrema, and the difference block-encoded by the difference encoder to a subsequent stage as encoded data.

The encoding apparatus may further include a noise adder (an A/D converter 81 shown in FIG. 2) configured to add noise to the image data and to output the image data with the noise added thereto. In this case, the extremum detector detects the extremum pixels and the number of extrema in the image data with the noise added thereto by the noise adder.

Also, the encoding apparatus may further include an encoding-information calculator (e.g., a calculator 112 for calculating the number of bits for quantization shown in FIG. 6) configured to calculate an encoding parameter in accordance with the number of extrema detected by the extremum detector. In this case, the encoder encodes the image data by an encoded-data amount that is based on the encoding parameter.

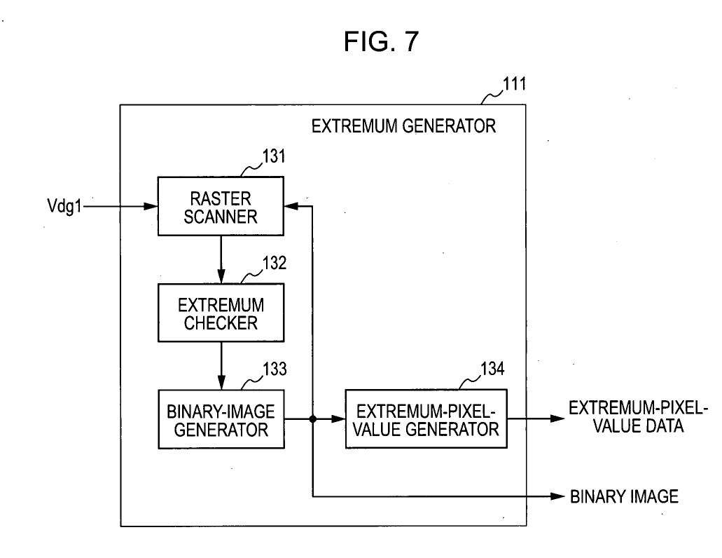

The extremum detector may include a checker (an extremum checker 132 shown in FIG. 7) configured to check whether a pixel in the image data has a value that is maximum or minimum compared with pixel values of neighboring pixels. In this case, the extremum detector detects, as an extremum pixel, each pixel determined by the checker as having a maximum or minimum value compared with the pixel values of-the neighboring pixels.

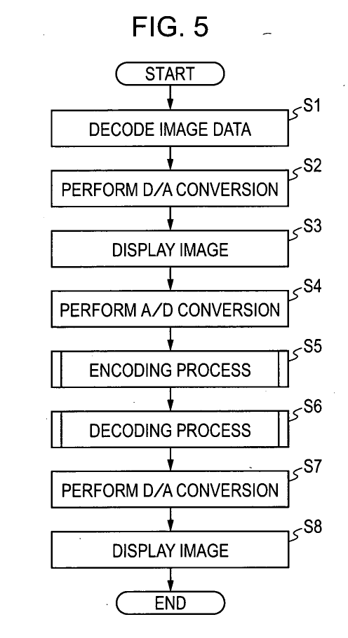

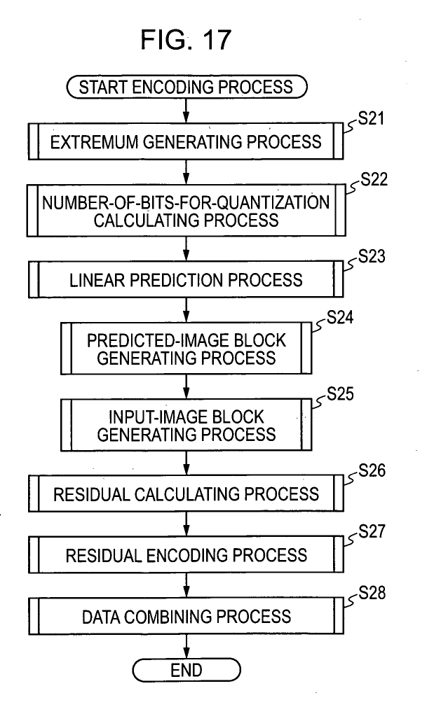

An encoding method according to another embodiment of the present invention includes the steps of detecting (e.g., step S21 shown in FIG. 17) extremum pixels having extrema in input image data and detecting the number of extrema corresponding to the number of the extremum pixels; and encoding (e.g., step S5 shown in FIG. 5) the image data by an encoded-data amount that is based on the number of extrema detected in the extremum detecting step.

A recording medium according to another embodiment of the present invention has recorded thereon a program for executing substantially the same processing as the encoding method described above, so that repeated description thereof will be refrained.

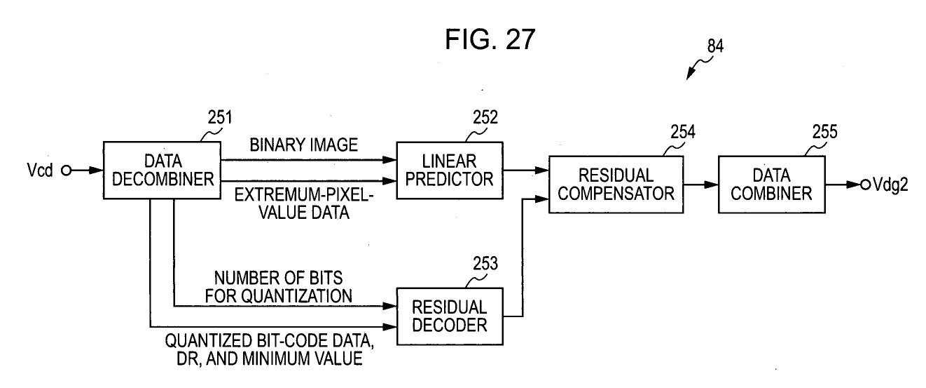

A decoding apparatus (e.g., the encoding apparatus 63 shown in FIG. 2) according to another embodiment of the present invention includes an input unit (e.g., a data decombiner 251 shown in FIG. 27) configured to receive input of an encoding parameter (e.g., the number of bits for quantization) that is set in accordance with the number of extrema corresponding to the number of extremum pixels having extrema in image data and input of encoded image data encoded by a data amount that is based on the encoding parameter; and a decoder (e.g., a residual decoder 253 shown in FIG. 27) configured to decode the encoded image data input via the input unit, on the basis of the encoding parameter input via the input unit, and to output decoded image data.

A decoding method according to another embodiment of the present invention includes the steps of receiving (e.g., step S301 shown in FIG. 30) input of an encoding parameter that is set in accordance with the number of extrema corresponding to the number of extremum pixels having extrema in image data and input of encoded image data encoded by a data amount that is based on the encoding parameter; and decoding (e.g., step S303 shown in FIG. 30) the encoded image data input in the input step, on the basis of the encoding parameter input in the input step, and outputting decoded image data.

A decoding apparatus (e.g., the encoding apparatus 63 shown in FIG. 2) according to another embodiment of the present invention includes an input unit (e.g., the data decombiner 251 shown in FIG. 27) configured to receive input of prediction data (e.g., extremum-pixel-value data, a binary image, or a motion vector) calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data; a predicted-image generator (e.g., the linear predictor 252 shown in FIG. 27) configured to generate predicted-image data using the prediction data input via the input unit; a decoder (e.g., the residual decoder 253 shown in FIG. 27) configured to decode the encoded difference data input via the input unit and to output decoded difference data; and a data combiner (e.g., a residual compensator 254 shown in FIG. 27) configured to combine the difference data decoded by the decoder and the predicted-image data generated by the predicted-image generator.

The prediction data may include location data and values of the extremum pixels.

The decoding apparatus may further include a noise adder (e.g., a D/A converter 85 shown in FIG. 2) configured to add noise to the image data combined by the data combiner and to output the image data with the noise added thereto to a subsequent stage.

A decoding method according to another embodiment of the present invention includes the steps of receiving (e.g., step S301 shown in FIG. 30) input of prediction data calculated using extremum pixels having extrema in image data and input of. encoded difference data obtained by encoding difference data by a data amount that is set in accordance with the number of extrema corresponding to the number of the extremum pixels, the difference data representing a difference between the image data and pixels predicted on the basis of the prediction data; generating (e.g., step S302 shown in FIG. 30) predicted-image data using the prediction data input in the input. step; decoding (e.g., step S303 shown in FIG. 30) the encoded difference data input in the input step and outputting decoded difference data; and combining (e.g., step S304 shown in FIG. 30) the difference data decoded in the decoding step and the predicted-image data generated in the predicted-image generating step.

A recording medium according to another embodiment of the present invention has recorded thereon a program for executing substantially the same processing as the decoding method described above, so that repeated description thereof will be refrained.

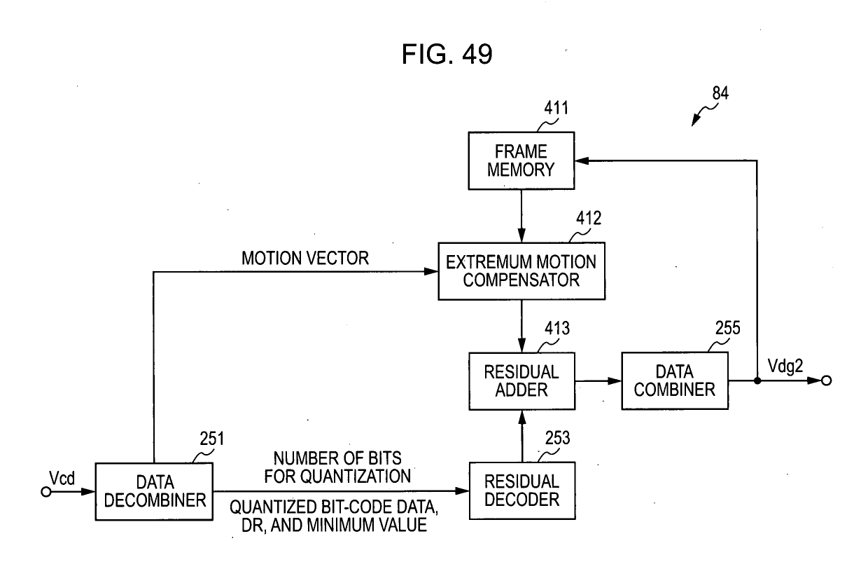

A decoding apparatus (e.g., the encoding apparatus 63 shown in FIG. 2) according to another embodiment of the present invention includes an input unit (e.g., a data decombiner 251 shown in FIG. 49) configured to receive input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector; a predicted-image generator (e.g., an extremum motion compensator 412 shown in FIG. 49) configured to generate predicted-image data using the motion vector of the extremum pixels, the motion vector being input via the input unit; a decoder (e.g., a residual decoder 253 shown in FIG. 49) configured to decode the encoded difference data input via the input unit and to output decoded difference data; and a data combiner (e.g., a residual adder 413 shown in FIG. 49) configured to combine the difference data decoded by the decoder and the predicted-image data generated by the predicted-image generator.

A decoding method according to another embodiment of the present invention includes the steps of receiving (e.g., step S611 shown in FIG. 51) input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector; generating (e.g., step S613 shown in FIG. 51) predicted-image data using the motion vector of the extremum pixels, the motion vector being input in the input step; decoding (e.g., step S612 shown in FIG. 51) the encoded difference data input in the input step and outputting decoded difference data; and combining (e.g., step S614 shown in FIG. 51) the difference data decoded in the decoding step and the predicted-image data generated in the predicted-image generating step.

A recording medium according to another embodiment of the present invention has recorded thereon a program for executing substantially the same processing as the decoding method described above, so that repeated description thereof will be refrained.

Now, embodiments of the present invention will be described with reference to the drawings.

FIG. 2 shows an example configuration of an image processing system 51 according to an embodiment of the present invention. The image processing system 51 includes a playback apparatus 61 that outputs analog image data Van1, a display 62 that displays an image corresponding to the image data Van1 output from the playback apparatus 61, and an encoding apparatus 63 that re-encodes the analog image data Van1 and records the resulting encoded image data Vcd (hereinafter also referred to as encoded data Vcd) on a recording medium (not shown), such as an optical disk.

The playback apparatus 61 includes a decoder 71 and a digital-to-analog (D/A) converter 72. The decoder 71 decodes encoded image data that is played back from a recording medium (not shown), such as an optical disk, and supplies the resulting decoded digital image data Vdg0 to the D/A converter 72. The D/A converter 72 converts the digital image data Vdg0 supplied from the decoder 71 into analog image data Van1, and supplies the analog image data Van1 to the display 62.

The display 62 is implemented, for example, by a cathode ray tube (CRT) display or a liquid crystal display (LCD), and it displays an image corresponding to the image data Van1 supplied from the D/A converter 72.

The encoding apparatus 63 includes an analog-to-digital (A/D) converter 81, an encoder 82, a recorder 83, a decoder 84, a D/A converter 85, and a display 86.

The A/D converter 81 converts analog image data Van1 supplied from the playback apparatus 61 into digital image data Vdg1, and supplies the digital image data Vdg1 to the encoder 82.

The encoder 82 encodes the digital image data Vdg1 supplied from the A/D converter 81, and supplies the resulting encoded data Vcd to the recorder 83 or the decoder 84. In the encoder 82, the same encoding process applied to encoded image data obtained by playback from a recording medium by the playback apparatus 61 is executed.

The encoder 82 detects extremum pixels having extremum values from the digital image data Vdg1, estimates image data on the basis of the extrema detected, and encodes a residual of the image data estimated as the image data Vdg1 using an amount of data based on the number of extrema corresponding to the number of extremum pixels, thereby obtaining encoded data Vcd. The configuration of the encoder 82 will be described later in detail.

An extremum herein refers to a value that is a maximum or a minimum compared with the pixel values of neighboring pixels. That is, an extremum pixel having an extremum refers to a pixel having a pixel value that is maximum (transition from increase to decrease in pixel value) or minimum (transition from decrease to increase in pixel value) compared with the pixel values of neighboring pixels. Thus, an extremum pixel is a pixel at a pixel location at which the quadratic differentiation of the waveform of pixel-value distribution yields 0.

The recorder 83 records the encoded data Vcd supplied from the encoder 82 on a recording medium (not shown), such as an optical disk. The encoded data Vcd recorded on a recording medium by the recorder 83 may be read by the recorder 83 and supplied to the decoder 84.

The decoder 84 decodes the encoded data Vcd supplied from the encoder 82 or the recorder 83, and supplies decoded digital image data Vdg2 to the D/A converter 85. The decoder 84 executes the same decoding process executed by the decoder 71. That is, the decoder 84 decodes the encoded data Vcd supplied from the encoder 82, which is encoded by the encoder 82 using an amount of data based on the number of extrema, thereby obtaining digital image data Vdg2. The configuration of the decoder 84 will be described later in detail.

The D/A converter 85 converts the digital image data Vdg2 supplied from the decoder 84 into analog image data Van2, and supplies the analog image data Van2 to the display 86. The display 86 is implemented, for example, by a CRT display or an LCD, and it displays an image corresponding to the analog image data Van2 supplied from the D/A converter 85.

In the image processing system 51, during D/A conversion by the D/A converter 72 or the D/A converter 85, during A/D conversion by the A/D converter 81, during data communications on a communication path between the D/A converter 72 and the A/D converter 81, and so forth, white noise, i.e., noise like random sandstorm, is added to image data generated through conversion, so that distortion of high-frequency components occurs, and distortion due to phase shift of image data (hereinafter referred to as phase shift) also occurs. That is, white noise (distortion of high-frequency components caused by white noise) and distortion (noise) due to phase shift are added to image data generated through conversion. The white noise and phase shift (noise caused by phase shift) are collectively referred to as analog noise (or analog distortion).

Now, distortion of high-frequency components caused by white noise will be described. In the course of conversion of digital image data into analog image data, white noise having substantially uniform frequency components is added to image data. The level of white noise changes randomly in time, and the distribution thereof is substantially normal. That is, the level of white noise added to analog image data corresponding to individual pixels varies randomly.

For example, even when the pixel values of pixels on a horizontal line are the same in digital image data Vdg0 before conversion, the pixel values of the corresponding pixels in digital image data Vdg1 obtained through D/A conversion by the A/D converter 81 and A/D conversion by the D/A converter 72 have variance within a certain range with respect to the original value (the same value). Thus, distortion of high-frequency components occurs in the image data. Distortion of high-frequency components also occurs with respect to the vertical direction as well as the horizontal direction. Depending on the variation in the level of white noise added to individual pixels, distortion of components other than high-frequency components also occurs.

As described above, in the D/A converter 72 or the D/A converter 85, white noise is added in the course of conversion of digital image data into analog image data, so that data is distorted two-dimensionally, i.e., with respect to the horizontal direction and the vertical direction. Noise added to image data is not limited to white noise, and the noise may include colored noise.

As described above, the analog image data Van1 output from the D/A converter 72 and the digital image data Vdg1 output from the A/D converter 81 have white noise and phase shift compared with the digital image data Vdg0, and the analog image data Van2 output from the D/A converter 85 have further white noise and phase shift compared with the digital image data Vdg1.

The degree of degradation of image quality due to the white noise and the phase shift is not so great. However, addition of white noise causes distortion of high-frequency components so that high-frequency components increase, and this increases extrema, i.e., values that are maximum or minimum compared with the pixel values of neighboring pixels.

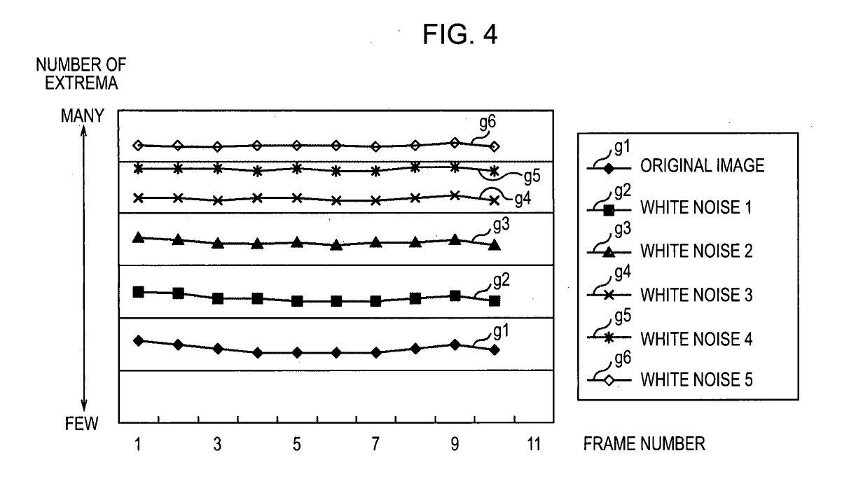

In the encoder 82, using the digital image data Vdg1 having white noise and phase shift, extremum pixels are detected, image data is estimated on the basis of the extrema detected, and a residual of the image data estimated as the image data Vdg1 is encoded using an amount of data based on the number of extrema corresponding to the number of extremum pixels (an amount of data restricted by the number of extrema). At this time, as will be described later with reference to FIG. 4, the likelihood of the image data estimated on the basis of the extrema is not so high due to the effect of white noise. Furthermore, since the number of extrema detected increases, the amount of data that can be allocated for encoding of the residual decreases. Thus, the accuracy of the encoding by the encoder 82 is reduced.

Accordingly, the image quality of the encoded data Vcd supplied from the encoder 82 or the analog image data Van2 supplied from the decoder 84 is considerably degraded compared with the image quality of the digital image data Vdg0 or Vdg1. This serves to prevent analog copying while allowing display of an image with an image quality not so degraded on the display 62.

Furthermore, since white noise and phase shift occur during conversion between analog and digital, copying of digital data is not significantly affected by white noise or phase shift. Thus, with the image processing system 51, it is possible to restrict only analog copying so that the image quality of image data is degraded during analog copying.

In the image processing system 51 shown in FIG. 2, white noise and phase shift occur naturally during D/A conversion by the D/A converter 72 or the D/A converter 85 or during A/D conversion by the A/D converter 81. However, it is possible to forcibly generate and add more white noise and phase shift than those that occur naturally.

This serves to enhance the effect of preventing analog copying.

Although phase shift will be omitted as appropriate in the following description, when white noise is added to image data, phase shift is also added to the image data.

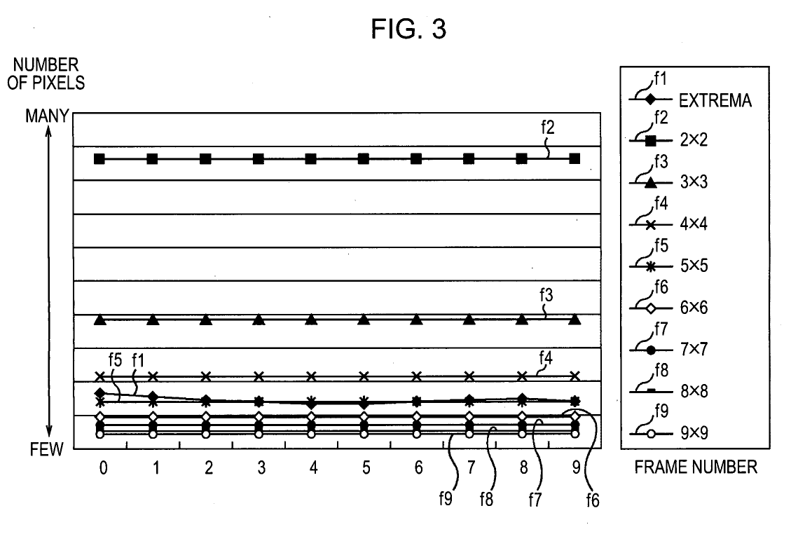

Next, an encoding process involving extrema will be described with reference to FIG. 3.

FIG. 3 is a graph showing the number of pixels used in an encoding process for each frame of an image. The vertical axis represents the number of pixels used for the encoding process, and the number of pixels increases upward along the vertical axis. The horizontal axis represents frame numbers 0 to 9.

In FIG. 3, f1 represents the number of pixels in a case where extrema are used for the encoding process, and the number of pixels is substantially the same as that represented by f5. f2 represents the number of pixels in a case where a pixel value at a predetermined location within each 2×2 block is used for the encoding process, and the number of pixels is greatest. f3 represents the number of pixels in a case where a pixel value at a predetermined location within each 3×3 block is used for the encoding process, and the number of pixels is substantially half compared with that represented by f2.

f4 represents the number of pixels in a case where a pixel value at a predetermined location within each 4×4 block is used for the encoding process, and the number of pixels is substantially half compared with that represented by f3. f5 represents the number of pixels in a case where a pixel value at a predetermined location within each 5×5 block is used for the encoding process, and the number of pixels is less than that represented by f4. f6 represents the number of pixels in a case where a pixel value at a predetermined location within each 6×6 block is used for the encoding process, and the number of pixels is less than that represented by f5 and is substantially half compared with that represented by f4.

f7 represents the number of pixels in a case where a pixel value at a predetermined location within each 7×7 block is used for the encoding process, and the number of pixels is less than that represented by f6. f8 represents the number of pixels in a case where a pixel value at a predetermined location within each 8×8 block is used for the encoding process, and the number of pixels is less than that represented by f7. f9 represents the number of pixels in a case where a pixel value at a predetermined location within each 9×9 block is used for the encoding process, and the number of pixels is somewhat less than that represented by f8.

In the graph shown in FIG. 3, the number of pixels is greatest in the case of f2 (the case where a pixel value at a predetermined location in each 2×2 block is used for the encoding process), and the number of pixels decreases in order of f3, f4, f5, f6, f7, f8, and f9. The number of pixels in the case of f1 (the case where extrema are used for the encoding process) is substantially the same as that in the case of f5. That is, the number of pixels used when extrema are used in the encoding process is substantially the same as the number of pixels used when a pixel value at a predetermined location within each 5×5 block is used for the encoding process.

Thus, when extrema are used in the encoding process, the number of pixels used for the encoding process in each frame is less than that in the typical case of f4 where a pixel value at a predetermined location of each 4×4 block is used.

Accordingly, when extrema are used for the encoding process, the amount of data is less than the number of pixels in the case where pixel values at predetermined locations are used for the encoding process, so that the circuitry scale can be reduced. However, the number of extrema increases in proportion to the amount of white noise, as shown in FIG. 4.

FIG. 4 is a graph showing relationship between white noise and the number of extrema in each frame of an image. The vertical axis represents the number of extrema, and the number of extrema increases upward along the vertical axis. The horizontal axis represents frame numbers 0 to 10. White noises 1 to 5 represent amounts of white noise added to an original image, and the amount of white noise increases as the number becomes greater.

In FIG. 4, g1 represents the number of extrema in an original image. g2 represents the number of extrema in the original image with a white noise 1 added thereto, and the number of extrema is greater than g1. g3 represents the number of extrema in the original image with a white noise 2 added thereto, and the number of extrema is greater than g2. g4 represents the number of extrema in an original image with a white noise 3 added thereto, and the number of extrema is greater than g3. g5 represents the number of extrema in the original image with a white noise 4 added thereto, and the number of extrema is greater than g4. g6 represents the number of extrema in the original image with a white noise 5 added thereto, and the number of extrema is greater than g5.

As described above, the number of extrema in a frame increases as white noise increases. In some cases, extrema that occur due to the addition of white noise are themselves white noises.

Thus, when image data is estimated on the basis of extrema detected, since the number of extrema increases due to the effect of white noise, the likelihood of the image data estimated on the basis of the extrema is not so high. Furthermore, when a residual between the image data Vdg1 and the image data estimated on the basis of the extrema is encoded using an amount of data based on the number of extrema corresponding to the number of extremum pixels, the number of extrema increases due to the effect of white noise, so that the amount of data that can be allocated for encoding of the residual decreases. This reduces the accuracy of the encoding by the encoder 82.

Accordingly, the image quality of the encoded data Vcd supplied from the encoder 82 or the analog image data Van2 supplied from the decoder 84 is considerably degraded compared with the image quality of the digital image data Vdg0 or Vdg1. This serves to prevent analog copying while allowing display of an image with an image quality not so degraded on the display 62.

Now, an example of a process executed by the image processing system 51 shown in FIG. 2 will be described with reference to a flowchart shown in FIG. 5.

In step S1, the decoder 71 decodes encoded image data played back from a recording medium (not shown), such as an optical disk, and supplies decoded digital image data Vdg0 to the D/A converter 72. The process then proceeds to step S2. In step S1, the same decoding process as in step S6 described later is executed.

In step S2, the D/A converter 72 converts the digital image data Vdg0 supplied from the decoder 71 into analog image data Van1, and supplies the analog image data Vanl to the display 62 and the A/D converter 81. The process then proceeds to step S3.

Thus, in step S3, an image corresponding to the analog image data Van1 is displayed on the display 62.

In step S4, the A/D converter 81 converts the analog image data Van1 supplied from the D/A converter 72 into digital image data Vdg1, and supplies the digital image data Vdg1 to the encoder 82. The process then proceeds to step S5. Through the conversion by the D/A converter 72 in step S2 and the conversion by the A/D converter 81 in step S4, white noise is added to the digital image data Vdg1 compared with the digital image data Vdg0.

In step S5, the encoder 82 encodes the digital image data Vdg1 supplied from the A/D converter 81, and supplies encoded data Vcd to the decoder 84. The process then proceeds to step S6. The process executed by the encoder 82 will be described later in detail.

Through the encoding process in step S5, from the digital image data Vdg1 with the white noise added thereto, each extremum pixel having an extremum, i.e., a maximum value or a minimum value compared with the pixel values of neighboring pixels, is detected, image data is estimated on the basis of the extrema detected, and a residual of the image data estimated as the image data Vdg1 is encoded using an amount of data based on the number of extrema corresponding to the number of extremum pixels, whereby encoded data Vcd is generated. The encoded data Vcd is supplied to the decoder 84.

In step S6, the decoder 84 decodes the encoded data Vcd supplied from the encoder 82, and supplies decoded digital image data Vdg2 to the D/A converter 85. The process then proceeds to step S7. The process executed by the decoder 84 will be described later in detail.

Through the decoding process in step S6, image data encoded using an amount of data based on the number of extrema is decoded using the encoded data Vcd supplied from the encoder 82, whereby the digital image data Vdg2 is obtained.

In step S7, the D/A converter 85 converts the digital image data Vdg2 supplied from the decoder 84 into analog image data Van2, and supplies the analog image data Van2 to the display 86. The process then proceeds to step S8.

In step S8, an image corresponding to the analog image data Van2 is displayed on the display 86. The image processing system 51 then exits image processing.

As described above, in the image processing system 51 according to this embodiment, image data is estimated on the basis of extrema detected using the digital image data Vdg1 with white noise added thereto, and a residual of the image data estimated as the image data Vdg1 is encoded using an amount of data based on the number of extrema corresponding to the number of extremum pixels. Thus, the likelihood of the image data estimated on the basis of the extrema is not so high, and the amount of data that can be allocated for the encoding of the residual is reduced by the restriction imposed by an increase in the number of extrema. This reduces the accuracy of the encoding.

Furthermore, since a decoding process is executed using the encoded data Vcd generated by encoding the digital image data Vdg1 with white noise added thereto, the accuracy of the decoding is reduced.

Accordingly, since the image quality of the encoding data Vcd supplied from the encoder 82 and the corresponding decoded digital image data Vdg2 supplied from the decoder 84 is considerably degraded compared with the image quality of the digital image data Vdg0 and the analog image data Van1, the image quality of the image displayed on the display 86 in step S8 is degraded compared with the image displayed on the display 62 in step S4. This serves to prevent analog copying.

Furthermore, when encoded data Vcd having a considerably degraded image quality, recorded on a recording medium by the recorder 83, is read and decoded, the resulting image data has an image quality equivalent to that of the image displayed on the display 86 in step S8.

Thus, when image data encoded by the encoder 82 and recorded by the recorder 83 on a recording medium is read and decoded in step S1 and the decoded image data is again encoded and decoded in steps S5 and S6, the image quality of the resulting image data is further degraded than that of the digital image data Vdg2. That is, as encoding and decoding according to this embodiment are repeated, the image quality of the resulting image data becomes further degraded.

This serves to prevent analog copying.

Now, the configuration of the encoder 82 shown in FIG. 2 will be described in detail.

FIG. 6 is a block diagram showing the configuration of the encoder 82. The encoder 82 receives input of digital image data Vdg1 with white noise from the A/D converter 81, encodes the input digital image data Vdg1, and supplies resulting encoded data Vcd to the recorder 83 or the decoder 84 at a subsequent stage.

The encoder 82 includes an extremum generator 111, a calculator 112 for calculating the number of bits for quantization, and an extremum encoding processor 113. The digital image data Vdg1 supplied from the A/D converter 81 is input to the extremum generator 111 and the extremum encoding processor 113.

The extremum generator 111 detects extremum pixels (hereinafter also referred to simply as extrema) from the digital image data Vdg1, and calculates a binary image in which extremum-pixel-value data and extremum locations are recorded. An extremum pixel refers to a pixel at which the quadratic differentiation of the waveform yields 0, i.e., a pixel having an extremum that is maximum or minimum compared with the pixel values of neighboring pixels. The binary image calculated by the extremum generator 111 is supplied to the calculator 112 for calculating the number of bits for quantization and the extremum encoding processor 113, and the extremum-pixel-value data calculated by the extremum generator 111 is supplied to the extremum encoding processor 113.

Using the binary image supplied from the extremum generator 111, the calculator 112 for calculating the number of bits for quantization sets the number of bits for quantization, which is an encoding parameter used for encoding by the extremum encoding processor 113, and supplies the number of bits for quantization to the extremum encoding processor 113.

The extremum encoding processor 113 includes a linear predictor 121, block generators 122-1 and 122-2, a residual generator 123, a residual encoder 124, and a data combiner 125. The extremum encoding processor 113 encodes the digital image data Vdg1 using the number of bits for quantization supplied from the calculator 112 for calculating the number of bits for quantization.

In the extremum encoding processor 113, the digital image data Vdg1 supplied from the A/D converter 81 is input as an input image to the linear predictor 121 and the block generator 122-1. The extremum-pixel-value data supplied from the extremum generator 111 is input to the data combiner 125, and the binary image supplied from the extremum generator 111 is input to the linear predictor 121 and the data combiner 125. The number of bits for quantization supplied from the calculator 112 for calculating the number of bits for quantization is input to the residual encoder 124 and the data combiner 125.

the linear predictor 121 reads the input image, linearly predicts pixels between extrema with respect to the horizontal and vertical directions using the input image and the binary image supplied from the extremum generator 111, and supplies an image composed of linearly predicted pixels (hereinafter also referred to as a predicted image) to the block generator 122-2.

The block generator 122-1 reads the input image, divides the input image into blocks of a designated block size (e.g., 4×4 pixels or 8×8 pixels), and supplies image data of the designated block size to the residual generator 123 as an input block on a block-by-block basis.

The block generator 122-2 reads the predicted image supplied from the linear predictor 121, divides the input image into blocks of the designated block size (e.g., 4×4 pixels or 8×8 pixels), and supplies image data of the designated block size to the residual generator 123 as a predicted block on a block-by-block basis.

The residual generator 123 obtains a residual of the linear prediction. More specifically, the residual generator 123 reads the input block supplied from the block generator 122-1 and the predicted block supplied from the block generator 122-2, and supplies a residual between the predicted block and the input block to the residual encoder 124 as a residual block.

The residual encoder 124 reads the residual block supplied from the residual generator 123, and encodes the residual block. More specifically, the residual encoder 124 calculates a minimum value, a maximum value, and a dynamic range DR of the pixels in the block, ADRC-encodes the residual block using the number of bits for quantization supplied from the calculator 112 for calculating the number of bits for quantization, and supplies resulting quantized bit-code data and the block dynamic range DR and minimum value to the data combiner 125. The method of encoding by the residual encoder 124 is preferably ADRC, but other encoding methods may be used.

The data combiner 125 combines the number of bits for quantization supplied from the calculator 112 for calculating the number of bits for quantization, the quantized bit-code data and the block dynamic range DR and minimum value supplied from the residual encoder 124, and the extremum-pixel-value data and binary image supplied from the extremum generator 111, and outputs resulting encoded data Vcd to the recorder 83 or the decoder 84 at a subsequent stage.

The calculator 112 for calculating the number of bits for quantization shown in FIG. 6 calculates the number of bits for quantization used as an encoding parameter for ADRC encoding by the extremum encoding processor 113. However, when other encoding methods are used by the extremum encoding processor 113, the calculator 112 for calculating the number of bits for quantization shown in FIG. 6 calculates an encoding parameter suitable for an encoding method used by the extremum encoding processor 113 on the basis of the number of extrema.

As described above, the linear predictor 121 performs linear prediction using extrema detected by the extremum generator 111 from the digital image data Vdg1 with white noise added thereto, so that the likelihood of predicted pixels is not so high. This reduces the accuracy of linear prediction.

Furthermore, the calculator 112 for calculating the number of bits for quantization sets the number of bits for quantization for encoding by the residual encoder 124 in accordance with the number of extrema detected by the extremum generator 111 from the digital image data Vdg1 and the residual encoder 124 performs ADRC encoding using the number of bits for quantization, the number of extrema in the digital image data Vdg1 input from the A/D converter 81 increases due to white noise added, so that the amount of data that can be allocated for encoding of the residual decreases.

That is, the accuracy of linear prediction is reduced, and the information content of quantized bit-code data obtained by ADRC encoding of the residual of linear prediction is reduced. Thus, the image quality of the digital image data Vdg2 obtained through decoding of the encoded data Vcd by the decoder 84 is degraded.

This inhibits analog copying.

FIG. 7 shows an example configuration of the extremum generator 111 shown in FIG. 6.

In the example shown in FIG. 7, the extremum generator 111 includes a raster scanner 131, an extremum checker 132, a binary-image generator 133, and an extremum-pixel-value generator 134.

The raster scanner 131 reads an input image, and moves through the pixels of the input image in order of raster scanning so that the extremum checker 132 selects a next pixel as a subject pixel in order of raster scanning.

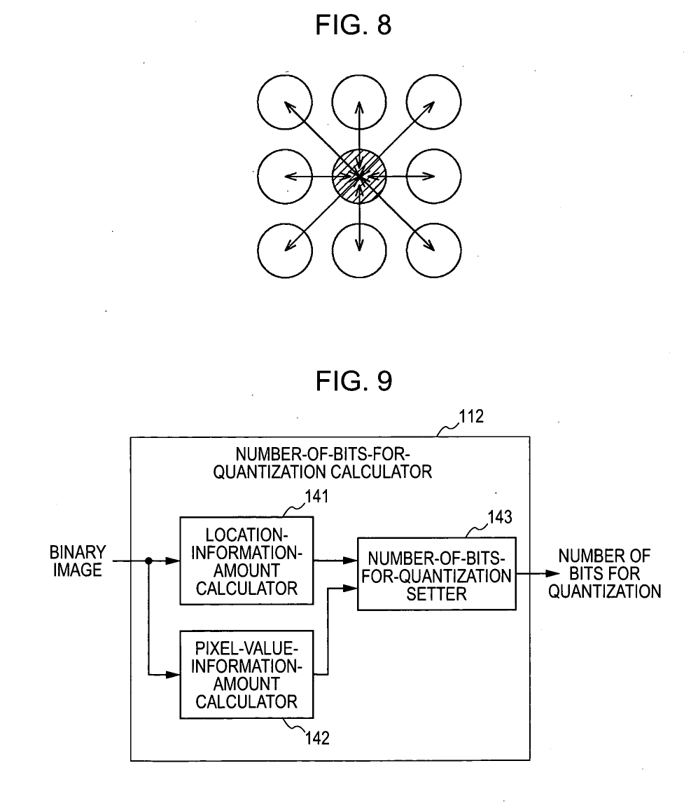

The extremum checker 132 selects a subject pixel in the input image, and determines the magnitude of the pixel value of the subject pixel (the pixel-value level of the luminance signal) using neighboring pixels of the subject pixel. More specifically, referring to FIG. 8, the extremum checker 132 compares the pixel value of the subject pixel (hatched in FIG. 8) with the pixel values of the eight pixels neighboring the subject pixel vertically, horizontally, and diagonally. The extremum checker 132 determines that the subject pixel has an extremum when the pixel value of the subject pixel is a maximum value or a minimum value compared with the pixel values of the eight neighboring pixels, i.e., when the quadratic differentiation of the waveform of pixel-value distribution at the location of the subject pixel yields 0. That is, even when no neighboring pixel has a pixel value greater than the pixel value of the subject pixel, the subject pixel is not determined as having an extremum if one or more neighboring pixels have the same greatest pixel value as the subject pixel.

The binary-image generator 133 generates a binary image by setting 255 as the pixel value of each pixel of the binary image corresponding to each subject pixel of the input image determined by the extremum checker 132 as having an extremum while setting 0 as the pixel value of each pixel of the binary image corresponding to each subject pixel of the input image determined by the extremum checker 132 as not having an extremum. The binary-image generator 133 then supplies the binary image to the calculator 112 for calculating the number of bits for quantization, the linear predictor 121, and the data combiner 125. Furthermore, the binary-image generator 133 controls the extremum-pixel-value generator 134 to store the pixel value of each subject pixel determined as having an extremum.

The extremum-pixel-value generator 134 stores the pixel value of each subject pixel determined as having an extremum as extremum-pixel-value data, and supplies the extremum-pixel-value data to the data combiner 125.

FIG. 9 shows an example configuration of the calculator 112 for calculating the number of bits for quantization shown in FIG. 6.

In the example shown in FIG. 9, the calculator 112 for calculating the number of bits for quantization includes a location-information-amount calculator 141, a pixel-value-information-amount calculator 142, and a setter 143 for setting the number of bits for quantization. The binary image supplied from the extremum generator 111 is input to the location-information-amount calculator 141 and the pixel-value-information-amount calculator 142.

The location-information-amount calculator 141 run-length-encodes the binary image and calculates an amount a encoded by the run-length encoding (i.e., the amount of extremum location information), and supplies the amount a of extremum-location information to the setter 143 for setting the number of bits for quantization.

The pixel-value-information-amount calculator 142 counts the number b of extrema in the binary image and calculates the amount c of extremum-pixel-value information (=8 bits×b), and supplies the amount c of extremum-pixel-value information to the setter 143 for setting the number of bits for quantization. 8 bits is an amount of information used to represent a pixel value.

The setter 143 for setting the number of bits for quantization subtracts the amount of extremum information (the amount a of extremum-location information+the amount c of extremum-pixel-value information) from a desired amount of information to calculate an amount d of information that can be allocated for pixels other than extremum pixels (an amount of information that can be allocated for encoding of a residual). That is, the amount d of information that can be allocated for pixels other than extremum pixels is “a desired amount of information−c−a”. The desired amount of information refers to the amount of information of desired encoded data Vcd that is to be passed to a subsequent stage.

For example, when the number q of bits for quantization (initially 10) is set and the number of blocks is e, a total amount f of information can be expressed by equation (1) below:
Total amount f of information=(8+8)×e+q×(total number of pixels−b) (1)

A dynamic range DR and a minimum value are each represented using 8 bits allocated thereto. In equation (1), the first “8” represents 8 bits for the dynamic range DR, and the second “8” represents 8 bits for the minimum value.

The setter 143 for setting the number of bits for quantization calculates the total information amount f according to equation (1), and sets the number q of bits for quantization with which the total information amount f exhibits a maximum information amount within the information amount d as the number of bits for quantization to be obtained.

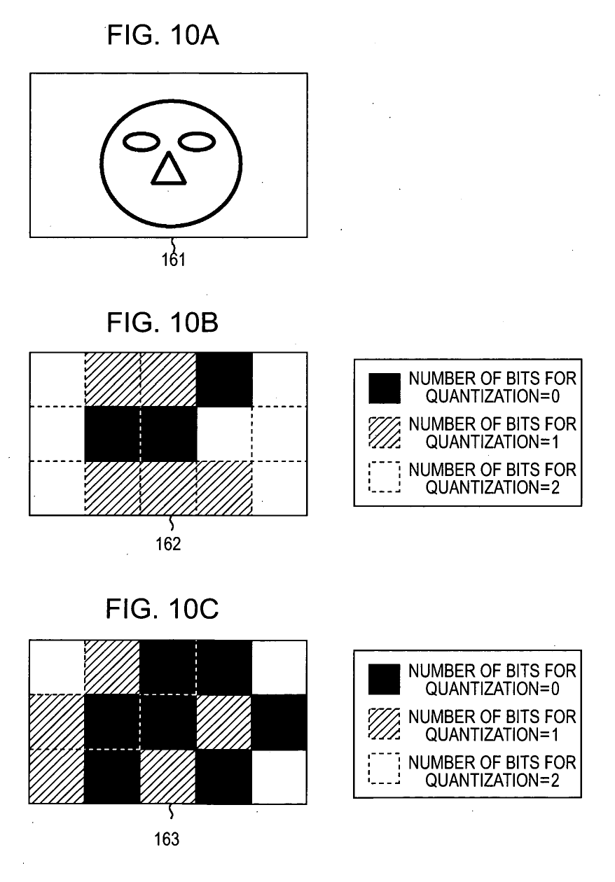

Now, the relationship between white noise and the number of bits for quantization calculated in accordance with the number of extrema will be described with reference to FIGS. 10A to 10C.

FIG. 10A shows an example of an original image 161 corresponding to the digital image data Vdg0 decoded by the decoder 71 shown in FIG. 2, in which a human face is represented in a central region. FIG. 10B schematically shows an example of a distribution 162 for the number of bits for quantization, which is a distribution of the number of bits for quantization calculated using extrema in the original image 161. FIG. 10C shows an example of a distribution 163 for the number of bits for quantization, which is a distribution of the number of bits for quantization calculated using the digital image data Vdg1 with white noise added thereto.

In the distributions 162 and 163 of the number of bits for quantization, blocks of 3 rows×5 columns are each composed of, for example, 4×4 pixels. Each block shown as black is a block for which the number of bits for quantization of 0 is set. Each block shown as hatched is a block for which the number of bits for quantization of 1 is set. Each block shown as white is a block for which the number of bits for quantization of 2 is set. The accuracy of encoding of a block increases as the number of bits for quantization for the block increases.

In the distribution 162 for the number of bits for quantization, the numbers of bits for quantization for the blocks on the first row are 2, 1, 1, 0, and 2 in that order from the left. The numbers of bits for quantization for the blocks on the second row are 2, 0, 0, 2, and 2 in that order from the left. The numbers of bits for quantization for the blocks on the third row are 2, 1, 1, 1, and 2 in that order from the left.

That is, regarding the distribution 162 of the number of bits for quantization, since the background of the person in the original image 161 is rather monotonous and does not include many extrema, the number of bits for quantization of 2 is set for blocks of the background. In contrast, blocks in the central region of the image representing details (profiles or the like) of the human face such as the eyes and the nose include a large amount of high-frequency components and therefore a large number of extrema, so that the number of bits for quantization of 0 or 1 is set.

On the other hand, in the distribution 163 of the number of bits for quantization, the numbers of bits for quantization for the blocks on the first row are 2, 1, 0, 0, and 2 in that order from the left. The numbers of bits for quantization for the blocks on the second row are 1, 0, 0, 1, and 0 in that order from the left. The numbers of bits for quantization for the blocks on the third row are 1, 0, 1, 0, and 2 in that order from the left.

That is, in the case of the distribution 163 of the number of bits for quantization, extremum due to the effect of white noise are detected, so that the number of bits for quantization of 0 or 1 is set for the blocks of the background of the person, which is rather monotonous in the original image 161. Furthermore, in the blocks in the central region of the image representing details of the human face such as the eyes and the nose, the number of extrema increases due to the effect of white noise, so that the number of bits for quantization of 0 or 1 is set for a larger number of pixels.

As described above, in the distribution 163 of the number of bits for quantization, compared with the distribution 162 of the number of bits for quantization, the number of bits for quantization tends to be smaller since more extrema are detected due to the effect of white noise. This reduces the accuracy of encoding by the residual encoder 124, which encodes a residual on the basis of the number of bits for quantization.

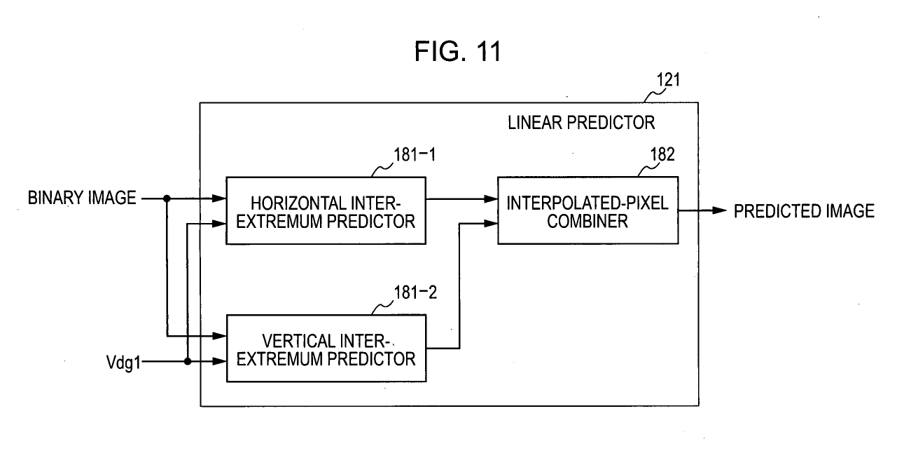

FIG. 11 shows an example configuration of the linear predictor 121 shown in FIG. 6.

In the example shown in FIG. 11, the linear predictor 121 includes a horizontal inter-extremum predictor 181-1, a vertical inter-extremum predictor 181-2, and an interpolated-pixel combiner 182.

The horizontal inter-extremum predictor 181-1 reads an input image Vdg1 and a binary image supplied from the extremum generator 111, predicts pixel values between horizontal pairs of extrema using the extrema, and supplies the pixel values predicted to the interpolated-pixel combiner 182 as a horizontally linear-interpolated image.

The vertical inter-extremum predictor 181-2 reads the input image Vdg1 and the binary image supplied from the extremum generator 111, predicts pixel values between vertical pairs of extrema using the extrema, and supplies the pixel values predicted to the interpolated-pixel combiner 182 as a vertically linear-interpolated image.

The interpolated-pixel combiner 182 includes a memory (not shown) having a predicted-image area. The interpolated-pixel combiner 182 reads the horizontally linear-interpolated image supplied from the horizontal inter-extremum predictor 181-1 and the vertically linear-interpolated image supplied from the vertical inter-extremum predictor 181-2, averages the pixel values of these interpolated images, and stores the pixel values calculated in the predicted-image area thereby generating a predicted image, and supplies the predicted image to the block generator 122-2. In the predicted image, values are missing at the locations of the extrema.

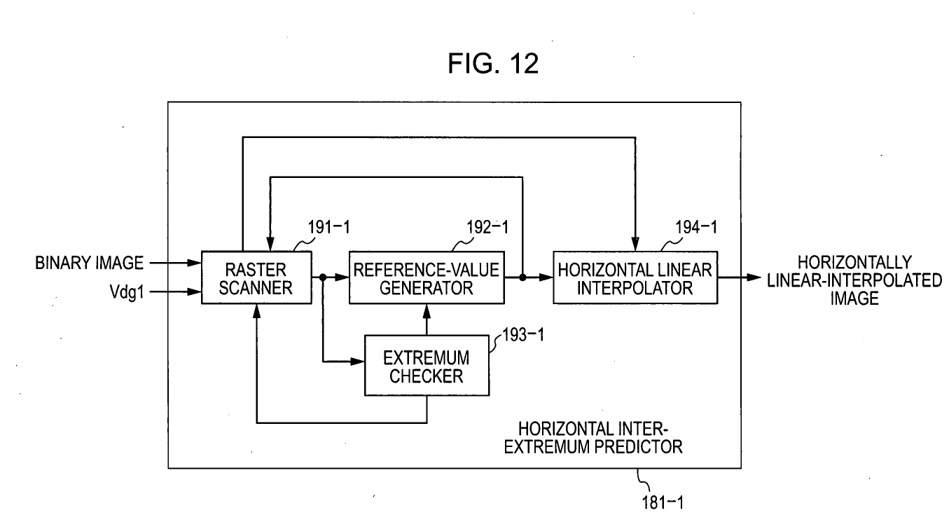

FIG. 12 shows an example configuration of the horizontal inter-extremum predictor 181-1.

In the example shown in FIG. 12, the horizontal inter-extremum predictor 181-1 includes a raster scanner 191-1, a reference-value generator 192-1, an extremum checker 193-1, and a horizontal linear interpolator 194-1.

The raster scanner 191-1 reads the binary image and the input image Vdg1, and selects a subject pixel by moving through the pixels of the binary image and the input image Vdg1 in order of raster scanning in the horizontal direction. Furthermore, when the subject pixel is not an endpoint pixel, the raster scanner 191-1 selects a pixel at a right reference-value location Rloc supplied from the reference-value generator 192-1 as a next subject pixel. On the other hand, when the subject pixel is an endpoint pixel, the raster scanner 191-1 controls the horizontal linear interpolator 194-1 to supply a horizontally linear-interpolated image to the interpolated-pixel combiner 182.

The input image Vdg1 read by the raster scanner 191-1 is also referred to by the reference-value generator 192-1, and the binary image read by the raster scanner 191-1 is also referred to by the extremum checker 193-1.

The reference-value generator 192-1 declares four variables, namely, a left reference value Lpix, a right reference value Rpix, a left reference-value location Lloc, and a right reference-value location Rloc. The reference-value generator 192-1 assigns the pixel value of the subject pixel selected by the raster scanner 191-1 to the left reference value Lpix, assigns the pixel location of the subject pixel to the left reference-value location Lloc, and supplies the left reference value Lpix and the left reference-value location Lloc to the horizontal linear interpolator 194-1.

Furthermore, in accordance with the result of checking by the extremum checker 193-1, the reference-value generator 192-1 assigns the pixel value of the subject pixel to the right reference value Rpix, assigns the pixel location of the subject pixel to the right reference-value location Rloc, and supplies the right reference value Rpix and the right reference-value location Rloc to the horizontal linear interpolator 194-1. At this time, the right reference-value location Rloc is also supplied to the raster scanner 191-1.

The extremum checker 193-1 checks whether the pixel value of the subject pixel selected by the raster scanner 191-1 is an extremum in the binary image. The raster scanner 191-1 moves horizontally rightward and selects a subject pixel until it is determined that the pixel value of the subject pixel is an extremum in the binary image. When it is determined that the pixel value of the subject pixel is an extremum in the binary image, the extremum checker 193-1 controls the reference-value generator 192-1 to assign the pixel value of the subject pixel to the right reference value Rpix and assigns the pixel location of the subject pixel to the right reference-value location Rloc.

The horizontal linear interpolator 194-1 includes a memory (not shown) having an image area for linear interpolation. The horizontal linear interpolator 194-1 performs linear interpolation between horizontal pairs of extrema using the left reference value Lpix, the right reference value Rpix, the left reference-value location Lloc, and the right reference-value location Rloc generated by the reference-value generator 192-1, thereby predicting pixel values between horizontal pairs of extrema, and stores the pixel values predicted in the image area for linear interpolation. When the prediction of pixel values between the horizontal pairs of extrema is finished, the horizontal linear interpolator 194-1 supplies the pixel values stored in the image area to the interpolated-pixel combiner 182 as a horizontally linear-interpolated image.

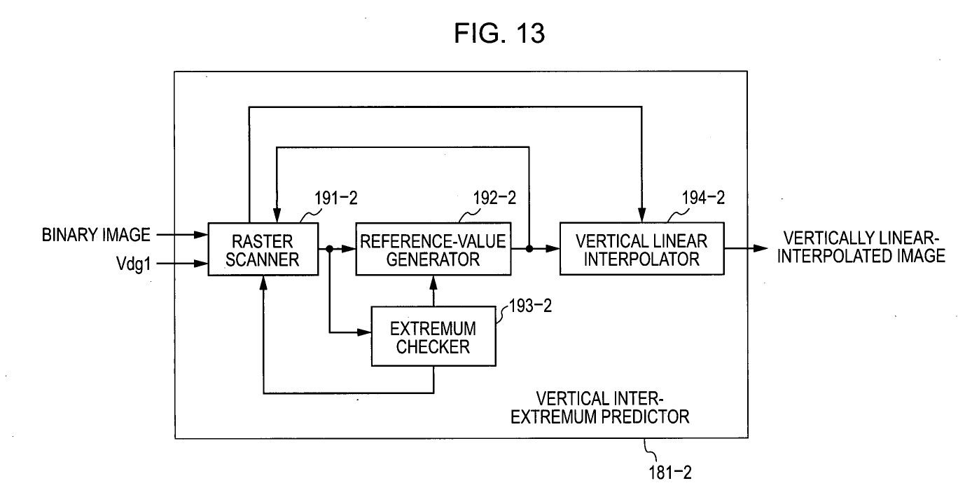

FIG. 13 shows an example configuration of the vertical inter-extremum predictor 181-2 shown in FIG. 11. The configuration of the vertical inter-extremum predictor 181-2 shown in FIG. 13 is substantially the same as the configuration of the horizontal inter-extremum predictor 181-1 shown in FIG. 12, except in that the direction of prediction differs.

In the example shown in FIG. 13, the vertical inter-extremum predictor 181-2 includes a raster scanner 191-2, a reference-value generator 192-2, an extremum checker 193-2, and a vertical linear interpolator 194-2.

The raster scanner 191-2 reads the binary image and the input image Vdg1, and selects a subject pixel by moving through the pixels of the binary image and the input image Vdg1 in order of raster scanning in the vertical direction. Furthermore, when the subject pixel is not an endpoint pixel, the raster scanner 191-2 selects a pixel at a down reference-value location Dloc supplied from the reference-value generator 192-2 as a next subject pixel. On the other hand, when the subject pixel is an endpoint pixel, the raster scanner 191-2 controls the vertical linear interpolator 194-2 to supply a vertically linear-interpolated image to the interpolated-pixel combiner 182.

The reference-value generator 192-2 declares four variables, namely, an up reference value Upix, a down reference value Dpix, an up reference-value location Uloc, and a down reference-value location Dloc. The reference-value generator 192-2 assigns the pixel value of the subject pixel selected by the raster scanner 191-2 to the up reference value Upix, assigns the pixel location of the subject pixel to the up reference-value location Uloc, and supplies the up reference value Upix and the up reference-value location Uloc to the vertical linear interpolator 194-2.

Furthermore, in accordance with the result of checking by the extremum checker 193-2, the reference-value generator 192-2 assigns the pixel value of the subject pixel to the down reference value Dpix, assigns the pixel location of the subject pixel to the down reference-value location Dloc, and supplies the down reference value Dpix and the down reference-value location Dloc to the vertical linear interpolator 194-2. At this time, the down reference-value location Dloc is also supplied to the raster scanner 191-2.

The extremum checker 193-2 checks whether the pixel value of the subject pixel selected by the raster scanner 191-2 is an extremum in the binary image. The raster scanner 191-2 moves vertically downward and selects a subject pixel until it is determined that the pixel value of the subject pixel is an extremum in the binary image. When it is determined that the pixel value of the subject pixel is an extremum in the binary image, the extremum checker 193-2 controls the reference-value generator 192-2 to assign the pixel value of the subject pixel to the down reference value Dpix and assigns the pixel location of the subject pixel to the down reference-value location Dloc.

The vertical linear interpolator 194-2 includes a memory (not shown) having an image area for linear interpolation. The vertical linear interpolator 194-2 performs linear interpolation between vertical pairs of extrema using the up reference value Upix, the down reference value Dpix, the up reference-value location Uloc, and the down reference-value location Dloc generated by the reference-value generator 192-2, thereby predicting pixel values between vertical pairs of extrema, and stores the pixel values predicted in the image area for linear interpolation. When the prediction of pixel values between the vertical pairs of extrema is finished, the vertical linear interpolator 194-2 supplies the pixel values stored in the image area to the interpolated-pixel combiner 182 as a vertically linear-interpolated image.

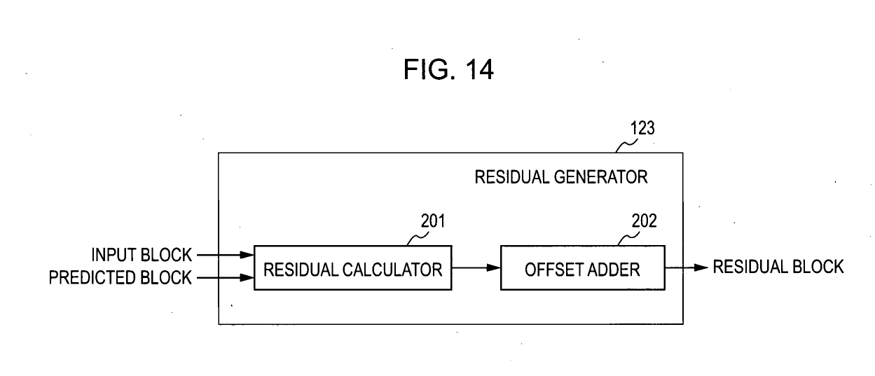

FIG. 14 shows an example configuration of the residual generator 123 shown in FIG. 6.

In the example shown in FIG. 14, the residual generator 123 includes a residual calculator 201 and an offset adder 202.

The residual calculator 201 reads an input block supplied from the block generator 122-1 and a predicted block supplied from the block generator 122-2, calculates a residual between the input block and the predicted block, and supplies the residual to the offset adder 202.

The offset adder 202 offsets the residual for the purpose of ADRC encoding by the residual encoder 124. More specifically, the offset adder 202 adds 128 to the residual supplied from the residual calculator 201, and supplies the resulting residual with an offset of 128 to the residual encoder 124 as a residual block. The value added as an offset is not limited to 128. When 128 is used as an offset added, values that remain negative even with an offset of 128 added thereto are replaced by 0s.

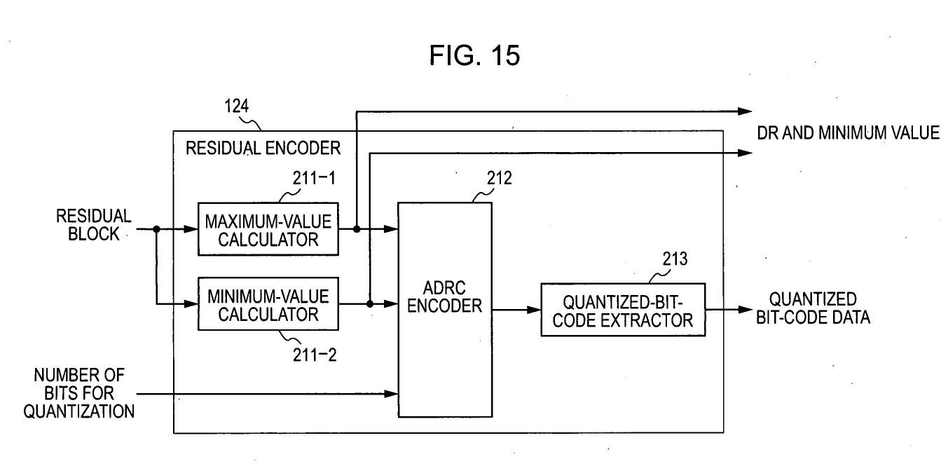

FIG. 15 shows an example configuration of the residual encoder 124 shown in FIG. 6.

In the example shown in FIG. 15, the residual encoder 124 includes a maximum-value calculator 211-1, a minimum-value calculator 211-2, an ADRC encoder 212, and a quantized-bit-code extractor 213.

The maximum-value calculator 211-1 reads the residual block supplied from the residual generator 123, calculates a maximum value among the pixel values in the residual block, and supplies the maximum value to the ADRC encoder 212 and the data combiner 125. The minimum-value calculator 211-2 reads the residual block supplied from the residual generator 123, calculates a minimum value among the pixel values in the residual block, and supplies the minimum value to the ADRC encoder 212 and the data combiner 125. That is, a minimum value and a dynamic range DR (maximum value−minimum value) are supplied from the maximum-value calculator 211-1 and the minimum-value calculator 211-2.

The ADRC encoder 212 reads the number of bits for quantization supplied from the calculator 112 for calculating the number of bits for quantization, and encodes the pixels of the residual block by ADRC using the number of bits for quantization and the minimum value and the dynamic range DR (maximum value−minimum value) in the residual block.

The quantized-bit-code extractor 213 extracts quantized bit-code data from the values ADRC-encoded by the ADRC encoder 212, and supplies the quantized bit-code data to the data combiner 125.

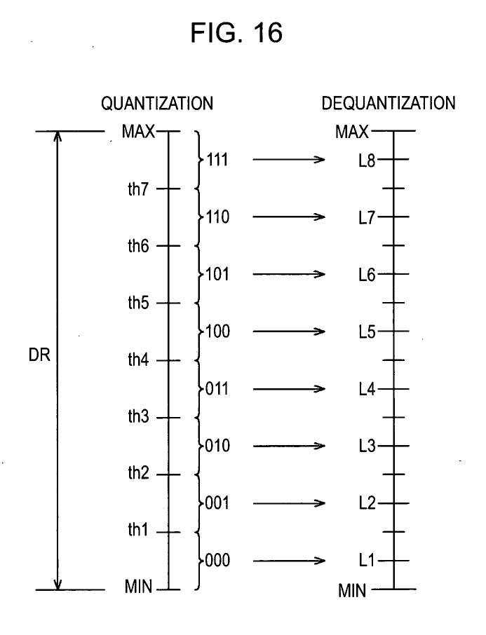

FIG. 16 is a diagram for explaining a scheme of quantization and dequantization in ADRC performed by the ADRC encoder 212.

FIG. 16 shows a dynamic range DR in a case of quantization by the number of bits for quantization of 3 (left part of the figure) and pixel values in a case of corresponding dequantization (right part in the figure).

In this quantization, since the number of bits for quantization is 3, a dynamic range defined by a minimum value MIN corresponding to a minimum pixel value before the quantization and a maximum value MAX corresponding to a maximum pixel value before the quantization is equally divided into 8 (=2³) ranges by thresholds th1 to th7, so that pixels having pixel values in the ranges defined by the thresholds are quantized as corresponding quantized bit-code data (000, 001, 010, 100, 101, 110, 111) represented by 3 bits.

More specifically, each pixel having a pixel value in the range defined by the minimum value MIN and the threshold th1 is quantized as a quantized bit code 000. Each pixel having a pixel value in the range defined by the threshold th1 and the threshold th2 is quantized as a quantized bit code 001. Each pixel having a pixel value in the range defined by the threshold th2 and the threshold th3 is quantized as a quantized bit code 010. Each pixel having a pixel value in the range defined by the threshold th3 and the threshold th4 is quantized as a quantized bit code 011.

Each pixel having a pixel value in the range defined by the threshold th4 and the threshold th5 is quantized as a quantized bit code 100. Each pixel having a pixel value in the range defined by the threshold th5 and the threshold th6 is quantized as a quantized bit code 101. Each pixel having a pixel value in the range defined by the threshold th6 and the threshold th7 is quantized as a quantized bit code 110. Each pixel having a pixel value in the range defined by the threshold th7 and the maximum value MAX is quantized as a quantized bit code 111.

In the corresponding dequantization, midpoint values L1 to L8 of the ranges used for quantization are used. More specifically, each quantized bit code 000 is dequantized into the midpoint value L1 of the range defined by the minimum value MIN and the threshold th1. Each quantized bit code 001 is dequantized into the midpoint value L2 of the. range defined by the threshold th1 and the threshold th2. Each quantized bit code 010 is dequantized into the midpoint value L3 of the range defined by the threshold th2 and the threshold th3. Each quantized bit code 011 is dequantized into the midpoint value L4 of the range defined by the threshold th3 and the threshold th4.

Each quantized bit code 100 is dequantized into the midpoint value L5 of the range defined by the threshold th4 and the threshold th5. Each quantized bit code 101 is dequantized into the midpoint value L6 of the range defined by the threshold th5 and the threshold th6. Each quantized bit code 110 is dequantized into the midpoint value L7 of the range defined by the threshold th6 and the threshold th7. Each quantized bit code 111 is dequantized into the midpoint value L8 of the range defined by the threshold th7 and the maximum value MAX.

Thus, the minimum value after the dequantization is the value L1 and the maximum value after the dequantization is the value L8, so that the dynamic range after the dequantization is defined by the value L1 and the value L8. That is, as shown in FIG. 16, the minimum value after the dequantization, i.e., the value L1, is somewhat greater than the minimum value MIN used in the quantization, and the maximum value after the dequantization, i.e., the value L8, is somewhat less than the maximum value MAX used in the quantization, so that the dynamic range decreases.

As described above, in ADRC quantization and dequantization, the dynamic range decreases due to the differences in the minimum value MIN and the maximum value MAX between quantization and dequantization.

Now, the encoding process executed by the encoder 82 shown in FIG. 2 will be described with reference to a flowchart shown in FIG. 17. The encoding process corresponds to the encoding process in step S5 executed by the encoding apparatus 63 as described earlier with reference to FIG. 5.

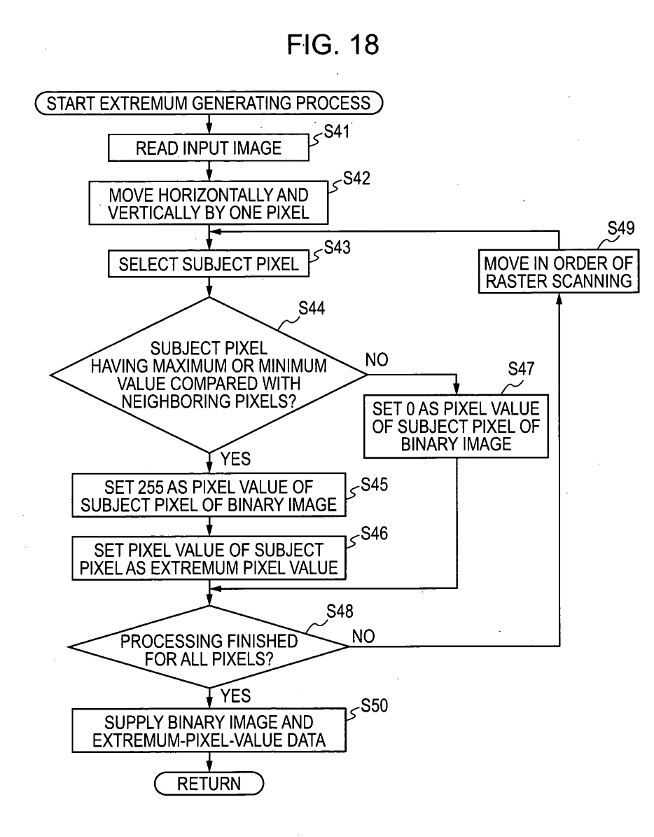

In the encoder 82, the extremum generator 111, the linear predictor 121, and the block generator 122-1 receive input of digital image data Vdg1 from the A/D converter 81. Upon receiving input of the digital image data Vdg1 from the A/D converter 81, the extremum generator 111 executes an extremum generating process in step S121. The extremum generating process will be described later in detail with reference to FIG. 18.

Through the extremum generating process in step S21, extrema are detected from the input image, and a binary image in which extremum-pixel-value data and extremum locations are recorded is calculated. The process then proceeds to step S22. At this time, the binary image calculated is supplied to the calculator 112 for calculating the number of bits for quantization and the extremum encoding processor 113, and the extremum-pixel-value data is supplied to the extremum encoding processor 113.

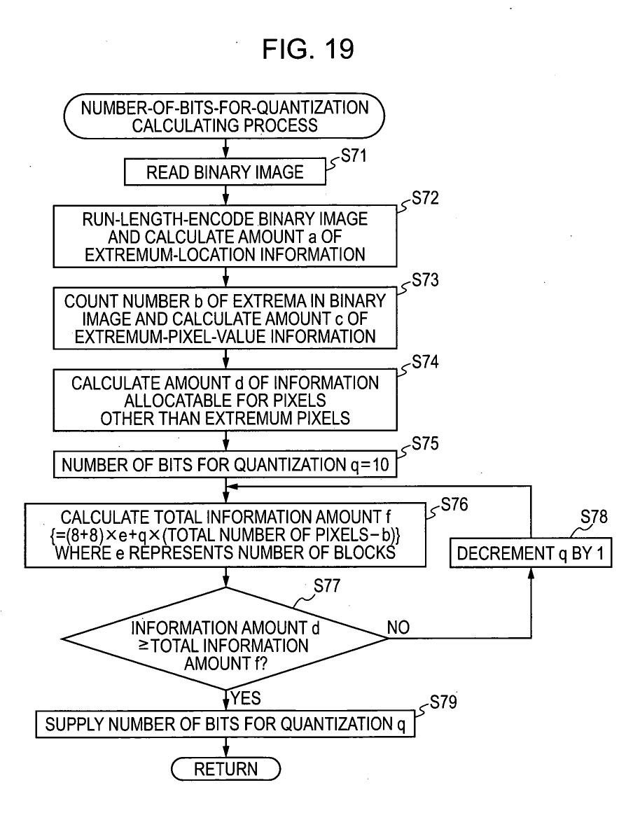

Upon receiving the binary image from the extremum generator 111, in step S22, the calculator 112 for calculating the number of bits for quantization executes a process for calculating an encoding parameter (the number of bits for quantization) that is used in encoding by the extremum encoding processor 113. The process for calculating the number of bits for quantization will be described later in detail with reference to FIG. 19.

Through the process for calculating the number of bits for quantization in step S22, the number of bits for quantization is calculated using the binary image supplied from the extremum generator 111, and the number of bits for quantization is supplied to the residual encoder 124 and the data combiner 125. The process then proceeds to step S23.

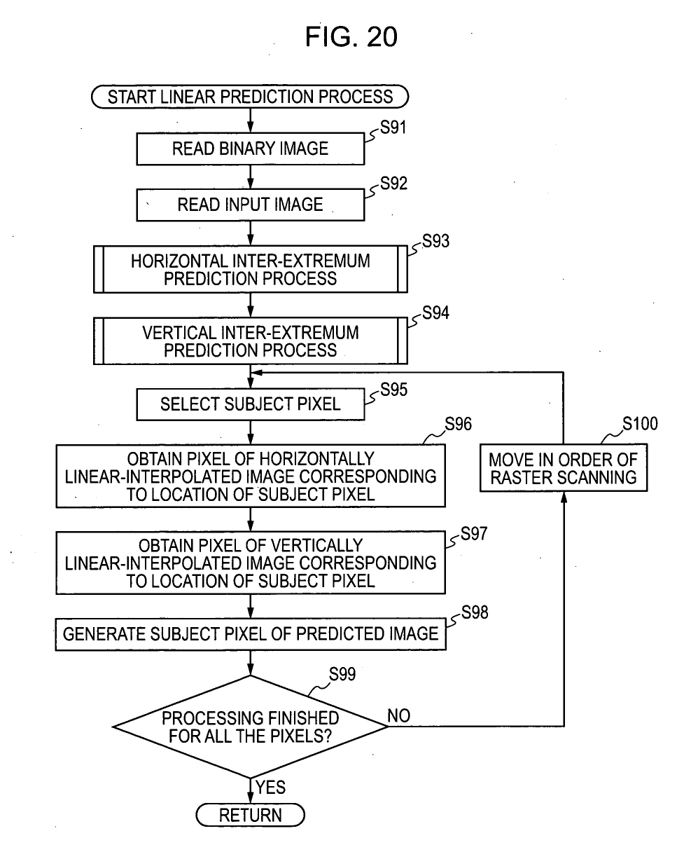

Upon receiving the binary image from the extremum generator 111, in step S23, the linear predictor 121 executes a linear prediction process. The linear prediction process will be described later in detail with reference to FIG. 20.

Through the linear prediction process in step S23, pixels between pairs of extrema are linearly predicted with respect to the horizontal and vertical directions using the input image and the binary image, and a predicted image composed of linearly predicted pixels is supplied to the block generator 122-2. The process then proceeds to step S24.

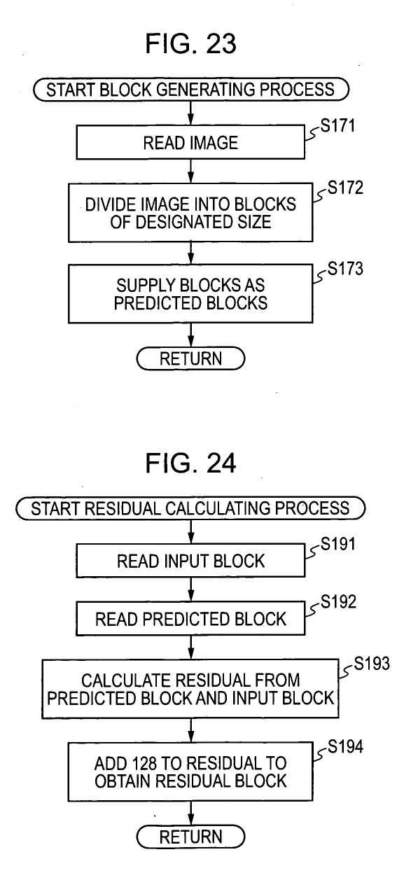

Upon receiving the predicted image from the linear predictor 121, in step S24, the block generator 122-2 executes a predicted-image block generating process. The block generating process will be described later in detail with reference to FIG. 23.

Through the block generating process in step S24, the predicted image supplied from the linear predictor 121 is divided into blocks of a designated block size, and the blocks are supplied to the residual generator 123 as predicted blocks on a block-by-block basis. The process then proceeds to step S25.

Upon receiving the digital image data Vdg1 from the A/D converter 81, in step S25, the block generator 122-1 executes an input-image block generating process. The block generating process is substantially the same as the block generating process in step S24 described later with reference to FIG. 23, so that repeated detailed description thereof will be refrained.

Through the block generating process in step S24, the input image is read and is divided into blocks of a designated block size, and the blocks are supplied to the residual generator 123 as input blocks on a block-by-block basis. The process then proceeds to step S26.

Upon receiving an input block and a predicted block from the block generator 122-1 and the block generator 122-2, in step S26, the residual generator 123 executes a residual calculating process. The residual calculating process will be described later in detail with reference to FIG. 24.

Through the residual calculating process in step S26, the input block and the predicted block are read, a residual block is calculated from the input block and the predicted block, and the residual block is supplied to the residual encoder 124. The process then proceeds to step S27.

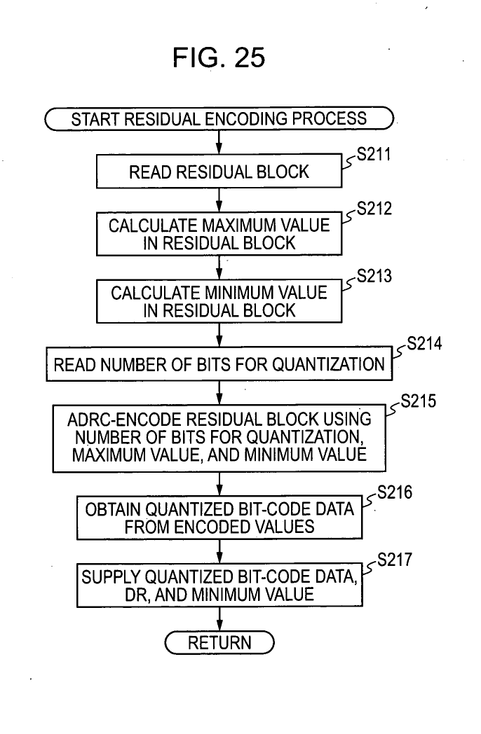

Upon receiving the residual block from the residual generator 123, in step S27, the residual encoder 124 executes a residual encoding process. The residual encoding process will be described later in detail with reference to FIG. 25.

Through the residual encoding process in step S27, the residual block supplied from the residual generator 123 is ADRC-encoded on the basis of the number of bits for quantization supplied from the calculator 112 for calculating the number of bits for quantization, and a minimum value and a dynamic range DR of the residual block and quantized bit-code data yielded by the ADRC encoding are supplied to the data combiner 125. The process then proceeds to step S28.

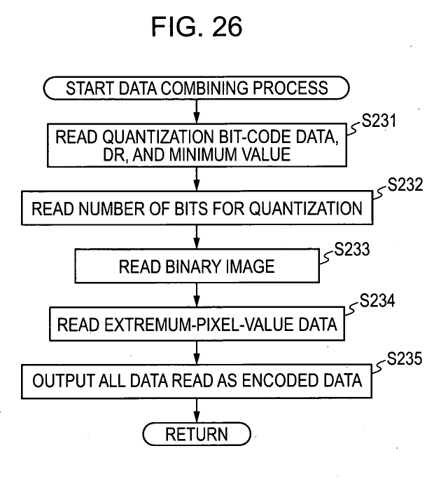

Upon receiving the quantized bit-code data from the residual encoder 124, in step S28, the data combiner 125 executes a data combining process. The data combining process will be described later in detail with reference to FIG. 26.

Through the data combining process in step S28, the extremum-pixel-value data and the binary image supplied from the extremum generator 111, the number of bits for quantization supplied from the calculator 112 for calculating the number of bits for quantization, and the quantized bit-code data, the minimum value, and the dynamic range supplied from the residual encoder 124 are combined to form encoded data Vcd, and the encoded data Vcd is output to the recorder 83 or the decoder 84 at a subsequent stage.

The encoding process by the encoder 82 is then exited. The process then returns to step S5 shown in FIG. 5 and proceeds to step S6, in which a decoding process is executed.

Now, the extremum generating process in step S21 shown in FIG. 17, executed by the extremum generator 111 shown in FIG. 6, will be described with reference to a flowchart shown in FIG. 18.

In step S41, the raster scanner 131 of the extremum generator 111 reads digital image data Vdg1 input from the A/D converter 81 as an input image. In step S42, the raster scanner 131 moves horizontally and vertically by one pixel in the input image. The process then proceeds to step S43.

In step S43, the extremum checker 132 selects a subject pixel in accordance with the movement of the raster scanner 131. In step S44, the extremum checker 132 determines whether the subject pixel has a maximum value or a minimum value compared with the pixel values of the neighboring 8 pixels as described earlier with reference to FIG. 8.

When it is determined in step S44 that the subject pixel has a maximum value or a minimum value compared with the pixel values of the eight neighboring pixels, the extremum checker 132 defines the subject pixel as having an extrema. Then, in step S45, the extremum checker 132 controls the binary-image generator 133 so that 255 is set as the pixel value of the subject pixel of the binary image corresponding to the subject pixel of the input image defined as having an extrema.

After setting 255 as the pixel value of the subject pixel of the binary image in step S45, in step S46, the binary-image generator 133 controls the extremum-pixel-value generator 134 so that the pixel value of the subject pixel having an extrema is stored as extremum-pixel-value data. The process then proceeds to step S48.

On the other hand, when it is determined in step S44 that the subject pixel does not have a maximum value or a minimum value compared with the pixel values of the eight neighboring pixels, the subject pixel does not have an extremum. Then, in step S47, the extremum checker 132 controls the binary-image generator 133 so that 0 is set as the pixel value of the subject pixel of the binary image corresponding to the subject pixel of the input image. The process then proceeds to step S48.

In step S48, the binary-image generator 133 checks whether processing for all the pixels of the image has been finished, on the basis of the pixel values of the binary image that have been set. All the pixels herein refer to pixels not including each outermost pixel of the image with respect to the horizontal and vertical directions. That is, pixels at the ends of the image are excluded from processing since it is not possible to compare the pixels with eight neighboring pixels.

When it is determined in step S48 on the basis of the pixel values of the binary image that have been set that processing for all the pixels of the image has not been finished, in step S49, the binary-image generator 133 causes the extremum generator 111 to move through the pixels of the input image in order of raster scanning. The process then returns to step S43, and subsequent steps are repeated. In step S43, the extremum checker 132 selects a next pixel in order of raster scanning as a next subject pixel.

When it is determined in step S48 on the basis of the pixel values of the binary image that have been set that processing for all the pixels of the image has been finished, in step S50, the binary-image generator 133 supplies the binary image generated to the calculator 112 for calculating the number of bits for quantization, the linear predictor 121, and the data combiner 125, and controls the extremum- pixel-value generator 134 so that the extremum-pixel-value data is supplied to the data combiner 125. The extremum generating process is then exited. The process then returns to step S21 shown in FIG. 17, and proceeds to step S22.

Next, the process for calculating the number of bits for quantization in step S22 shown in FIG. 17, executed by the calculator 112 for calculating the number of bits for quantization shown in FIG. 6, will be described with reference to a flowchart shown in FIG. 19.

In the calculator 112 for calculating the number of bits for quantization, in step S71, the location-information-amount calculator 141 and the pixel-value-information-amount calculator 142 reads a binary image supplied from the extremum generator 111. The process then proceeds to step S72.

Upon reading the binary image, in step S72, the location-information-amount calculator 141 run-length-encodes the binary image, calculates an amount a of information encoded by the run-length encoding (i.e., the amount of extremum-location information), and supplies the amount a of extremum-location information to the setter 143 for setting the number of bits for quantization. The process then proceeds to step S73.

Upon reading the binary image, in step S73, the pixel-value-information-amount calculator 142 counts extrema in the binary image to obtain the number b of extrema, calculates an amount c of extremum-pixel-value information (=8 bits×b), and supplies the amount c of extremum-pixel-value information to the setter 143 for setting the number of bits for quantization. The process then proceeds to step S74.

Upon receiving the amount a of extremum-location information from the location-information-amount calculator 141 and the amount c of extremum-pixel-value information from the pixel-value-information-amount calculator 142, in step S74, the setter 143 for setting the number of bits for quantization calculates an amount d of information that can be allocated to pixels other than extremum pixels (=desired amount of information−c−a) using the amount a of extremum-location information and the amount c of extremum-pixel-value information. Then, in step S75, the setter 143 for setting the number of bits for quantization sets 10 (initial value) as the number q of bits for quantization. The process then proceeds to step S76. The initial value of 10 is herein chosen since the value is not empirically possible as the number of bits for quantization and in consideration of processing load. However, the initial value is not limited to 10, and may be other values that are not empirically possible as the number of bits for quantization.

In step S76, the setter 143 for setting the number of bits for quantization calculates a total information amount f expressed by equation (1), where e represents the number of blocks. Then, in step S77, the setter 143 for setting the number of bits for quantization checks whether the total information amount f is less than or equal to the information amount d. When it is determined that the total information amount d is greater than the information amount d, in step S78, the setter 143 for setting the number of bits for quantization decrements the number q of bits for quantization by 1. The process then returns to step S76, and subsequent steps are repeated.

When it is determined in step S77 that the total information amount f is less than or equal to the information amount d, the setter 143 for setting the number of bits for quantization sets the current number q of bits for quantization as the number of bits for quantization that is to be used for ADRC encoding by the residual encoder 124. Then, in step S79, the setter 143 for setting the number of bits for quantization supplies the number q of bits for quantization to the residual encoder 124 and the data combiner 125. The process for calculating the number of bits for quantization is then exited. The process then returns to step S22 shown in FIG. 17, and proceeds to step S23.

Next, the linear prediction process in step S23 shown in FIG. 17, executed by the linear predictor 121 shown in FIG. 6, will be described with reference to a flowchart shown in FIG. 20.

In the linear predictor 121, in step S91, the horizontal inter-extremum predictor 181-1 and the vertical inter-extremum predictor 181-2 read a binary image supplied from the extremum generator 111. Then, in step S92, the horizontal inter-extremum predictor 181-1 and the vertical inter-extremum predictor 181-2 read digital image data Vdg1 input from the A/D converter 81. The process then proceeds to step S93.

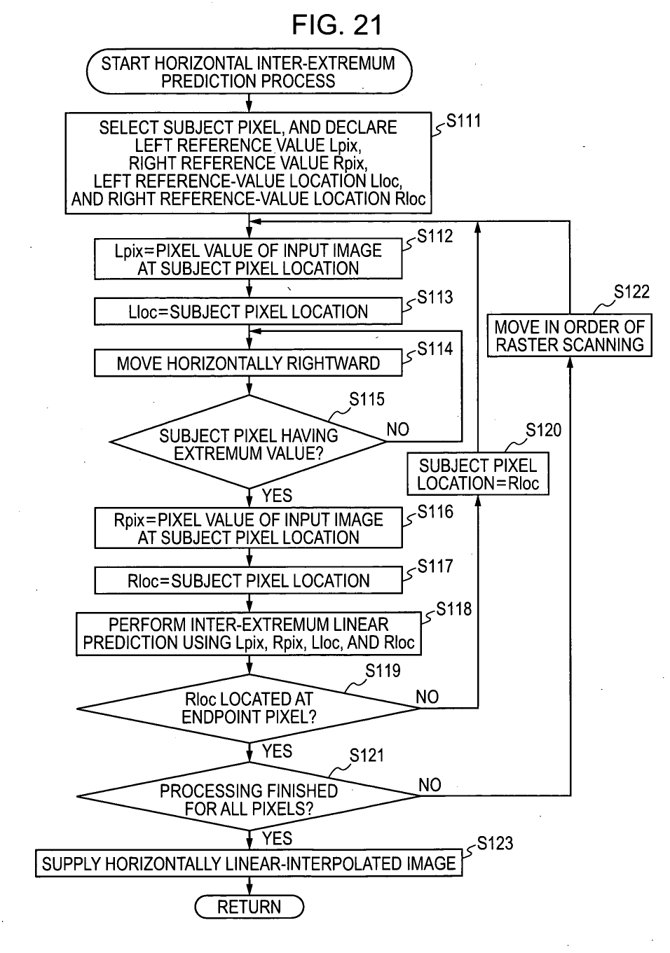

Upon reading the binary image and the input image, in step S93, the horizontal inter-extremum predictor 181-1 performs a horizontal inter-extremum prediction process using the binary image and the input image. The horizontal inter-extremum prediction process will be described later in detail with reference to FIG. 21.

Through the horizontal inter-extremum prediction process in step S93, pixels between horizontal pairs of extrema are linearly predicted using the input image and the binary image, and a horizontally linear-interpolated image composed of linearly predicted pixels is supplied to the interpolated-pixel combiner 182. The process then proceeds to step S94.

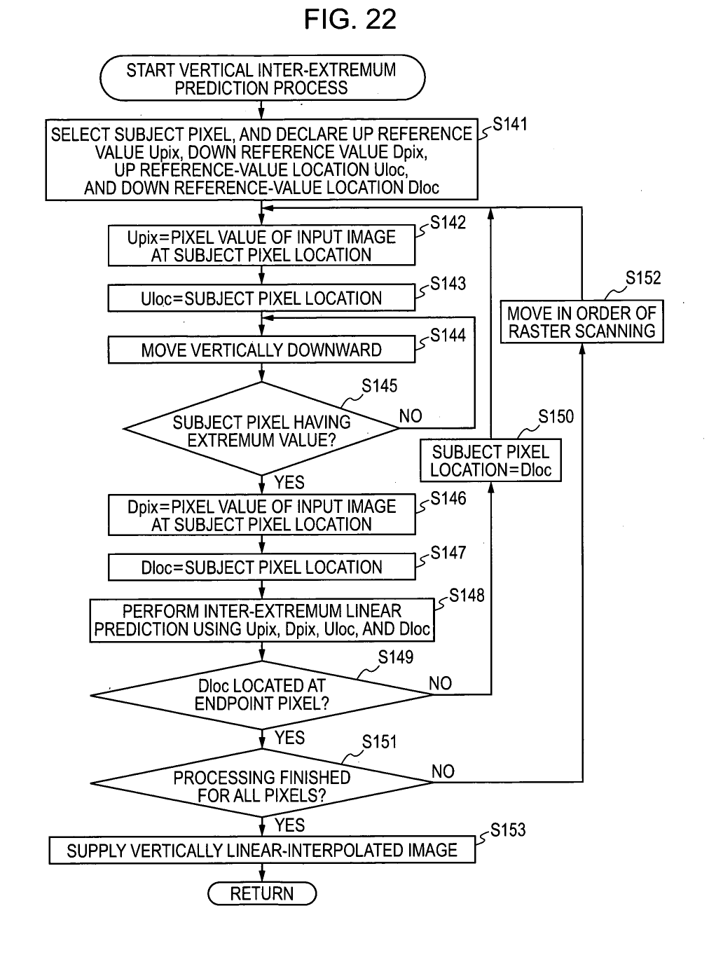

Upon reading the binary image and the input image, in step S94, the vertical inter-extremum predictor 181-2 performs a vertical inter-extremum prediction process using the binary image and the input image. The vertical inter-extremum prediction process will be described later in detail with reference to FIG. 22.

Through the vertical inter-extremum prediction process in step S94, pixels between vertical pairs of extrema are linearly predicted using the input image and the binary image, and a vertically linear-interpolated image composed of linearly predicted pixels is supplied to the interpolated-pixel combiner 182. The process then proceeds to step S95.

Upon receiving the horizontally linear-interpolated image from the horizontal inter-extremum predictor 181-1 and the vertically linear-interpolated image from the vertical inter-extremum predictor 181-2, in step S95, the interpolated-pixel combiner 182 selects a subject pixel in the predicted-image area of its internal memory (not shown). The process then proceeds to step S96.

In step S96, the interpolated-pixel combiner 182 extracts a pixel of the horizontally linear-interpolated image at the location corresponding to the subject pixel. In step S97, the interpolated-pixel combiner 182 extracts a pixel of the vertically linear-interpolated image at the location corresponding to the subject pixel. The process then proceeds to step S98.

In step S98, the interpolated-pixel combiner 182 calculates an average between the pixel values of the horizontally and vertically linear-interpolated images, and stores the resulting pixel value in the predicted-image area, whereby the subject pixel of the predicted image is generated. Then, in step S99, it is checked whether processing for all the pixels has been finished. When it is determined that processing has not been finished for all the pixels, in step S100, a movement in order of raster scanning takes place in the predicted-image area. The process then returns to step S95, in which a next pixel in order of raster scanning is selected as a subject pixel. Then, subsequent steps are repeated.

When it is determined in step S99 that processing for all the pixels has been finished, the interpolated-pixel combiner 182 supplies the predicted image stored in the predicted-image area to the block generator 122-2, and exits the linear prediction process. The process then returns to step S23 shown in FIG. 17, and proceeds to step S24.

Next, the horizontal inter-extremum prediction process in step S93 shown in FIG. 20, executed by the horizontal inter-extremum predictor 181-1, will be described with reference to a flowchart shown in FIG. 21.

In the horizontal inter-extremum predictor 181-1, in step S111, the raster scanner 191-1 selects a subject pixel in the binary image and the input image that have been read, and causes the reference-value generator 192-1 to declare four variables, namely, a left reference value Lpix, a right reference value Rpix, a left reference-value location Lloc, and a right reference-value location Rloc. The process then proceeds to step S112.

In step S112, the reference-value generator 192-1 assigns the pixel value of the input image at the location of the subject pixel selected by the raster scanner 191-1 to the left reference value Lpix, and supplies the left reference value Lpix to the horizontal linear interpolator 194-1. Then, in step S113, the reference-value generator 192-1 assigns the location of the subject pixel to the left reference-value location Lloc, and supplies the left reference-value location Lloc to the horizontal linear interpolator 194-1. The process then proceeds to step S114.

In step S114, the raster scanner 191-1 moves horizontally rightward in the binary image and the input image to select the pixel at the new location as a subject pixel. Then, in step S115, the extremum checker 193-1 checks whether the subject pixel has an extremum with reference to the binary image at the location of the subject pixel.

When it is determined in step S115 with reference to the binary image at the location of the subject pixel that the subject pixel does not have an extremum, the process returns to step S114, and subsequent steps are repeated.

When it is determined in step S115 with reference to the binary image at the location of the subject pixel that the subject pixel has an extremum, in step S116, the reference-value generator 192-1 assigns the pixel value of the input image at the location of the subject pixel to the right reference value Rpix. Then, in step S117, the reference-value generator 192-1 assigns the location of the subject pixel to the right reference-value location Rloc, and supplies the right reference value Rpix and the right reference-value location Rloc to the horizontal linear interpolator 194-1. The process then proceeds to step S118. At this time, the right reference-value location Rloc is also supplied to the raster scanner 191-1.

Upon receiving the right reference value Rpix and the right reference-value location Rloc, in step S118, the horizontal linear interpolator 194-1 performs linear interpolation between horizontal pairs of extrema using the left reference value Lpix, the left reference-value location Lloc, the right reference value Rpix, and the right reference-value location Rloc supplied from the reference-value generator 192-1, thereby predicting the pixel values between the horizontal pairs of extrema, and stores the predicted pixel values in the image area for linear interpolation. The process then proceeds to step S119.

Upon receiving the right reference-value location Rloc, in step S119, the raster scanner 191-1 checks whether the pixel at the right reference-value location Rloc is an endpoint pixel with respect to the horizontal direction. When it is determined that the pixel at the right reference-value location Rloc is not an endpoint pixel with respect to the horizontal direction, in step S120, the raster scanner 191-1 sets the right reference-value location Rloc supplied from the reference-value generator 192-1 as the location of a next subject pixel, i.e., selects the pixel at the right reference-value location Rloc as a next subject pixel. The process then returns to step S112, and subsequent steps are repeated.

When it is determined in step S119 that the pixel at the right reference-value location Rloc is an endpoint pixel with respect to the horizontal direction, in step S121, the raster scanner 191-1 checks whether processing for all the pixels in the image has been finished. When it is determined that processing for all the pixels in the image has not been finished, in step S122, the raster scanner 191-1 moves in order of raster scanning (i.e., to a next horizontal line) in the binary image and the input image to select a new pixel as a subject pixel. The process then returns to step S112, and subsequent steps are repeated.

When it is determined in step S121 that processing for all the pixels in the image has been finished, in step S123, the raster scanner 191-1 controls the horizontal linear interpolator 194-1 so that the pixel values stored in the image area for linear interpolation are supplied to the interpolated-pixel combiner 182 as a horizontally linear-interpolated image. The horizontal inter-extremum prediction process is then exited, and the process returns to step S93 shown in FIG. 20 and proceeds to step S94.

Next, the vertical inter-extremum prediction process in step S94 shown in FIG. 20, executed by the vertical inter-extremum predictor 181-2 shown in FIG. 11, will be described with reference to a flowchart shown in FIG. 22. The vertical inter-extremum prediction process is substantially the same as the horizontal inter-extremum prediction process shown in FIG. 21, except for the direction of prediction.

In the vertical inter-extremum predictor 181-2, in step S141, the raster scanner 191-2 selects a subject pixel in the binary image and the input image that have been read, and causes the reference-value generator 192-2 to declare four variables, namely, an up reference value Upix, a down reference value Dpix, an up reference-value location Uloc, and a down reference-value location Dloc. The process then proceeds to step S142.

In step S142, the raster scanner 191-2 assigns the pixel value of the input image at the location of the subject pixel selected by the raster scanner 191-2 to the up reference value Upix, and supplies the up reference value Upix to the vertical linear interpolator 194-2. Then, in step S143, the reference-value generator 192-2 assigns the location of the subject pixel to the up reference-value location Uloc, and supplies the up reference-value location Uloc to the vertical linear interpolator 194-2. The process then proceeds to step S144.

In step S144, the raster scanner 191-2 moves vertically downward in the binary image and the input image to select a new pixel as a subject pixel. Then, in step S145, the extremum checker 193-2 checks whether the subject pixel has an extremum with reference to the binary image at the location of the subject pixel.

When it is determined in step S145 with reference to the binary image at the location of the subject pixel that the subject pixel does not have an extremum, the process returns to step S144, and subsequent steps are repeated.

When it is determined in step S145 with reference to the binary image at the location of the subject pixel that the subject pixel has an extremum, in step S146, the reference-value generator 192-2 assigns the pixel value of the input image at the location of the subject pixel to the down reference value Dpix. Then, in step S147, the reference-value generator 192-2 assigns the location of the subject pixel to the down reference-value location Dloc, and supplies the down reference value Dpix and the down reference-value location Dloc to the vertical linear interpolator 194-2. The process then proceeds to step S148. At this time, the down reference-value location Dloc is also supplied to the raster scanner 191-2.

Upon receiving the down reference value Dpix and the down reference-value location Dloc, in step S148, the vertical linear interpolator 194-2 performs linear interpolation between vertical pairs of extrema using the up reference value Upix, the down reference value Dpix, the up reference-value location Uloc, and the down reference-value location Dloc supplied from the reference-value generator 192-2, thereby predicting pixel values between the vertical pairs of extrema, and stores the predicted pixel values in the image area for linear interpolation. The process then proceeds to step S149.

Upon receiving the down reference-value location Dloc, in step S149, the raster scanner 191-2 checks whether the pixel at the down reference-value location Dloc is an endpoint pixel with respect to the vertical direction. When it is determined that the pixel at the down reference-value location Dloc is not an endpoint pixel with respect to the vertical direction, in step S150, the raster scanner 191-2 sets the down reference-value location Dloc supplied from the reference-value generator 192-2 as the location of a next subject pixel, i.e., selects the pixel at the down reference-value location Dloc as a next subject pixel. The process then returns to step S142, and subsequent steps are repeated.

When it is determined in step S149 that the pixel at the down reference-value location Dloc is an endpoint pixel with respect to the vertical direction, in step S151, the raster scanner 191-2 checks whether processing for all the pixels in the image has been finished. When it is determined that processing for all the pixels in the image has not been finished, in step S152,. the raster scanner 191-2 moves in order of raster scanning (i.e., to a next vertical line) in the binary image and the input image to select a new pixel as a subject pixel. The process then returns to step S142, and subsequent steps are repeated.

When it is determined in step S151 that processing for all the pixels in the image has been finished, in step S153, the raster scanner 191-2 controls the vertical linear interpolator 194-2 so that the pixel values stored in the image area for linear interpolation are supplied to the interpolated-pixel combiner 182 as a vertically linear-interpolated image. The vertical inter-extremum prediction process is then exited, and the process returns to step S94 shown in FIG. 20 and proceeds to step S95.

Next, the predicted-image block generating process in step S24 shown in FIG. 17, executed by the block generator 122-2 shown in FIG. 6, will be described with reference to a flowchart shown in FIG. 23.

In step S171, the block generator 122-2 reads a predicted image supplied from the linear predictor 121. In step S172, the block generator 122-2 divides the predicted image into blocks of a designated block size (e.g., 4×4 pixels or 8×8 pixels). The process then proceeds to step S173.

In step S173, the block generator 122-2 supplies image data of the designated block size to the residual generator 123 as a predicted block on a block-by-block basis. Then predicted-image block generating process is then exited, and the process returns to step S24 shown in FIG. 17 and proceeds to step S25.

Next, the residual calculating process in step S26 shown in FIG. 17, executed by the residual generator 123 shown in FIG. 6, will be described with reference to a flowchart shown in FIG. 24.

In the residual generator 123, in step S191, the residual calculator 201 reads an input block supplied from the block generator 122-1. The process then proceeds to step S192.

In step S192, the residual calculator 201 reads a predicted block supplied from the block generator 122-2. The process then proceeds to step S193.

In step S193, the residual calculator 201 calculates a residual between the input block supplied from the block generator 122-1 and the predicted block supplied from the block generator 122-2, and supplies the residual to the offset adder 202. The process then proceeds to step S194.

In step S194, the offset adder 202 adds an offset of 128 for ADRC encoding to the residual supplied from the residual calculator 201, and supplies the resulting residual to the residual encoder 124 as a residual block. The residual calculating process is then exited, and the process returns to step S26 shown in FIG. 17 and proceeds to step S27.

Next, the residual encoding process in step S27 shown in FIG. 17, executed by the residual encoder 124 shown in FIG. 6, will be described with reference to a flowchart shown in FIG. 25.

In the residual encoder 124, in step S211, the maximum-value calculator 211-1 and the minimum-value calculator 211-2 reads the residual block supplied from the residual generator 123.

Upon reading the residual block, in step S212, the maximum-value calculator 211-1 calculates a maximum value in the residual block, and supplies the maximum value to the ADRC encoder 212. The process then proceeds to step S213. Upon reading the residual block, in step S213, the minimum-value calculator 211-2 calculates a minimum value in the residual block, and supplies the minimum value to the ADRC encoder 212. The process then proceeds to step S214.

Upon reading the maximum value and minimum value in the residual block, in step S214, the ADRC encoder 212 reads the number of bits for quantization supplied from the calculator 112 for calculating the number of bits for quantization. Then, in step S215, the ADRC encoder 212 performs ADRC encoding using the number of bits for quantization and the minimum value and the dynamic range DR (=maximum value−minimum value) in the residual block. Then, in step S216, the ADRC encoder 212 extracts quantized bit-code data from the ADRC-encoded values. The process then proceeds to step S217.

In step S217, the maximum-value calculator 211-1, the minimum-value calculator 211-2, and the quantized-bit-code extractor 213 supply the dynamic range DR (=maximum value−minimum value), the minimum value, and the quantized bit-code data to the data combiner 125, respectively. The residual encoding process is then exited, and the process returns to step S27 shown in FIG. 17 and proceeds to step S28.

Next, the data combining process in step S28 shown in FIG. 17, executed by the data combiner 125 shown in FIG. 6, will be described with reference to a flowchart shown in FIG. 26.

In step S231, the data combiner 125 reads the quantized bit-code data, the dynamic range DR, and the minimum value supplied from the residual encoder 124. Then, in step S232, the data combiner 125 reads the number of bits for quantization supplied from the calculator 112 for calculating the number of bits for quantization. The process then proceeds to step S233.

In step S233, the data combiner 125 reads a binary image supplied from the extremum generator 111. Then, in step S234, the data combiner 125 reads extremum-pixel-value data supplied from the extremum generator 111. The process then proceeds to step S235.

In step S235, the data combiner 125 combines all the data that has been read (i.e., the quantized bit-code data, the dynamic range DR, the minimum value, the binary image, and the extremum-pixel-value data), and supplies resulting encoded data Vcd to the recorder 83 or the decoder 84 at a subsequent stage.

The data combiner 125 then exits the data combining process. The process then returns to step S28 and exits the encoding process shown in FIG. 17. The process then returns to step S5 shown in FIG. 5 and proceeds to step S6.

As described above, in the encoder 82, extrema are detected from digital image data Vdg1, and linear prediction is performed on the basis of the extrema detected. Furthermore, a residual after the linear prediction is ADRC-encoded by the number of bits for quantization that is set on the basis of the number of extrema detected, and extremum information such as extremum pixel values and the number of extrema (binary image), the specified number of bits for quantization, a dynamic range and a minimum value of the residual, and quantized bit-code data obtained by the ADRC encoding of the residual are supplied to a subsequent stage as encoded data Vcd.

Since white noise is added to the digital image data Vdg1 input from the A/D converter 81 so that the pixel values of pixels with the white noise added thereto can have extrema, accurate linear prediction based on the extrema is inhibited, so that the likelihood of the residual after the linear prediction is not so high.

Furthermore, the number of extrema increases due to the effect of the white noise, so that the number of bits for quantization that is set on the basis of the number of extrema decreases. This inhibits accurate ADRC encoding of the residual on the basis of the number of bits for quantization.

Thus, the image quality of digital image data Vdg2 that is obtained through decoding of the encoded data Vcd by the decoder 84 is degraded.

Accordingly, the encoding by the encoder 82 inhibits analog copying.

Next, the configuration of the decoder 84 shown in FIG. 2 will be described in detail.

FIG. 27 is a block diagram showing the configuration of the decoder 84, which is a counterpart of the encoder 82 shown in FIG. 6. The decoder 84 receives input of encoded data Vcd from the encoder 82 or the recorder 83, decodes the encoded data Vcd, and supplies resulting digital image data Vdg2 to the D/A converter 85 at a subsequent stage.

The decoder 84 includes a data decombiner 251, a linear predictor 252, a residual decoder 253, a residual compensator 254, and a data combiner 255.

The data decombiner 251 receives input of the encoded data Vcd from the encoder 82 (or the recorder 83), and decombines the encoded data Vcd into extremum-pixel-value data, a binary image, the number of bits for quantization, a dynamic range DR and a minimum value of a residual, and quantized bit-code data. Then, the data decombiner 251 supplies extremum information used for linear interpolation (the extremum-pixel-value data and the binary image) to the linear predictor 252, and supplies the number of bits for quantization, the dynamic range DR and the minimum value of the residual, and the quantized bit-code data to the residual decoder 253. The linear predictor 252 linearly predict pixels between horizontal and vertical pairs of extrema using the extremum-pixel-value data and the binary image supplied from the data decombiner 251, and supplies the resulting linearly predicted image to the residual compensator 254. The configuration of the linear predictor 252 is substantially the same as that of the linear predictor 121 shown in FIG. 121, so that repetition of detailed description thereof will be refrained.

The residual decoder 253 reads the number of bits for quantization, the dynamic range DR and the minimum value of the residual, and the quantized bit-code data supplied from the data decombiner 251, decodes the residual block using the number of bits for quantization, the dynamic range DR and the minimum value of the residual, and the quantized bit-code data, and supplies the resulting decoded residual block to the residual compensator 254.

The residual compensator 254 reads the residual block supplied from the residual decoder 253 and reads the predicted image from the linear predictor 252 on a block-by-block basis, adds residual blocks to the predicted images of individual blocks (i.e., to individual predicted blocks) to obtain an output block, and supplies the output blocks to the data combiner 255.

The data combiner 255 writes image data of the output block supplied from the residual compensator 254 to an output image area. When image data for all the output blocks has been written, the data combiner 255 supplies the image data written to the output image area to the D/A converter 85 at a subsequent stage as digital image data Vdg2.

As described above, the extremum information (the pixel-value data and the binary image) used for linear prediction by the linear predictor 252 in the decoder 84 shown in FIG. 27 is extracted from image data with white noise added thereto by the encoder 82. Furthermore, the quantized bit-code data decoded by the residual decoder 253 is encoded under a restriction of the amount of data based on the number of extrema detected from the image data with white noise added thereto by the encoder 82.

Thus, the predicted image obtained through linear prediction by the linear predictor 252 and the residual blocks obtained through decoding of the residual by the residual decoder 253 are not necessarily accurate. Accordingly, the image quality of the digital image data Vdg2 composed of output blocks generated by summing predicted blocks and residual blocks is degraded. This inhibits analog copying.

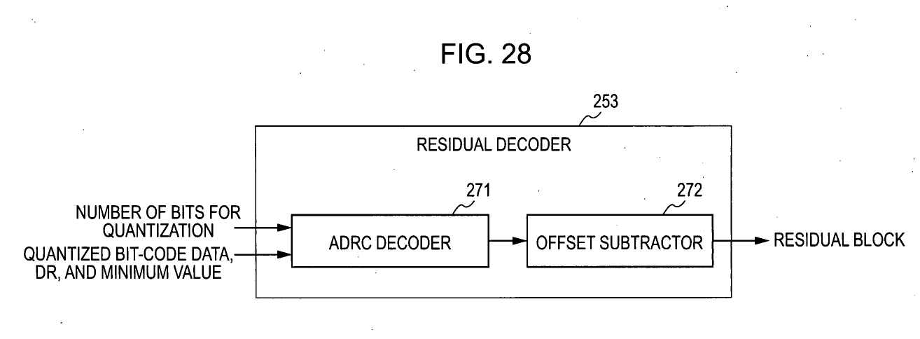

FIG. 28 shows an example configuration of the residual decoder 253 shown in FIG. 27.

In the example shown in FIG. 28, the residual decoder 253 includes an ADRC decoder 271 and an offset subtractor 272.

The ADRC decoder 271 reads the number of bits for quantization, the dynamic range and the minimum value of the residual, and the quantized bit-code data supplied from the data decombiner 251, and performs ADRC decoding using the number of bits for quantization, the dynamic range and the minimum value of the residual, and the quantized bit-code data, and supplies the resulting ADRC-decoded values to the offset subtractor 272.

The offset subtractor 272 subtracts the offset of 128, which has been added by the offset adder 202 shown in FIG. 14, from the values ADRC-decoded by the ADRC decoder 271, and supplies the resulting residual block to the residual compensator 254.

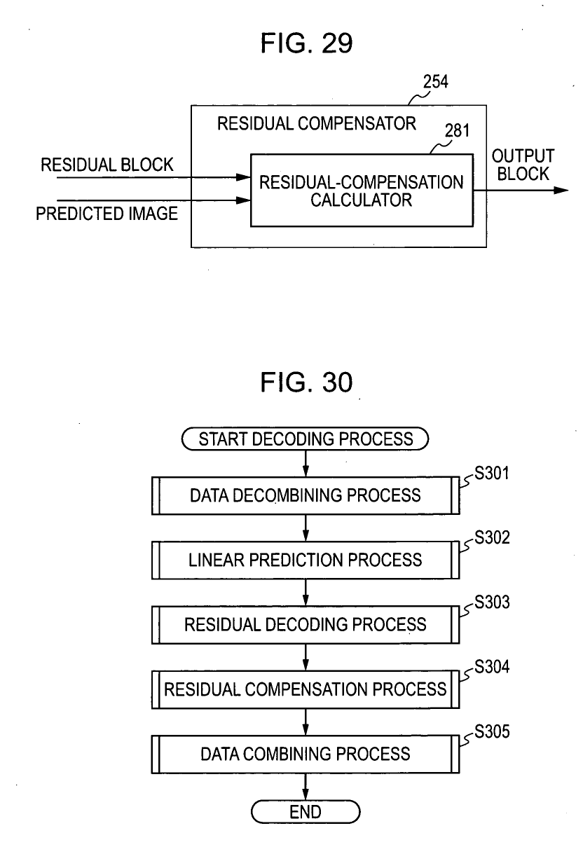

FIG. 29 shows an example configuration of the residual compensator 254 shown in FIG. 27.

In the example shown in FIG. 29, the residual compensator 254 includes a residual-compensation calculator 281.

The residual-compensation calculator 281 reads the predicted image supplied from the linear predictor 252 on a block-by-block basis, and reads the residual block supplied from the residual decoder 253. The residual-compensation calculator 281 adds the residual blocks supplied from the residual decoder 253 to the predicted images of individual blocks (i.e., individual predicted blocks) to obtain output blocks, and supplies the output blocks to the data combiner 255.

Next, the decoding process executed by the decoder 84 shown in FIG. 17 will be described with reference to a flowchart shown in FIG. 30. The decoding process corresponds to step S6 executed by the encoding apparatus 63, described with reference to FIG. 5.

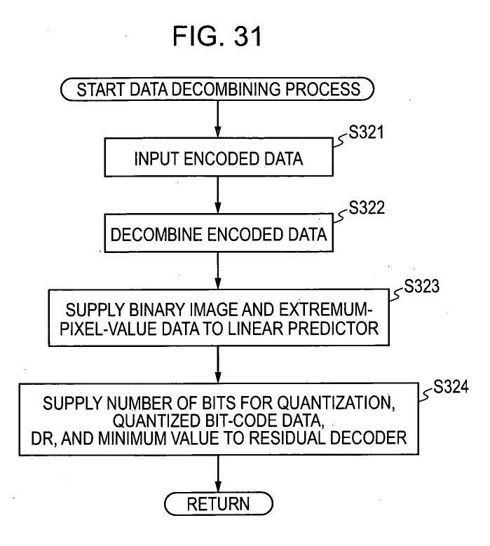

In the decoder 84, the data decombiner 251 receives encoded data Vcd from the encoder 82 (or the recorder 83). Upon receiving the encoded data Vcd, in step S301, the data decombiner 251 executes a data decombining process. The data decombining process will be described later in detail with reference to FIG. 31.

Through the data decombining process in step S301, the encoded data Vcd supplied from the encoder 82 is decombined into a binary image, extremum-pixel-value data, the number of bits for quantization, quantized bit-code data, a dynamic range DR, and a minimum value. The binary image and the extremum-pixel-value data are supplied to the linear predictor 252, and the number of bits for quantization, the quantized bit-code data, the dynamic range DR, and the minimum value are supplied to the residual decoder 253. The process then proceeds to step S302.

Upon receiving the binary image and the extremum-pixel-value data from the data decombiner 251, in step S302, the linear predictor 252 executes a linear prediction process. The linear prediction process is substantially the same as the linear prediction process executed by the linear predictor 121 of the encoder 82 in step S23 shown in FIG. 17 (i.e., the linear prediction process described earlier with reference to FIG. 20), so that repeated description thereof will be refrained. In the linear prediction process in step S302, extremum-pixel-value data is used instead of an input image.

Through the linear prediction process in step S302, pixels between horizontal and vertical pairs of extrema are linearly predicted on the basis of the binary image and the extremum-pixel-value data supplied from the data decombiner 251, and a predicted image composed of the linearly predicted pixels is supplied to the residual compensator 254. The process then proceeds to step S303.

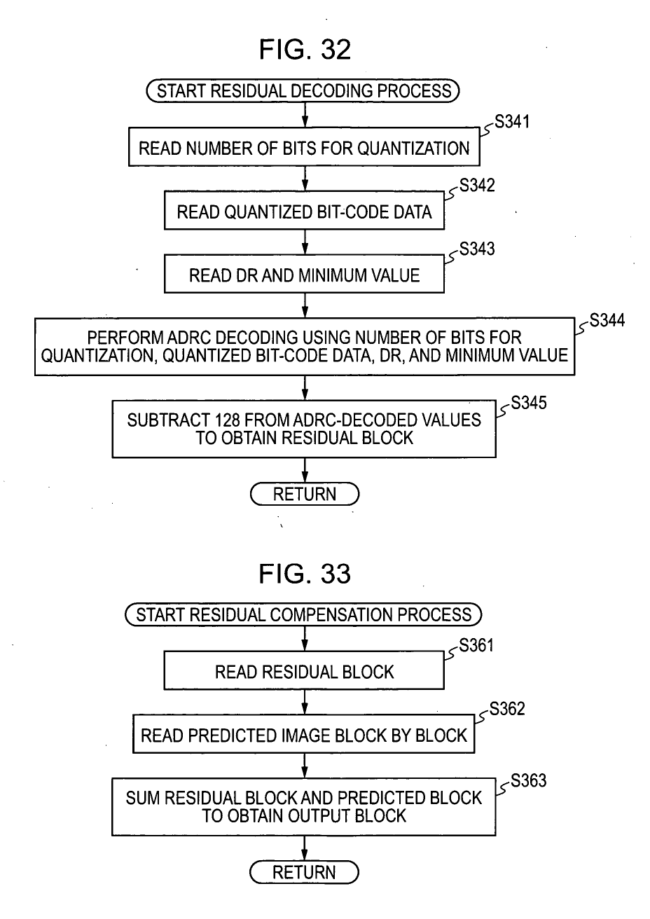

Upon receiving the number of bits for quantization, the quantized bit-code data, the dynamic range DR, and the minimum value from the data decombiner 251, in step S303, the residual decoder 253 executes a residual decoding process. The residual decoding process will be described later in detail with reference to FIG. 32.

Through the residual decoding process in step S303, ADRC decoding is performed using the quantized bit-code data, the dynamic range DR, and the minimum value, residual blocks are calculated from the values obtained by the ADRC decoding, and the residual blocks are supplied to the residual compensator 254. The process then proceeds to step S304.

Upon receiving the residual blocks from the residual decoder 253, in step S304, the residual compensator 254 executes a residual compensation process. The residual compensation process will be described later in detail with reference to FIG. 33.

Through the residual compensation process in step S304, the residual blocks supplied from the residual decoder 253 are added to the predicted images of the individual blocks supplied from the linear predictor 252, and the resulting output blocks are supplied to the data combiner 255. The process then proceeds to step S305.

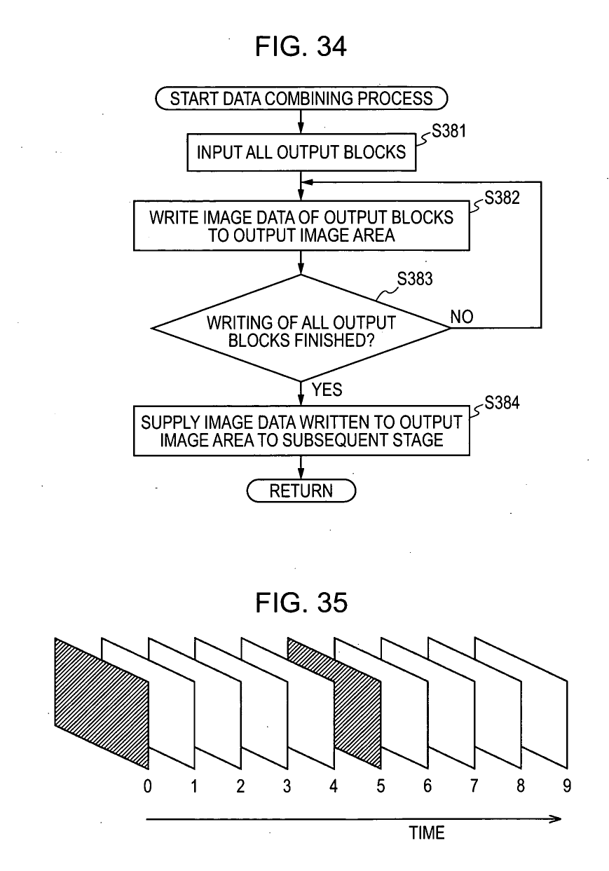

Upon receiving the output blocks from the residual compensator 254, in step S305, the data combiner 255 executes a data combining process. The data combining process will be described later in detail with reference to FIG. 34.

Through the data combining process in step S305, the image data of the output blocks supplied from the residual compensator 254 is written to the output image area. When the image data of all the output blocks has been written, the image data written to the output image data is supplied to the D/A converter 85 at a subsequent stage as digital image data Vdg2. The decoding process is then exited, and the process returns to step S6 shown in FIG. 5 and proceeds to step S7.

Next, the data decombining process in step S301 shown in FIG. 30, executed by the data decombiner 251 shown in FIG. 27, will be described with reference to a flowchart shown in FIG. 31.

In step S321, the data decombiner 251 receives input of encoded data Vcd supplied from the encoder 82. Then, in step S322, the data decombiner 251 decombines the input encoded data Vcd.

More specifically, in step S322, the data decombiner 251 decombines the encoded data Vcd into a binary image, extremum-pixel-value data, the number of bits for quantization, quantized bit-code data, a dynamic range DR, and a minimum value. The process then proceeds to step S323.

In step S323, the data decombiner 251 supplies the binary image and the extremum-pixel-value data to the linear predictor 252. Then, in step S324, the data decombiner 251 supplies the number of bits for quantization, the quantized bit-code data, the dynamic range DR, and the minimum value to the residual decoder 253. The data decombining process is then exited, and the process returns to step S301 shown in FIG. 30 and proceeds to step S302.

Next, the residual decoding process in step S303 shown in FIG. 30, executed by the residual decoder 253 shown in FIG. 27, will be described with reference to a flowchart shown in FIG. 32.

In the residual decoder 253, in step S341, the ADRC decoder 271 reads the number of bits for quantization supplied from the data decombiner 251. Then, in step S342, the ADRC decoder 271 reads the. quantized bit-code data supplied from the data decombiner 251. Then, in step S343, the ADRC decoder 271 reads the dynamic range DR and the minimum value supplied from the data decombiner 251. The process then proceeds to step S344.

In step S344, the ADRC decoder 271 performs ADRC decoding using the number of bits for quantization, the dynamic range and the minimum value of the residual, and the quantized bit-code data, and supplies values obtained by the ADRC decoding to the offset subtractor 272. The process then proceeds to step S345.

In step S345, the offset subtractor 272 subtracts the offset of 128, which has been added by the offset adder 202 shown in FIG. 14, from the ADRC-decoded values supplied from the ADRC decoder 271 to obtain residual blocks, and supplies the residual blocks to the residual compensator 254. The residual decoding process is then exited, and the process returns to step S303 shown in FIG. 30 and proceeds to step S304.

The residual compensation process in step S304 shown in FIG. 30, executed by the residual compensator 254 shown in FIG. 27, will be described with reference to a flowchart shown in FIG. 33.

In the residual compensator 254, in step S361, the residual-compensation calculator 281 reads the residual blocks supplied from the residual decoder 253. Then, in step S362, the residual-compensation calculator 281 reads a predicted image supplied from the linear predictor 252 on a block-by-block basis. The process then proceeds to step S363.

In step S363, the residual-compensation calculator 281 adds predicted images of individual blocks (i.e., individual predicted blocks) to the residual blocks supplied from the residual decoder 253 to obtain output blocks, and supplies the output blocks to the data combiner 255. The residual compensation process is then exited, and the process returns to step S304 shown in FIG. 30 and proceeds to step S305.

Next, the data combining process in step S305 shown in FIG. 30, executed by the data combiner 255 shown in FIG. 27, will be described with reference to a flowchart shown in FIG. 34.

In step S381, the data combiner 255 receives input of all the output blocks supplied from the residual compensator 254 (i.e., all the blocks corresponding to the input-image blocks generated by the block generator 122-1 of the encoder 82). The process then proceeds to step S382.

In step S382, the data combiner 255 writes the image data of the output blocks to the output image area. Then, in step S383, the data combiner 255 checks whether writing of all the output blocks has been finished. When it is determined that writing of all the output blocks has not been finished, the process returns to step S382, and subsequent steps are repeated.

When it is determined in step S383 that writing of all the output blocks has been finished, in step S384, the data combiner 255 supplies the image data written to the output image area to the D/A converter 85 at a subsequent stage as digital image data Vdg2. The process then proceeds to step S305 and the decoding process shown in FIG. 30 is exited. The process then returns to step S6 shown in FIG. 5 and proceeds to step S7.

As described above, in the decoder 84, linear prediction is performed using only extrema detected from image data with white noise added thereto by the encoder 82. Thus, the image quality of image data generated using predicted blocks obtained by the linear prediction is degraded.

Furthermore, in the decoder 84, residual decoding is performed using quantized bit-code data obtained by the encoder 82 using extrema through quantization of a residual after linear prediction and using the number of bits for quantization that is set on the basis of the number of extrema. Thus, the image quality of image data generated using residual blocks obtained by the residual decoding is degraded.

This serves to inhibit analog copying.

Although the above description has been given in the context of an example where linear prediction is performed using extrema, the scheme of image encoding is not limited to linear prediction, and other encoding schemes employing extrema may be used.

Next, an example where motion is estimated by block matching using extrema will be described.

FIG. 35 shows a frame structure of image data that is processed by the image processing system 51 that estimates motion by block matching.

In the example shown in FIG. 35, frames of image data are shown along a temporal axis. The image data is composed of reference frames at the 0th and 5th frames (shown as hatched) and non-reference frames. The interval of reference frames is 5 frames, which can be set by a user.

In the image processing system 51 that estimates motion by block matching as described below, of these frames, intra-frame encoding is performed for the reference frame by the ADRC encoding scheme according to Japanese Unexamined Patent Application Publication No. 61-144989, described earlier with reference to FIG. 16, so that the dynamic range decreases through encoding and decoding. On the other hand, for non-reference frames, inter-frame encoding described below is performed. That is, the following description is directed to inter-frame encoding.

Next, the configuration of the encoder 82 shown in FIG. 2 in the case where motion estimation is performed by block matching will be described in detail.

FIG. 36 is a block diagram showing another configuration of the encoder 82. In the example shown in FIG. 36, parts corresponding to those of the encoder 82 shown in FIG. 6 are designated by corresponding signs, and repeated descriptions thereof will be omitted as appropriate.

In the example shown in FIG. 36, the encoder 82 includes a block generator 311, a frame memory 312, an extremum generator 111, a calculator 112 for calculating the number of bits for quantization, and an extremum encoding processor 113. Digital image data Vdg1 supplied from the A/D converter 81 is input to the block generator 311 and the frame memory 312.

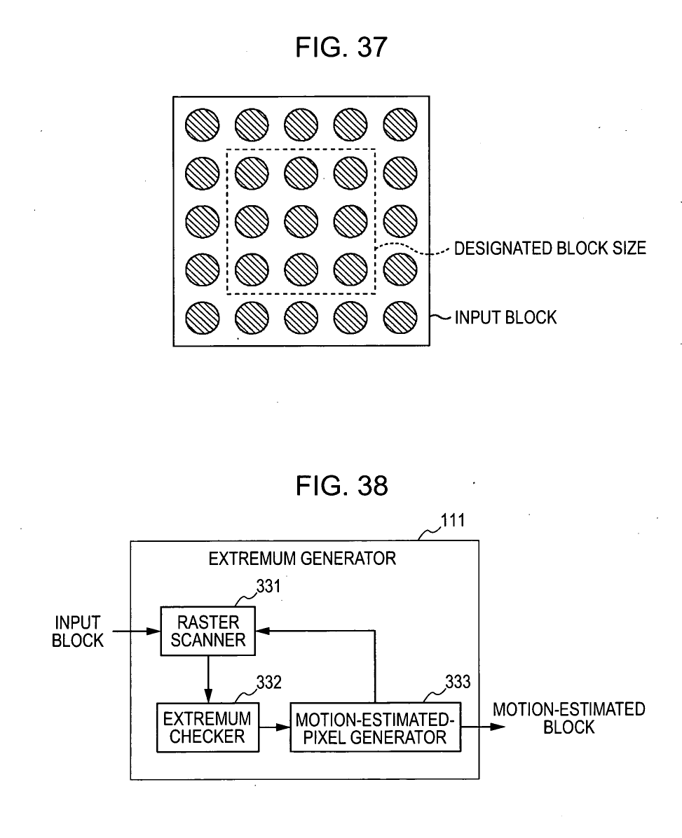

The block generator 311 reads an input image and divides the input image into blocks of a designated block size (e.g., 4×4 pixels or 8×8 pixels). Then, the block generator 311 adds one pixel (line margin) at each end of lines with respect to both horizontal and vertical directions around the entire periphery of the pixels of the designated block size, as shown in FIG. 37. Then, the block generator 311 supplies the image data with the line margin added thereto to the extremum generator 111 and the residual generator 322 of the extremum encoding processor 113 as input blocks on a block-by-block basis.

The frame memory 312 stores the image data of an immediately preceding frame (hereinafter also referred to as a previous frame), and supplies the image data to the extremum motion estimator 321 and the residual generator 322 of the extremum encoding processor 113.

The extremum generator 111 detects extremum pixels from the input blocks supplied from the block generator 311. An extremum pixel herein refers to a pixel having an extrema, i.e., a maximum value or a minimum value compared with the pixel values of neighboring pixels. The extremum generator 111 generates pixels of motion-estimated blocks on the basis of the extrema, and supplies the resulting motion-estimated blocks to the calculator 112 for calculating the number of bits for quantization and the extremum motion estimator 321 of the extremum encoding processor 113.

Using the motion-estimated blocks supplied from the extremum generator 111, the calculator 112 for calculating the number of bits for quantization determines the number of bits for quantization that is to be used in encoding by the extremum encoding processor 113, and supplies the number of bits for quantization to the residual encoder 323 and the data combiner 324 of the extremum encoding processor 113. That is, the calculator 112 for calculating the number of bits for quantization can obtain extremum-pixel-value data and extrema locations from the motion-estimated blocks.

The extremum encoding processor 113 includes the extremum motion estimator 321, the residual generator 322, the residual encoder 323, and the data combiner 324. The extremum encoding processor 113 encodes digital image data Vdg1 on the basis of the number of bits for quantization supplied from the calculator 112 for calculating the number of bits for quantization.

The extremum motion estimator 321 reads a previous frame supplied from the frame memory 312 and motion-estimated blocks supplied from the extremum generator 111. Then, the extremum motion estimator 321 performs motion searching with reference to the previous block by block matching to calculate motion vectors, and supplies the motion vectors to the residual generator 322 and the data combiner 324.

The residual generator 322 calculates residuals after the motion estimation. More specifically, the residual generator 322 reads the input blocks supplied from the block generator 311, the motion vectors supplied from the extremum motion estimator 321, and the previous frame supplied from the frame memory 312. Then, the residual generator 322 generates pixel values of predicted blocks to obtain predicted blocks using the motion vectors and the previous frame. Then, the residual generator 322 supplies the predicted blocks and the residuals of the input blocks to the residual encoder 323 as residual blocks.

The residual encoder 323 reads the residual blocks supplied from the residual generator 322, and ADRC-encodes the residual blocks on the basis of the number of bits for quantization supplied from the calculator 112 for calculating the number of bits for quantization. Then, the residual encoder 323 supplies quantized bit-code data and dynamic ranges DR and minimum values in the individual blocks, obtained by the ADRC encoding, to the data combiner 324. The configuration of the residual encoder 323 is substantially the same as that of the residual encoder 124 shown in FIG. 6, so that the configuration of the residual encoder 124 shown in FIG. 15 applies to the configuration of the residual encoder 323.

The data combiner 324 combines the motion vectors supplied from the extremum motion estimator 321, the number of bits for quantization supplied from the calculator 112 for calculating the number of bits for quantization, the quantized bit-code data and the block dynamic ranges DR and minimum values supplied from the residual encoder 323, and supplies resulting encoded data Vcd to the recorder 83 or the decoder 84 at a subsequent stage.

Although the extremum motion estimator 321 shown in FIG. 36 performs motion estimation by block matching, without limitation to block matching, other methods of motion estimation, such as a gradient method.

As described above, the extremum motion estimator 321 performs motion estimation by block matching using extrema detected by the extremum generator 111 from digital image data Vdg1 with white noise added thereto. Thus, the likelihood of estimated motion vectors is not so high, so that accurate motion estimation is inhibited.

Furthermore, the calculator 112 for calculating the number of bits for quantization determines the number of bits for quantization that is to be used in encoding by the residual encoder 323, on the basis of the number of extrema detected by the extremum generator 111 from the digital image data Vdg1, and the residual encoder 323 performs ADRC encoding on the basis of the number of bits for quantization. Since white noise is added to the digital image data Vdg1 input from the A/D converter 81, the number of extrema increases due to the effect of the white noise, so that the amount of data that can be allocated for encoding of residuals is reduced.

That is, accurate motion estimation is inhibited, and the amount of information of quantized bit-code data that can be obtained by ADRC encoding of residuals after motion estimation is reduced. Thus, the image quality of digital image data Vdg2 obtained through decoding of encoded data Vcd by the decoder 84 is degraded.

This inhibits analog copying.

FIG. 38 shows an example configuration of the extremum generator 111 shown in FIG. 36.

In the example shown in FIG. 38, the extremum generator 111 includes a raster scanner 331, an extremum checker 332, and a motion-estimated-pixel generator 333.

The raster scanner 331 reads an input block, and moves through pixels of the input block in order of raster scanning so that the extremum checker 332 selects a next pixel as a subject pixel in order of raster scanning.

The extremum checker 332 selects a subject pixel in the input block, and checks the magnitudes of the pixel values of neighboring pixels of the subject pixel. More specifically, similarly to the extremum checker 132 shown in FIG. 7, the extremum checker 332 compares the pixel value of the subject pixel with the pixel values of the eight pixels neighboring the subject pixel vertically, horizontally, and diagonally, and defines the subject pixel as having an extremum when the subject pixel has a maximum pixel value or a minimum pixel value compared with the neighboring pixels.

The motion-estimated-pixel generator 333, under the control of the extremum checker 332, sets the pixel values of a motion-estimated block to generate a motion-estimated block, and supplies the motion-estimated block to the calculator 112 for calculating the number of bits for quantization and the extremum motion estimator 321.

That is, when the extremum checker 332 determines that the subject pixel has a maximum value or a minimum value compared with the pixel values of the neighboring pixels (i.e., an extremum), the motion-estimated-pixel generator 333 sets the pixel value of the subject pixel in the input block as the pixel value of the subject pixel in the motion-estimated block. On the other hand, when the extremum checker 332 determines that the subject pixel does not have a maximum value or a minimum value compared with the pixel values of the neighboring pixels (i.e., an extremum), the motion-estimated-pixel generator 333 sets 0 as the pixel value of the subject pixel in the motion-estimated block.

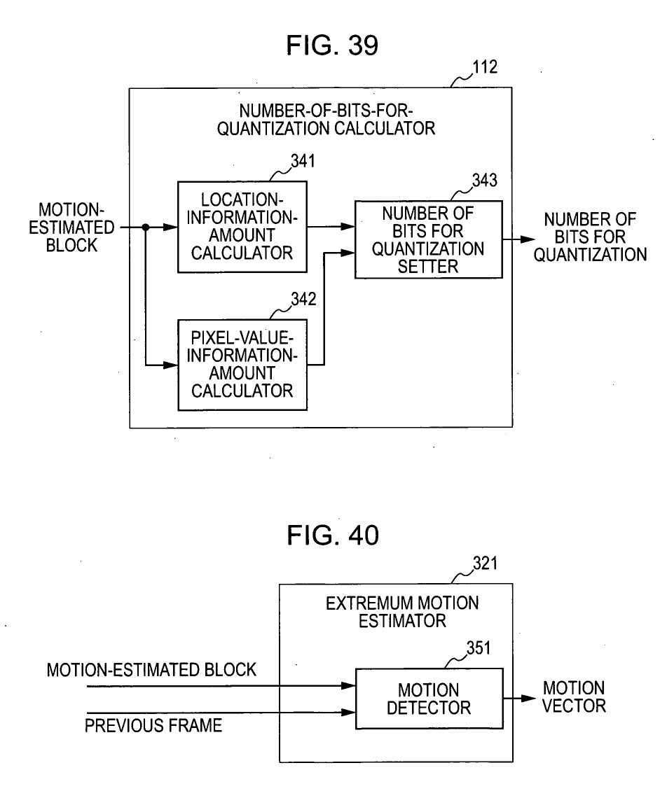

FIG. 39 shows an example configuration of the calculator 112 for calculating the number of bits for quantization shown in FIG. 36.

In the example shown in FIG. 39, the calculator 112 for calculating the number of bits for quantization includes a location-information-amount calculator 341, a pixel-value-information-amount calculator 342, and a setter 343 for setting the number of bits for quantization. A motion-estimated block supplied from the extremum generator 111 is input to the location-information-amount calculator 341 and the pixel-value-information-amount calculator 342.

The location-information-amount calculator 341 obtains the number of extrema in the motion-estimated block, multiplies the number of extrema by a size in terms of the number of bits corresponding to the block size to calculate an amount a of extremum-location information, and supplies the amount a of extremum-location information to the setter 343 for setting the number of bits for quantization.

The pixel-value-information-amount calculator 342 counts the number b of extrema in the motion-estimated block to calculate an amount c of extreinum-pixel-value information (=8 bits×b), and supplies the amount c of extremum-pixel-value information to the setter 343 for setting the number of bits for quantization. 8 bits is an amount of information used to represent a pixel value.

The setter 343 for setting the number of bits for quantization subtracts the amount of extremum information (i.e., the amount a of extremum-location information+the amount c of extremum-pixel-value information) form a desired amount of information to calculate an amount d of information that can be allocated for pixels other than extremum pixels (i.e., an amount of information that can be allocated for encoding of a residual). That is, in an environment under a bandwidth restriction, the amount d of information that can be allocated for pixels other than extremum pixels is “a desired amount of information−c−a”. The desired amount of information refers to the amount of information of desired encoded data Vcd that is to be passed to a subsequent stage.

For example, when the initial number q of bits for quantization of 10 is set, an amount g of information within a block can be expressed by equation (2) below:
Block information amount g=(8+8)+q×(designated block size−b)+motion-vector size+the number of bits for quantization size (2)

A dynamic range DR and a minimum value are each represented using 8 bits allocated thereto. In equation (2), the first “8” represents 8 bits for the dynamic range DR, and the second “8” represents 8 bits for the minimum value.

That is, the block information amount g is the sum of the information amount of the dynamic range DR (8 bits), the information amount of the minimum value (8 bits), the size of the motion vector (a bit sequence representing a search range), and the size of the number of bits for quantization (a bit sequence representing the number of bits for quantization).

The setter 343 for setting the number of bits for quantization calculates the block information amount g according to equation (2), and sets the number q of bits for quantization with which the block information amount g becomes a maximum information amount within the information amount d as the number of bits for quantization that is to be used.

FIG. 40 shows an example configuration of the extremum motion estimator 321 shown in FIG. 36.

In the example shown in FIG. 40, the extremum motion estimator 321 includes a motion detector 351.

The motion detector 351 reads a previous frame supplied from the frame memory 312 and a motion-estimated block supplied from the extremum generator 111. The motion detector 351 detects a motion by block matching with reference to the previous frame using only non-zero pixel values (i.e., only extrema) of the motion-estimated block according to the rule of least sum of squares of differences in pixel values, thereby calculating a motion vector. Then, the motion detector 351 supplies the motion vector to the residual generator 322 and the data combiner 324.

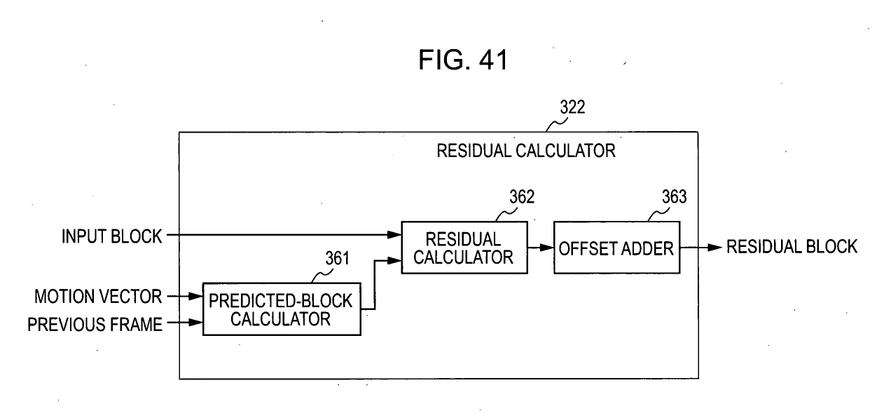

FIG. 41 shows an example configuration of the residual generator 322 shown in FIG. 36.

In the example shown in FIG. 41, the residual generator 322 includes a predicted-block calculator 361, a residual calculator 362, and an offset adder 363.

The predicted-block calculator 361 reads a motion vector supplied from the extremum motion estimator 321 and a previous frame supplied from the frame memory 312. Then, the predicted-block calculator 361 generates pixel values of a predicted block to generate a predicted block using the motion vector and the previous frame, and supplies the predicted block to the residual calculator 362.

The residual calculator 362 reads an input block supplied from the block generator 311 and the predicted block supplied from the predicted-block calculator 361, calculates a residual between the input block and the predicted block, and supplies the residual to the offset adder 363.

The offset adder 363 is configured substantially the same as the offset adder 202 shown in FIG. 14. The offset adder 363 adds an offset for ADRC encoding by the residual encoder 323. More specifically, the offset adder 363 adds 128 to the residual supplied from the residual calculator 362, and supplies the resulting residual to the residual encoder 323 as a residual block.

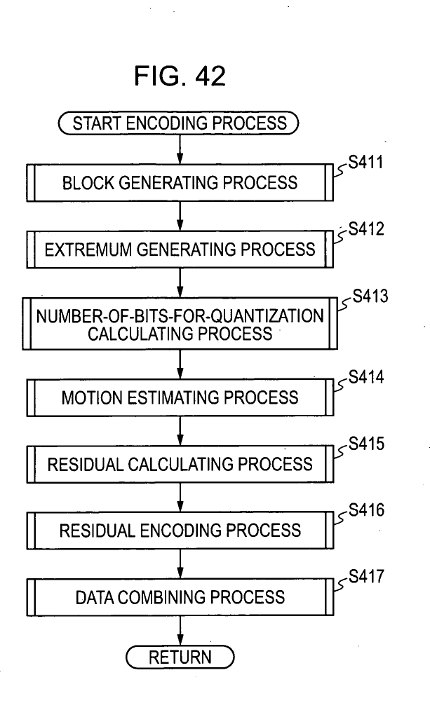

Next, an encoding process executed by the encoder 82 shown in FIG. 36 will be described with reference to a flowchart shown in FIG. 42. The encoding process is another example of the encoding process in step S5 executed by the encoding apparatus 63, described earlier with reference to FIG. 5.

In the encoder 82, the block generator 311 and the frame memory 312 receive input of digital image data Vdg1 from the A/D converter 81. The image data of a previous frame input to and stored in the frame memory 312 is supplied to the extremum motion estimator 321 and the residual generator 322 of the extremum encoding processor 113.

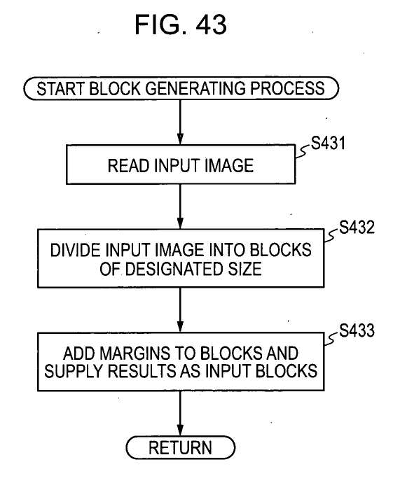

Upon receiving the digital image data Vdg1 from the A/D converter 81, in step S411, the block generator 311 executes a block generating process. The block generating process will be described later in detail with reference to FIG. 43.

Through the block generating process in step S411, the input image that has been read is divided into blocks of a designated block size, and image data with line margins added thereto are supplied to the extremum generator 111 and the residual generator 322 as input blocks on a block-by-block basis. The process then proceeds to step S412.

Upon receiving the input block from the block generator 311, in step S412, the extremum generator 111 executes an extremum generating process. The extremum generating process will be described later in detail with reference to FIG. 43.

Through the extremum generating process in step S412, extrema are detected from the input block, and pixels of a motion-estimated block are generated on the basis of the extrema. Then, the motion-estimated block is supplied to the calculator 112 for calculating the number of bits for quantization. The process then proceeds to step S413.

Upon receiving the motion-estimated block from the extremum generator 111, in step S413, the calculator 112 for calculating the number of bits for quantization executes a process for calculating the number of bits for quantization that is to be used in encoding by the extremum encoding processor 113. The process for calculating the number of bits for quantization will be described later in detail.

Through the process for calculating the number of bits for quantization in step S413, the number of bits for quantization is calculated using the motion-estimated block supplied from the extremum generator 111, and the number of bits for quantization is supplied to the residual encoder 323 and the data combiner 324. The process then proceeds to step S414.

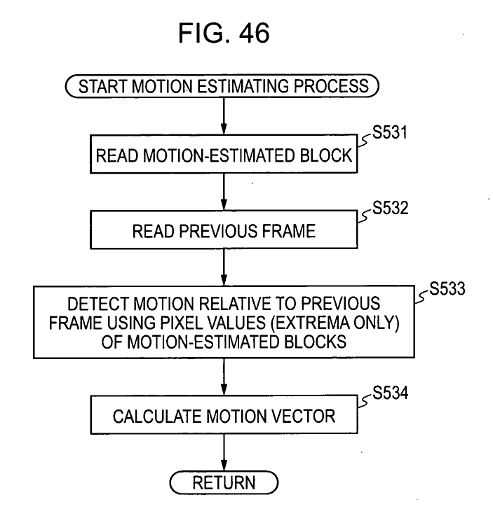

Upon receiving the motion-estimated block from the extremum generator 111, in step S414, the extremum motion estimator 321 executes a motion estimating process by block matching using the motion-estimated block supplied from the extremum generator 111. The motion estimating process will be described later in detail with reference to FIG. 46.

Through the motion estimating process in step S414, motion searching is performed using pixel values (extrema) of the motion-estimated block with reference to the previous frame supplied from the frame memory 312, whereby a motion vector is calculated. The motion vector is supplied to the residual generator 322 and the data combiner 324. The process then proceeds to step S415.

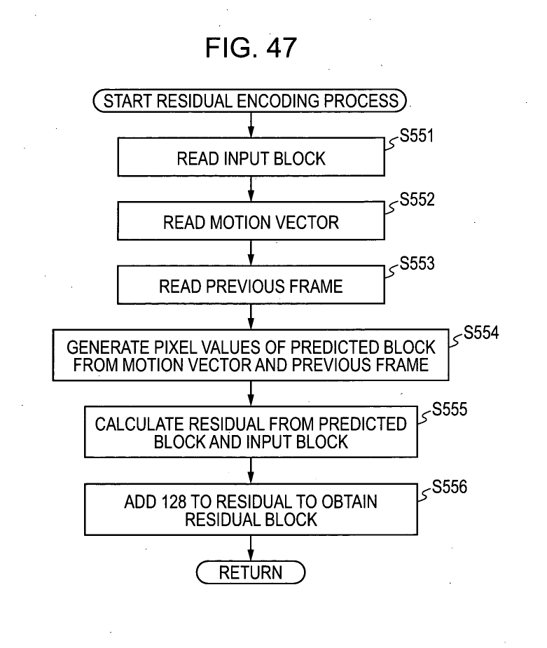

Upon receiving the motion vector from the extremum motion estimator 321, in step S415, the residual generator 322 executes a residual calculating process. The residual calculating process will be described later in detail with reference to FIG. 47.

Through the residual calculating process in step S415, pixel values of a predicted block are generated to obtain a predicted block using the motion vector supplied from the extremum motion estimator 321 and the previous frame supplied from the extremum motion estimator 321. Then, a residual between the predicted block and the input block supplied from the block generator 311 is supplied to the residual encoder 323 as a residual block. The process then proceeds to step S416.

Upon receiving the residual block from the residual generator 322, in step S416, the residual encoder 323 executes a residual encoding process. The residual encoding process is substantially the same as the residual encoding process executed in step S27 shown in FIG. 17 by the residual encoder 124 shown in FIG. 6 (i.e., the residual encoding process described earlier with reference to FIG. 25), so that repeated description thereof will be refrained.

Through the residual encoding process in step S416, the residual block supplied from the residual generator 322 is ADRC-encoded on the basis of the number of bits for quantization supplied from the calculator 112 for calculating the number of bits for quantization, and a minimum value and a dynamic range DR of the residual block and quantized bit-code data obtained by the ADRC encoding are supplied to the data combiner 324. The process then proceeds to step S417.

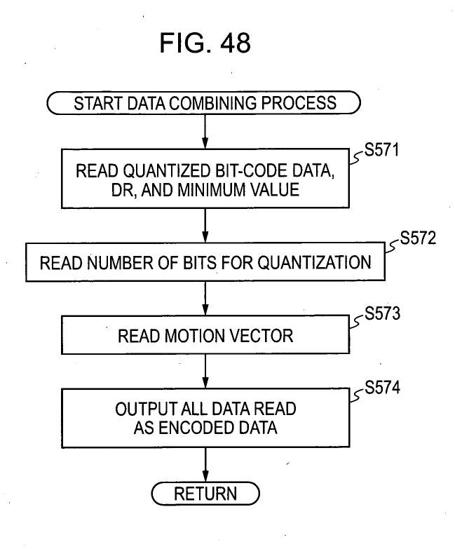

Upon receiving the quantized bit-code data from the residual encoder 323, in step S417, the data combiner 324 executes a data combining process. The data combining process will be described later in detail with reference to FIG. 48.

Through the data combining process in step S417, the motion vector supplied from the extremum motion estimator 321, the number of bits for quantization supplied from the calculator 112 for calculating the number of bits for quantization, and the quantized bit-code data, the minimum value, and the dynamic range DR supplied from the residual encoder 323 are combined to form encoded data Vcd, which is output to the recorder 83 or the decoder 84 at a subsequent stage.

The encoding process by the encoder 82 shown in FIG. 36 is then exited. The process then returns to step S5 shown in FIG. 5 and proceeds to step S6, in which a decoding process is executed.

Next, the block generating process in step S411 shown in FIG. 42, executed by the block generator 311 shown in FIG. 36, will be described with reference to a flowchart shown in FIG. 43.

In step S431, the block generator 311 reads digital image data Vdg1 supplied from the A/D converter 81 as an input image. Then, in step S432, the block generator 311 divides the input image into blocks of a designated block size (e.g., 4×4 pixels or 8×8 pixels). The process then proceeds to step S433.

In step S433, the block generator 311 adds one pixel (line margin) at each end of lines with respect to both horizontal and vertical directions around the entire periphery of the pixels of the designated block size, and supplies the image data with the line margin added thereto to the extremum generator 111, the extremum motion estimator 321, and the residual generator 322 as input blocks on a block-by-block basis. The block generating process is then exited, and the process returns to step S411 shown in FIG. 42 and proceeds to step S412.

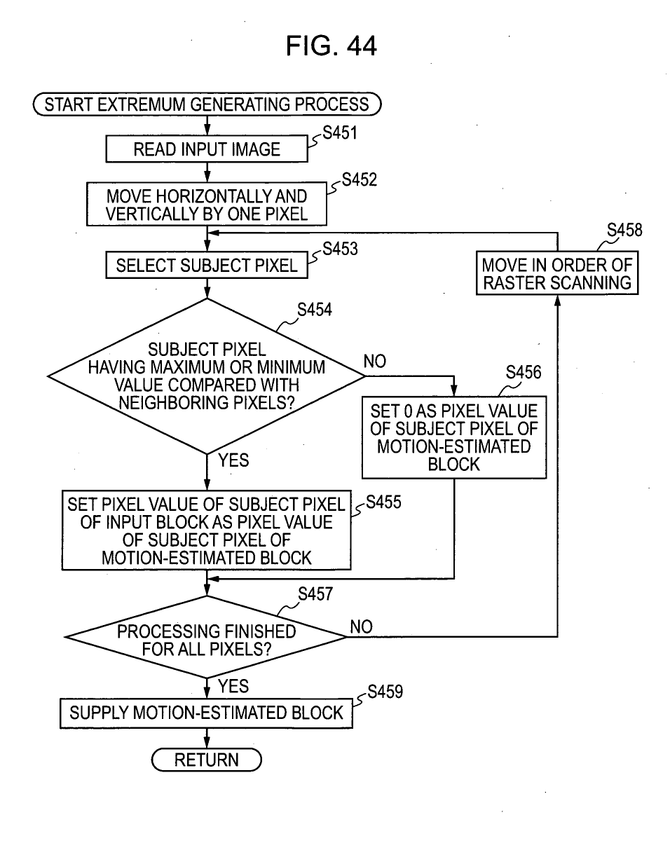

Next, the extremum generating process in step S412 shown in FIG. 42, executed by the. extremum generator 111 shown in FIG. 36, will be described with reference to a flowchart shown in FIG. 44.

In the extremum generator 111, in step S451, the raster scanner 331 reads an input block supplied from the block generator 311. Then, in step S452, the raster scanner 331 moves horizontally and vertically by one pixel in the input block. The process then proceeds to step S453.

In step S453, the extremum checker 332 selects a new subject pixel in accordance with the movement of.the raster scanner 331. Then, in step S454, the extremum checker 332 checks whether the subject pixel has a maximum value or a minimum value compared with the pixel values of the eight neighboring pixels.

When it is determined in step S454 that the subject pixel has a maximum value or a minimum value compared with the pixel values of the eight neighboring pixels, the extremum checker 332 defines the subject pixel as having an extremum. Then, in step S455, the extremum checker 332 controls the motion-estimated-pixel generator 333 so that the pixel value of the subject pixel having an extremum in the input block is set as the pixel value of the subject pixel in a motion-estimated block. That is, the motion-estimated-pixel generator 333 sets the pixel value of the subject pixel in the motion-estimated block such that the pixel value is an extremum.

On the other hand, when it is determined in step S454 that the subject pixel does not have a maximum value or a minimum value compared with the pixel values of the eight neighboring pixels, the subject pixel does not have an extremum. Then, in step S456, the extremum checker 332 controls the motion-estimated-pixel generator 333 so that 0 is set as the pixel value of the subject pixel in the motion-estimated block corresponding to the subject pixel in the input block. The process then proceeds to step S457.

In step S457, the motion-estimated-pixel generator 333 determines whether processing for all the pixels of the block has been finished, on the basis of the pixel values of the motion-estimated block that have been set. All the pixels herein refer to pixels within the designated block size not including each outermost pixel of the input block with respect to the horizontal and vertical directions. That is, pixels at the ends of the image exceeding the designated block size are excluded from processing since it is not possible to compare the pixels with eight neighboring pixels.

When it is determined in step S457 that processing for all the pixels has not been finished, in step S458, the motion-estimated-pixel generator 333 causes the motion-estimated-pixel generator 333 to move to a next pixel in the input block in order of raster scanning. The process then returns to step S453, and subsequent steps are repeated. That is, in step S453, the extremum checker 332 selects a next pixel as a subject pixel in order of raster scanning.

When it is determined in step S457 that processing for all the pixels has been finished, in step S459, the motion-estimated-pixel generator 333 supplies the motion-estimated block generated to the calculator 112 for calculating the number of bits for quantization and the extremum motion estimator 321. The extremum generating process is then exited, and the process returns to step S412 shown in FIG. 42 and proceeds to step S413.

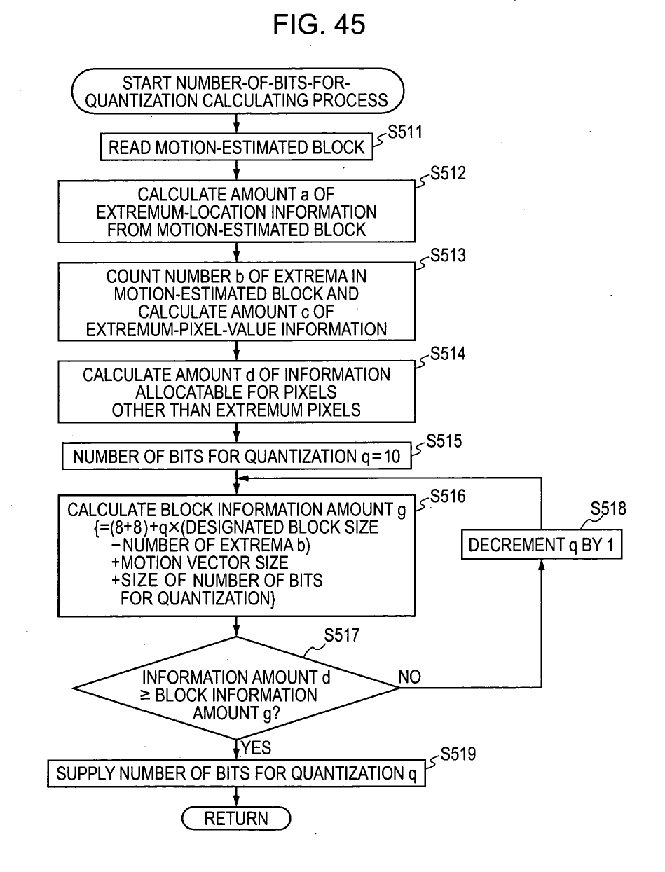

Next, the process for calculating the number of bits for quantization in step S413 shown in FIG. 42, executed by the calculator 112 for calculating the number of bits for quantization shown in FIG. 36, will be described with reference to a flowchart shown in FIG. 45.

In the calculator 112 for calculating the number of bits for quantization, in step S511, the location-information-amount calculator 341 and the pixel-value-information-amount calculator 342 reads a motion-estimated block supplied from the extremum generator 111. The process then proceeds to step S512.

Upon reading the motion-estimated block, in step S512, the location-information-amount calculator 341 calculates the number of extrema in the motion-estimated block, and multiplies the number of extrema in the motion-estimated block by a size in terms of the number of bits corresponding to the block size, thereby calculating an amount a of extremum-location information. Then, the location-information-amount calculator 341 supplies the amount a of extremum-location information to the setter 343 for setting the number of bits for quantization. The process then proceeds to step S513.

Upon reading the motion-estimated block, in step S513, the pixel-value-information-amount calculator 342 counts the number of extrema in the motion-estimated block, calculates an amount c of extremum-pixel-value information (=8 bits×b), and supplies the amount c of extremum-pixel-value information to the setter 343 for setting the number of bits for quantization. The process then proceeds to step S514.

Upon receiving the amount a of extremum-location information from the location-information-amount calculator 341 and the amount c of extremum-pixel-value information from the pixel-value-information-amount calculator 342, in step S514, the setter 343 for setting the number of bits for quantization calculates an amount d of information that can be allocated for pixels other than extremum pixels (=desired amount of information−c−a) on the basis of the amount of extremum information (the amount a of extremum-location information+the amount c of extremum-pixel-value information). Then, in step S515, the setter 343 for setting the number of bits for quantization sets 10 (initial value) as the number q of bits for quantization. The process then proceeds to step S516. The initial value of 10 is herein chosen since the value is not empirically possible as the number of bits for quantization and in consideration of processing load. However, the initial value is not limited to 10, and may be other values that are not empirically possible as the number of bits for quantization.

In step S516, the setter 343 for setting the number of bits for quantization calculates a block information amount g according to equation (2). Then, in step S517, the setter 343 for setting the number of bits for quantization checks whether the block information amount g is less than the information amount d. When it is determined that the block information amount is greater than or equal to the information amount d, in step S518, the setter 343 for setting the number of bits for quantization decrements the number q of bits for quantization by 1. The process then returns to step S516, and subsequent steps are repeated.

When it is determined in step S517 that the block information amount g is less than the information amount d, the setter 343 for setting the number of bits for quantization sets the current number q of bits for quantization as the number q of bits for quantization that is to be used in ADRC encoding by the residual encoder 323. Then, in step S519, the setter 343 for setting the number of bits for quantization supplies the number q of bits for quantization to the residual encoder 323 and the data combiner 324. The process for calculating the number of bits for quantization is then exited, and the process returns to step S413 shown in FIG. 42 and proceeds to step S414.

Next, the motion estimating process in step S414 shown in FIG. 42, executed by the extremum motion estimator 321 shown in FIG. 36, will be described with reference to a flowchart shown in FIG. 46.

In step S531, the motion detector 351 reads a motion-estimated block supplied from the extremum generator 111. Then, in step S532, the motion detector 351 reads a previous frame supplied from the frame memory 312. The process then proceeds to step S533.

In step S533, the motion detector 351 detects a motion with reference to the previous frame using only non-zero pixel values (i.e., only extrema) of the motion-estimated block according to the rule of least sum of squares of differences in pixel values, thereby calculating a motion vector. Then, the motion detector 351 supplies the motion vector to the residual generator 322 and the data combiner 324. The motion estimating process is then exited, and the process returns to step S414 shown in FIG. 42 and proceeds to step S415.

Next, the residual calculating process in step S415 shown in FIG. 42, executed by the residual generator 322 shown in FIG. 36, will be described with reference to a flowchart shown in FIG. 47.

In step S551, the residual calculator 362 reads an input block supplied from the block generator 311. The process then proceeds to step S552.

In step S552, the predicted-block calculator 361 reads a motion vector supplied from the extremum motion estimator 321. Then, in step S553, the predicted-block calculator 361 reads a previous frame supplied from the frame memory 312. The process then proceeds to step S554.

In step S554, the predicted-block calculator 361 generates pixel values of a predicted block to obtain a predicted block using the motion vector supplied from the extremum motion estimator 321 and the previous frame supplied from the frame memory 312, and supplies the predicted block to the residual calculator 362. The process then proceeds to step S555.

In step S555, the residual calculator 362 calculates a residual between the input block supplied from the block generator 311 and the predicted block supplied from the predicted-block calculator 361, and supplies the residual to the offset adder 363. The process then proceeds to step S556.

In step S556, the offset adder 363 adds an offset of 128 to the residual supplied from the residual calculator 362, and supplies the resulting residual to the residual encoder 323 as a residual block. The residual calculating process is then exited, and the process returns to step S416 shown in FIG. 42 and proceeds to step S417.

Next, the data combining process in step S417 shown in FIG. 42, executed by the data combiner 324 shown in FIG. 36, will be described with reference to a flowchart shown in FIG. 48.

In step S571, the data combiner 324 reads quantized bit-code data, a dynamic range DR, and a minimum value supplied from the residual encoder 323. Then, in step S572, the data combiner 324 reads the number of bits for quantization supplied from the calculator 112 for calculating the number of bits for quantization. The process then proceeds to step S573.

In step S573, the data combiner 324 reads a motion vector supplied from the extremum motion estimator 321. Then, in step S574, the data combiner 324 combines all the data that has been read (i.e., the quantized bit-code data, the dynamic range DR, the minimum value, the number of bits for quantization, and the motion vector), and supplies resulting encoded data Vcd to the recorder 83 or the decoder 84 at a subsequent stage.

The data combiner 324 then exits the data combining process. The process then returns to step S417 shown in FIG. 42, and the encoding process shown in FIG. 42 is exited. The process then returns to step S5 shown in FIG. 5 and proceeds to step S6.

As described above, in the encoder 82 shown in FIG. 36, extrema are detected from digital image data Vdg1, and motion estimation is performed on the basis of the extrema detected. Furthermore, a residual after the motion estimation is ADRC-encoded on the basis of the number of bits for quantization that is set in accordance with the number of extrema detected, and a motion vector estimated no the basis of the extrema, the number of bits for quantization that has been set, a dynamic range and a minimum value of the residual, and quantized bit-code data obtained by the ADRC-encoding of the residual are supplied to a subsequent stage as encoded data Vcd.

The digital image data Vdg1 input from the A/D converter 81 has white noise added thereto, so that the pixel values of pixels with white noise added thereto can have extrema. Thus, accurate motion estimation based on extrema is inhibited, so that the likelihood of the residual after the motion estimation is not so high.

Furthermore, the number of extrema increases due to the effect of the white noise, so that the number of bits for quantization set in accordance with the number of extrema is reduced. This reduces the accuracy of the ADRC encoding of the residual based on the number of bits for quantization.

Thus, the image quality of digital image data Vdg2 obtained by decoding of the encoded data Vcd by the decoder 84 is degraded.

Accordingly, the encoding by the encoder 82 inhibits analog copying.

Next, the configuration of the decoder 84 shown in FIG. 2 in the case where motion estimation is based on block matching will be described in detail.

FIG. 49 is a block diagram showing the configuration of the decoder 84 that performs decoding corresponding to the encoding performed by the encoder 82 shown in FIG. 36. In the example shown in FIG. 49, parts corresponding to those of the decoder 84 shown in FIG. 27 are designated by corresponding signs, and repeated descriptions thereof will be omitted as appropriate.

In the example shown in FIG. 49, the decoder 84 includes a data decombiner 251, a residual decoder 253, a frame memory 411, an extremum motion compensator 412, a residual adder 413, and a data combiner 255.

The data decombiner 251 receives input of encoded data Vcd from the encoder 82 (or the recorder 83), and decombines the encoded data Vcd into a motion vector, the number of bits for quantization, a dynamic range DR and a minimum value of a residual, and quantized bit-code data. Then, the data decombiner 251 supplies the motion vector to the extremum motion compensator 412, and supplies the number of bits for quantization, the dynamic range DR and the minimum value of the residual, and the quantized bit-code data to the residual decoder 253.

The residual decoder 253 reads the number of bits for quantization, the dynamic range DR and the minimum value of the residual, and the quantized bit-code data supplied from the data decombiner 251. Then, the residual decoder 253 decodes the residual block using the number of bits for quantization, the dynamic range DR and the minimum value of the residual, and the quantized bit-code data, and supplies the resulting decoded residual block to the residual adder 413. The configuration of residual decoder 253 shown in FIG. 49 is substantially the same as that of the residual decoder 253 shown in FIG. 27, so that the-configuration of the residual decoder 253 shown in FIG. 28 applies to the configuration of the residual decoder 253 shown in FIG. 49.

The frame memory 411 stores digital image data Vdg2 supplied from the data combiner 255. The frame memory 411 supplies the image data of a previous frame to the extremum motion compensator 412.

The extremum motion compensator 412 obtains a motion-estimation destination block from the previous frame read from the frame memory 411, on the basis of the motion vector supplied from the data decombiner 251. Then, the extremum motion compensator 412 obtains a predicted block from the motion-estimation destination block, and supplies the predicted block to the residual adder 413.

The residual adder 413 adds the residual block obtained by the residual decoder 253 to the predicted block obtained by the extremum motion compensator 412 to obtain an output block, and supplies the output block to the data combiner 255.

The data combiner 255 has an output image area in its internal memory (not shown). The data combiner 255 writes the image data of output blocks supplied from the residual adder 413 to the output image area. When the image data of all the output blocks has been written, the data combiner 255 supplies the image data written to the output image area to the D/A converter at a subsequent stage as digital image data Vdg2, and writes the image data to the frame memory 411.

As described above, in the decoder 84 shown in FIG. 49, the motion vector used for motion estimation by the extremum motion compensator 412 is calculated on the basis of extrema detected by the encoder 82 from image data with white noise added thereto. Furthermore, the quantized bit-code data decoded by the residual decoder 253 is obtained by encoding under a restriction of data amount in accordance with the number of extrema detected by the encoder 82 from the image data with white noise added thereto.

Thus, the likelihood of a predicted block obtained through motion estimation by the extremum motion compensator 412 or a residual block obtained through residual decoding by the residual decoder 253 is not necessarily high. Accordingly, the image quality of digital image data Vdg2 composed of output blocks generated by summing predicted blocks and residual blocks is degraded. This serves to inhibit analog copying.

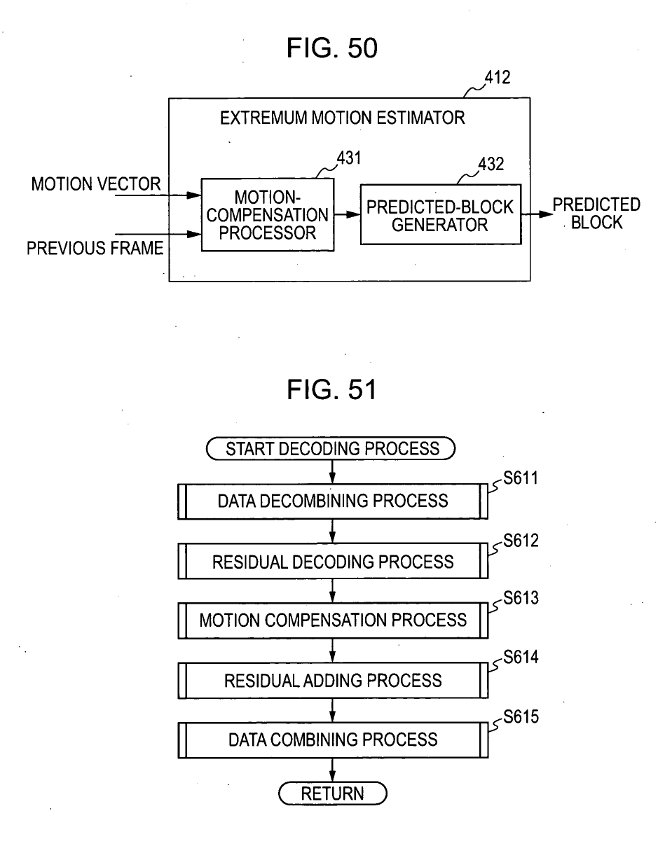

FIG. 50 shows an example configuration of the extremum motion compensator 412 shown in FIG. 49.

In the example shown in FIG. 50, the extremum motion compensator 412 includes a motion compensation processor 431 and a predicted-block generator 432.

The motion compensation processor 431 reads a motion vector supplied from the data decombiner 251 and reads a previous frame from the frame memory 411. Then, the motion compensation processor 431 obtains a motion-estimation destination block from the previous frame supplied from the frame memory 411, on the basis of the motion vector supplied from the data decombiner 251.

The predicted-block generator 432 obtains a predicted block from the motion-estimation destination block supplied from the motion compensation processor 431, and supplies the predicted block to the residual adder 413.

Next, a decoding process executed by the decoder 84 shown in FIG. 49 will be described with reference to a flowchart shown in FIG. 51. The decoding process is another example of step S6 executed by the encoding apparatus 63, described earlier with reference to FIG. 5.

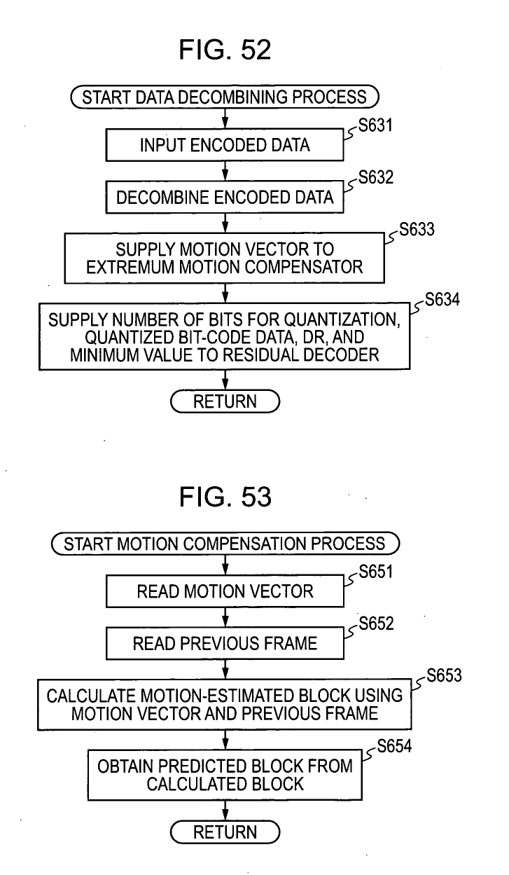

In the decoder 84, the data decombiner 251 receives encoded data Vcd from the encoder 82 (or the recorder 83). Upon receiving the encoded data Vcd, in step S611, the data decombiner 251 executes a data decombining process. The data decombining process will be described later in detail with reference to FIG. 52.

Through the data decombining process in step S611, the encoded data Vcd supplied from the encoder 82 is decombined into a motion vector, the number of bits for quantization, quantized bit-code data, a dynamic range DR, and a minimum value. The motion vector is supplied to the extremum motion compensator 412, and the number of bits for quantization, the quantized bit-code data, the dynamic range DR, and the minimum value are supplied to the residual decoder 253. The process then proceeds to step S612.

Upon receiving the number of bits for quantization, the quantized bit-code data, the dynamic range DR, and the minimum value from the data decombiner 251, in step S612, the residual decoder 253 executes a residual decoding process. The residual decoding process is substantially the same as the residual decoding process executed by the residual decoder 253 shown in FIG. 27 in step S303 shown in FIG. 30 (i.e., the residual decoding process described earlier with reference to FIG. 32), so that repeated description thereof will be refrained.

Through the residual decoding process in step S612, ADRC decoding is performed using the quantized bit-code data, the dynamic range DR, and the minimum value, a residual block is obtained from values obtained by the ADRC decoding, and the residual block is supplied to the residual adder 413. The process then proceeds to step S613.

Upon receiving the motion vector from the data decombiner 251, in step S613, the extremum motion compensator 412 executes a motion compensation process. The motion compensation process will be described later in detail with reference to FIG. 53.

Through the motion compensation process in step S613, a motion-estimation destination block is obtained from the previous frame read from the frame memory 411, on the basis of the motion vector supplied from the data decombiner 251. Then, a predicted block is obtained from the motion-estimation destination block, and the predicted block is supplied to the residual adder 413. The process then proceeds to step S614.

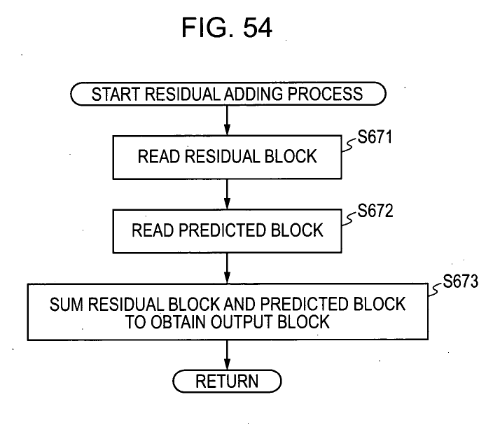

Upon receiving the predicted block from the extremum motion compensator 412, in step S614, the residual adder 413 executes a residual adding process. The residual adding process will be described later in detail with reference to FIG. 54.

Through the residual adding process in step S614, a residual block supplied from the residual decoder 453 is added to the predicted block supplied from the extremum motion compensator 412, and the resulting output block is supplied to the data combiner 255. The process then proceeds to step S615.

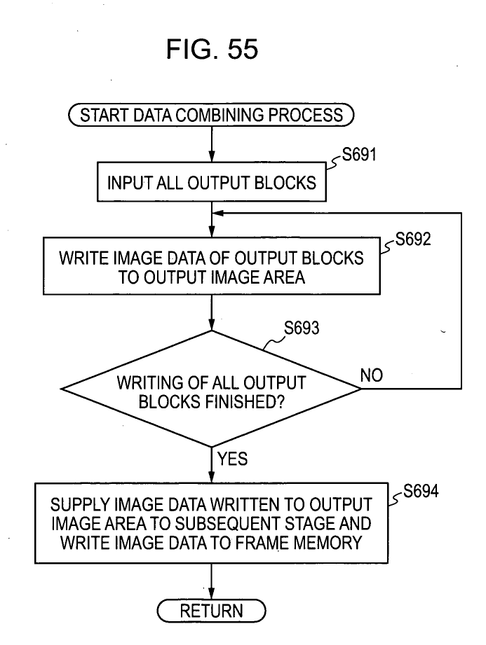

Upon receiving the output block from the residual adder 413, in step S615, the data combiner 255 executes a data combining process. The data combining process will be described later in detail with reference to FIG. 55.

Through the data combining process in step S615, the image data of output blocks supplied from the residual adder 413 are written to the output image area. When the image data of all the output blocks has been written, the image data written to the output image area is supplied to the D/A converter 85 at a subsequent stage as digital image data Vdg2. The decoding process is then exited, and the process returns to step S6 shown in FIG. 5 and proceeds to step S7.

Next, the data decombining process in step S611 shown in FIG. 51, executed by the data decombiner 251 shown in FIG. 49, will be described with reference to a flowchart shown in FIG. 52.

In step S631, the data decombiner 251 receives input of encoded data Vcd supplied from the encoder 82. Then, in step S632, the data decombiner 251 decombines the input encoded data Vcd.

More specifically, in step S632, the data decombiner 251 decombines the encoded data Vcd into a motion vector, the number of bits for quantization, quantized bit-code data, a dynamic range DR, and a minimum value. The process then proceeds to step S633.

In step S633, the data decombiner 251 supplies the motion vector to the extremum motion compensator 412. Then, in step S634, the data decombiner 251 supplies the number of bits for quantization, quantized bit-code data, the dynamic range DR, and the minimum value to the residual decoder 253. The data decombining process is then exited, and the process returns to step S611 shown in FIG. 51 and proceeds to step S612.

Next, the motion compensation process in step S613 shown in FIG. 51, executed by the extremum motion compensator 412 shown in FIG. 49, will be described with reference to a flowchart shown in FIG. 53.

In step S651, the motion compensation processor 431 reads a motion vector supplied from the data decombiner 251. Then, in step S652, the motion compensation processor 431 reads a previous frame from the frame memory 411. The process then proceeds to step S653.

In step S653, the motion compensation processor 431 obtains a motion-estimation destination block from the previous frame supplied from the frame memory 411, on the basis of the motion vector supplied from the data decombiner 251. The process then proceeds to step S654.

In step S654, the predicted-block generator 432 obtains a predicted block from the motion-estimation destination block obtained by the motion compensation processor 431, and supplies the predicted block to the residual adder 413. The motion compensation process is then exited, and the process returns to step S613 shown in FIG. 51 and proceeds to step S614.

Next, the residual adding process in step S614 shown in FIG. 51, executed by the residual adder 413 shown in FIG. 49, will be described with reference to a flowchart shown in FIG. 54.

In step S671, the residual adder 413 reads a residual block supplied from the residual decoder 253. Then, in step S672, the residual adder 413 reads a predicted block supplied from the extremum motion compensator 412. The process then proceeds to step S673.

In step S673, the residual adder 413 adds the residual block supplied from the residual decoder 253 to the predicted block supplied from the extremum motion compensator 412 to obtain an output block, and supplies the output block to the data combiner 255. The residual adding process is then exited, and the process returns to step S614 shown in FIG. 51 and proceeds to step S615.

Next, the data combining process in step S615 shown in FIG. 51, executed by the data combiner 255 shown in FIG. 49, will be described with reference to a flowchart shown in FIG. 55.

In step S691, the data combiner 255 receives input of all the output blocks supplied from the residual adder 413 (i.e., all the blocks corresponding to an input image, supplied from the block generator 311 of the encoder 82). The process then proceeds to step S692.

In step S692, the data combiner 255 writes the image data of output blocks to the output image area. Then, in step S693, the data combiner 255 checks whether the image data of all the blocks has been written. When it is determined that the image data of all the blocks has not been written, the process returns to step S692, and subsequent steps are repeated.

When it is determined in step S693 that the image data of all the blocks has been written, in step S694, the data combiner 255 supplies the image data written to the output image area to the D/A converter 85 at a subsequent stage as digital image data Vdg2, and also writes the image data to the frame memory 411. The process then returns to step S615 shown in FIG. 51, and the encoding process shown in FIG. 51 is exited. The process then returns to step S6 shown in FIG. 5 and proceeds to step S7.

As described above, in the decoder 84 shown in FIG. 49, motion compensation is performed on the basis of only extrema detected by the encoder 82 from image data with white noise added thereto. Thus, the image quality of image data generated using predicted blocks obtained by the motion compensation is degraded.

Furthermore, in the decoder 84, residual decoding is performed using quantized bit-code data obtained by the encoder 82 using extrema through quantization of a residual after the motion compensation and using the number of bits for quantization that is set in accordance with the number of extrema. Thus, the image quality of image data generated using residual blocks obtained by the residual decoding is degraded.

This serves to inhibit analog copying.

As described above, in the image processing system according to the embodiment of the present invention, encoding is performed using digital image data Vdg1 with white noise added thereto. Thus, the accuracy of encoding (linear prediction, motion estimation, ADRC encoding, or the like) by the encoder 82 is reduced.

Furthermore, in the image processing system according to the embodiment of the present invention, decoding is performed using encoded data Vcd obtained by encoding digital image data Vdg1 with white noise added thereto. Thus, the accuracy of encoding (linear prediction, motion compensation, residual compensation, or the like) is reduced.

Accordingly, the image quality of encoded data Vcd obtained from the encoder 82 or digital image data Vdg2 obtained by decoding the encoded data Vcd by the decoder 84 is considerably degraded compared with the image quality of digital image data Vdg0 or analog image data Van1. This serves to prevent analog copying.

Although the above description has been given in the context of the decoder 84 of the encoding apparatus 63, the configuration of the decoder 71 of the playback apparatus 61 is substantially the same, and the decoder 71 executes similar processing. In the embodiment of the present invention, encoding and decoding can be performed repeatedly. In that case, the image quality of the resulting image data becomes further degraded on each iteration of encoding and decoding. This serves to prevent analog copying even further.

Furthermore, although the number of pixels in each block for processing is, for example, 8×8 pixels or 4×4 pixels in the embodiment described above, the number of pixels in each block for processing is not limited to these numbers.

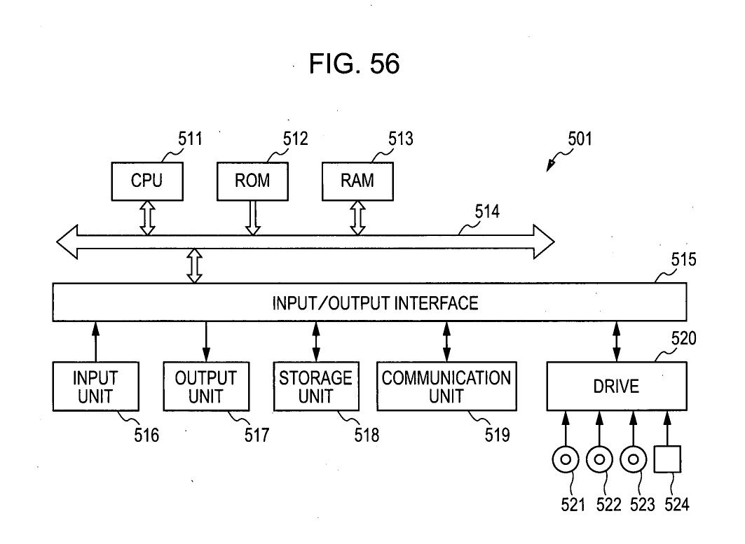

The series of processes described above can be executed either by hardware or by software. When the series of processes is executed by software, the playback apparatus 61 and the encoding apparatus 63 shown in FIG. 2 are each implemented, for example, by a personal computer 501 shown in FIG. 56.

Referring to FIG. 56, a central processing unit (CPU) 511 executes various processes according to programs recorded on a read-only memory (ROM) 512 or programs loaded from a random access memory (RAM) 513 from a storage unit 518. The RAM 513 also stores data used for execution of various processes by the CPU 511 as needed.

The CPU 511, the ROM 512, and the RAM 513 are connected to each other via a bus 514. The bus 514 is also connected to an input/output interface 515.

The input/output interface 515 is connected to an input unit 516, e.g., a keyboard and a mouse, an output unit 517, e.g., a speaker and a display (e.g., the display 62 or the display 86 shown in FIG. 2) implemented by a CRT display or an LCD, a storage unit 518, e.g., a hard disk, and a communication unit 519, e.g., a modem or a terminal adaptor. The communication unit 519 carries out communications with other information processing apparatuses via a network (not shown), such as the Internet.

The input/output interface 515 is also connected to a drive 520 as needed. On the drive 520, a removable recording medium, such as a magnetic disk 521, an optical disk 522, a magneto-optical disk 523, or a semiconductor memory 524 is mounted as needed, and computer programs read therefrom are installed as needed, for example in the storage unit 518.

That is, the drive 520 corresponds to the recorder 83 shown in FIG. 2.

When the series of processes is executed by software, a program constituting the software is installed via a network or a recording medium onto a computer embedded in special hardware or onto a general-purpose computer or the like that is capable of executing various functions with various programs installed thereon.

For example, a programs constituting software having the functions of the decoder 71, the D/A converter 72, the A/D converter 81, the encoder 82, the decoder 84, the D/A converter 85, and the like, described earlier with reference to FIG. 2, is installed. For example, the program may include modules respectively corresponding to the blocks described above. Alternatively, the program may include modules having some of or all the functions of some blocks, or modules to which the functions of a block are divided. Yet alternatively, the program may be based on a single algorithm.

The recording medium storing such a program may be a removable recording medium (package medium) that is distributed separately from a main apparatus unit in order to provide a user with the program, such as the magnetic disk 521 (e.g., a floppy disk), the optical disk 522 (e.g., a compact disk read-only memory (CD-ROM) or a digital versatile disk (DVD)), the magneto-optical disk 523 (e.g., a mini disk (MD)), or the semiconductor memory 524. Alternatively, the recording medium storing such a program may be the ROM 512 or the storage unit 518, which is distributed to a user as included in a main apparatus unit.

Steps defining programs for allowing a computer to execute various processes need not necessarily be executed in the orders described herein with reference to flowcharts, and steps may be executed in parallel or individually (e.g., parallel processing or object-based processing).

A program may be executed either by a single computer or in a distributed manner by a plurality of computers. Furthermore, a program may be transferred to a remote computer for execution.

In this specification, a system refers to the entirety of a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus that encodes image data, the encoding apparatus comprising:
an extremum detector configured to detect extremum pixels having extrema in input image data and the number of extrema corresponding to the number of the extremum pixels; and
an encoder configured to encode the image data by an encoded-data amount that is based on the number of extrema detected by the extrema detector.

2. The encoding apparatus according to claim 1, wherein the encoder includes:
a predicted-pixel generator configured to generate predicted image data using the extremum pixels;
a difference calculator configured to calculate a difference between the predicted image data generated by the predicted-pixel generator and the image data; and
a difference encoder configured to block-encode the difference calculated by the difference calculator.

3. The encoding apparatus according to claim 2, wherein the predicted-pixel generator generates the predicted image data by linear interpolation of the extremum pixels.

4. The encoding apparatus according to claim 2, wherein the predicted-pixel generator generates the predicted-image data on the basis of a motion vector calculated using the extremum pixels.

5. The encoding apparatus according to claim 2, wherein the difference encoder uses adaptive dynamic range coding to block-encode the difference calculated by the difference calculator by the encoded-data amount that is based on the number of extrema.

6. The encoding apparatus according to claim 2, wherein the encoder further includes a data output unit configured to output location data and values of the extremum pixels detected by the extremum detector, an encoding parameter that is set in accordance with the number of extrema, and the difference block-encoded by the difference encoder to a subsequent stage as encoded data.

7. The encoding apparatus according to claim 2, wherein the encoder further includes a data output unit configured to output a motion vector calculated using the extremum pixels, an encoding parameter that is set in accordance with the number of extrema, and the difference block-encoded by the difference encoder to a subsequent stage as encoded data.

8. The encoding apparatus according to claim 1, further comprising a noise adder configured to add noise to the image data and to output the image data with the noise added thereto,
wherein the extremum detector detects the extremum pixels and the number of extrema in the image data with the noise added thereto by the noise adder.

9. The encoding apparatus according to claim 1, further comprising an encoding-information calculator configured to calculate an encoding parameter in accordance with the number of extrema detected by the extremum detector,
wherein the encoder encodes the image data by an encoded-data amount that is based on the encoding parameter.

10. The encoding apparatus according to claim 1,
wherein the extremum detector includes a checker configured to check whether a pixel in the image data has a value that is maximum or minimum compared with pixel values of neighboring pixels, and
wherein the extremum detector detects, as an extremum pixel, each pixel determined by the checker as having a maximum or minimum value compared with the pixel values of the neighboring pixels.

11. An encoding method for an encoding apparatus that encodes image data, the encoding method comprising the steps of:
detecting extremum pixels having extrema in input image data and detecting the number of extrema corresponding to the number of the extremum pixels; and
encoding the image data by an encoded-data amount that is based on the number of extrema detected in the extremum detecting step.

12. A recording medium having recorded thereon a program that allows a computer to execute processing for encoding image data, the program comprising the steps of:
detecting extremum pixels having extrema in input image data and detecting the number of extrema corresponding to the number of the extremum pixels; and
encoding the image data by an encoded-data amount that is based on the number of extrema detected in the extremum detecting step.

13. A decoding apparatus that decodes encoded image data, the decoding apparatus comprising:
an input unit configured to receive input of an encoding parameter that is set in accordance with the number of extrema corresponding to the number of extremum pixels having extrema in image data and input of encoded image data encoded by a data amount that is based on the encoding parameter; and
a decoder configured to decode the encoded image data input via the input unit, on the basis of the encoding parameter input via the input unit, and to output decoded image data.

14. A decoding method for a decoding apparatus that decodes encoded image data, the decoding method comprising the steps of:
receiving input of an encoding parameter that is set in accordance with the number of extrema corresponding to the number of extremum pixels having extrema in image data and input of encoded image data encoded by a data amount that is based on the encoding parameter; and
decoding the encoded image data input in the input step, on the basis of the encoding parameter input in the input step, and outputting decoded image data.

15. A decoding apparatus that decodes encoded image data, the decoding apparatus comprising:
an input unit configured to receive input of prediction data calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data;
a predicted-image generator configured to generate predicted-image data using the prediction data input via the input unit;
a decoder configured to decode the encoded difference data input via the input unit and to output decoded difference data; and
a data combiner configured to combine the difference data decoded by the decoder and the predicted-image data generated by the predicted-image generator.

16. The decoding apparatus according to claim 15, wherein the prediction data includes location data and values of the extremum pixels.

17. The decoding apparatus according to claim 16, further comprising a noise adder configured to add noise to the image data combined by the data combiner and to output the image data with the noise added thereto to a subsequent stage.

18. The decoding apparatus according to claim 16, wherein the predicted-image generator generates the predicted-image data by linear interpolation of the extremum pixels.

19. The decoding apparatus according to claim 16, wherein the decoder decodes the encoded difference data by adaptive dynamic range coding and outputs the decoded difference data.

20. The decoding apparatus according to claim 19, wherein the encoded difference data includes a minimum value and a dynamic range of the difference data for pixels in a block.

21. A decoding method for a decoding apparatus that decodes encoded image data, the decoding method comprising the steps of:
receiving input of prediction data calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data;
generating predicted-image data using the prediction data input in the input step;
decoding the encoded difference data input in the input step and outputting decoded difference data; and
combining the difference data decoded in the decoding step and the predicted-image data generated in the predicted-image generating step.

22. A recording medium having recorded thereon a program that allows a computer to execute processing for decoding encoded image data, the program comprising the steps of:
receiving input of prediction data calculated using extremum pixels having extrema in image data and input of encoded difference data obtained by encoding difference data by a data amount that is set in accordance with the number of extrema corresponding to the number of the extremum pixels, the difference data representing a difference between the image data and pixels predicted on the basis of the prediction data;
generating predicted-image data using the prediction data input in the input step;
decoding the encoded difference data input in the input step and outputting decoded difference data; and
combining the difference data decoded in the decoding step and the predicted-image data generated in the predicted-image generating step.

23. A decoding apparatus that decodes encoded image data, the decoding apparatus comprising:
an input unit configured to receive input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector;
a predicted-image generator configured to generate predicted-image data using the motion vector of the extremum pixels, the motion vector being input via the input unit;
a decoder configured to decode the encoded difference data input via the input unit and to output decoded difference data; and
a data combiner configured to combine the difference data decoded by the decoder and the predicted-image data generated by the predicted-image generator.

24. A decoding method for decoding encoded image data, the decoding method comprising the steps of:
receiving input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector;
generating predicted-image data using the motion vector of the extremum pixels, the motion vector being input in the input step;
decoding the encoded difference data input in the input step and outputting decoded difference data; and
combining the difference data decoded in the decoding step and the predicted-image data generated in the predicted-image generating step.

25. A recording medium having recorded thereon a program that allows a computer to execute processing for decoding encoded image data, the program comprising the steps of:
receiving input of a motion vector of extremum pixels having extrema in image data and input of encoded difference data obtained by encoding difference data by a data amount that is set in accordance with the number of extrema corresponding to the number of the extremum pixels, the difference data representing a difference between the image data and pixels predicted using the motion vector;
generating predicted-image data using the motion vector of the extremum pixels, the motion vector being input in the input step;
decoding the encoded difference data input in the input step and outputting decoded difference data; and
combining the difference data decoded in the decoding step and the predicted-image data generated in the predicted-image generating step.

26. An encoding apparatus that encodes image data, the encoding apparatus comprising:
extremum detecting means for detecting extremum pixels having extrema in input image data and the number of extrema corresponding to the number of the extremum pixels; and
encoding means for encoding the image data by an encoded-data amount that is based on the number of extrema detected by the extrema detecting means.

27. A decoding apparatus that decodes encoded image data, the decoding apparatus comprising:
input means for receiving input of an encoding parameter that is set in accordance with the number of extrema corresponding to the number of extremum pixels having extrema in image data and input of encoded image data encoded by a data amount that is based on the encoding parameter; and
decoding means for decoding the encoded image data input via the input means, on the basis of the encoding parameter input via the input means, and for outputting decoded image data.
